(19) United States
(12) Patent Application Publication
(10) Pub. No.: US 2018/0046933 A1
(43) Pub. Date: Feb. 15, 2018

(54) SYSTEM AND METHOD FOR CONTROLLING A QUANTUM COMPUTING EMULATION DEVICE

(71) Applicant: Board of Regents, The University of Texas System, Austin, TX (US)

(72) Inventors: Brian R. La Cour, Austin, TX (US); Michael J. Starkey, San Antonio, TX (US); Corey I. Ostrove, Austin, TX (US)

(21) Appl. No.: 15/675,163

(22) Filed: Aug. 11, 2017

Related U.S. Application Data
(60) Provisional application No. 62/373,433, filed on Aug. 11, 2016.

(51) Int. Cl. G06N 99/00; G06F 12/02; G06F 13/10; G06F 13/364; G06F 13/40

(52) U.S. Cl. CPC G06N 99/002; G06F 13/364; G06F 13/4022; G06F 13/107; G06F 12/023; G06F 2212/1044

(57) ABSTRACT

A quantum computing emulation platform may be used to control operation of a quantum computing emulation device in performing, by analog electronic circuits within the device, a quantum computing exercise. The platform may include a master controller to determine an initial quantum state for the exercise, a number and sequence of gate operations to be applied in sets of execution runs, and a transformation type for each run, to define and allocate storage for data collection variables, to initiate performance of the exercise by the device, and to store results. The platform may include a set controller to prepare control values for the gate operations and to prepare the platform to collect results, and a run controller to provide the control values for each run to the device and record results. The control values may control switches on the device and program analog electronic circuits to perform particular gate operations.

### RELATED APPLICATIONS

This application claims priority to U.S. Provisional Application No. 62/373,433 filed Aug. 11, 2016, entitled “System and Method for Controlling a Quantum Computing Emulation Device,” which is incorporated herein by reference in its entirety.

### STATEMENT OF GOVERNMENT INTEREST

This invention was made with government support under Grant no. N00014-14-1-0323 and Grant no. N00014-17-1-2107 awarded by the Office of Naval Research. The government has certain rights in the invention.

### FIELD OF THE DISCLOSURE

The present disclosure relates generally to the field of quantum computing systems and, more particularly, to systems and methods for controlling and simulating a quantum computing emulation device.

### DESCRIPTION OF THE RELATED ART

A quantum state can be represented by a mathematical object that characterizes the state of a physical system obeying the laws of quantum mechanics. Quantum states can be used to represent the physical state of microscopic systems, such as atoms or photons. These states may exist naturally but can be difficult to prepare and control in a given physical system.

The quantum state of a physical system can be described as either a pure or a mixed state. Attaining a pure state may involve special preparation of the physical system, while a mixed state may occur naturally. Interactions of the physical system with the surrounding environment can reduce the purity of a pure state, which then may be reduced to a mixed state. The process of a quantum state changing from a pure state to a mixed state is sometimes referred to as decoherence. For example, decoherence processes can destroy entanglement and pure states, reducing the quantum state to a mixed state. Mixed states may not be useful in typical quantum computing systems, and some existing quantum computer algorithms are based upon the assumption that the quantum state is a pure state. A quantum state can also be described as either an entangled state or a separable state. An entangled state may describe the state a physical system in which certain components are interrelated, while a separable state may describe the state of a physical system that is not entangled.

A quantum computing system may be defined as a physical system used to prepare, manipulate, and measure a quantum state. A quantum computing system may use a set of gates in a circuit architecture to prepare and manipulate the quantum state, which is sometimes referred to as a “gate-based” model of quantum computing. In addition, one or more measurement gates may be used to output the results of the computational process. Current approaches to quantum computing use true quantum systems, such as photons, trapped ions, or superconducting circuits. All of these approaches rely upon maintaining a highly coherent quantum state through a series of gate operations in order to achieve a computational advantage. Preparing and manipulating such systems can be quite difficult, as small interactions with the environment quickly lead to decoherence of the state and, consequently, a significant loss in performance. The efficacy of a gate-based quantum computing system may therefore rely upon maintaining a pure quantum state, which may be an entangled pure state. The quality of a gate-based quantum computing system may also be dependent upon the quality of each of the constituent gates. The quality of a gate may be defined by gate fidelity, which measures the similarity of a gate's actual output state to an ideal output state. In order to achieve fault-tolerant performance, through the use of Quantum Error Correction (QEC) protocols, a minimum threshold of gate fidelity may be desirable. Achieving this minimum threshold has been one challenge in some existing physical representations of a quantum computing system.

Certain theoretical research has suggested that quantum computing systems may outperform classical digital computers at performing certain tasks, such as factorization and list searches, which, among other tasks, may be used in communication security and data mining. Some algorithms developed from the theoretical research may be practically executed on a physical quantum computing system.

### SUMMARY

The disclosure relates to systems and methods for controlling and simulating a quantum emulation device. In one aspect, a disclosed method for controlling a quantum computing emulation device may include receiving, via an input interface of a quantum computing emulation platform, input identifying a quantum computing exercise to be performed by analog electronic circuits within the quantum computing emulation device, determining, by a master controller of the quantum computing emulation platform dependent on the received input, a plurality of control values for programming, on the quantum computing emulation device, an initial quantum state for the quantum computing exercise, a number of gate operations to be applied to the initial quantum state in one or more sets of execution runs during performance of the quantum computing exercise, a transformation type for each execution run, and a sequence of one or more gate operations to be applied in each set of execution runs, defining, by the master controller of the quantum computing emulation platform, one or more data collection variables for the quantum computing exercise and allocating storage for the one or more data collection variables in a memory, initiating performance of the quantum computing exercise by the analog electronic circuits within the quantum computing emulation device, where the initiating includes providing the control values to the quantum computing emulation device, and storing, by the master controller of the quantum computing emulation platform to the data collection variables, data collected from the quantum computing emulation device during performance of the quantum computing exercise.

In any of the disclosed embodiments, the plurality of control values may include a respective control value for controlling each of a plurality of switch type circuits on the quantum computing emulation device. The plurality of switch type circuits may control selection of a number of qubits to be operated on, a particular one of the qubits to be operated on, or the initial quantum state for the quantum computing exercise.

In any of the disclosed embodiments, the plurality of control values may further include a control value for controlling, for at least one of the qubits to be operated on, whether the quantum state of the qubit is represented in the frequency domain, in the time domain, or in both the frequency domain and the time domain.

In any of the disclosed embodiments, the plurality of control values may include a plurality of gate coefficients for programming the analog electronic circuits to perform a particular one of a plurality of gate operations implemented on the quantum computing emulation device.

In any of the disclosed embodiments, initiating performance of the quantum computing exercise may include initiating performance of one or more operations, by a set controller of the quantum computing emulation platform, to prepare control values for one or more gate operations to be performed by the quantum computing emulation device during each execution run in each set of execution runs and to prepare the quantum computing emulation platform to collect results of the quantum computing exercise.

In any of the disclosed embodiments, the method may also include initiating, by the set controller of the quantum computing emulation platform for each execution run, performance of one or more operations, by a run controller of the quantum computing emulation platform, to provide the control values for the one or more gate operations to be performed by the quantum computing emulation device during the execution run and to record results of the execution run in one or more of the data collection variables in the memory.

In any of the disclosed embodiments, initiating performance of the quantum computing exercise may include defining one or more control variables for the quantum computing exercise and allocating storage for the one or more control variables in the memory, and storing the plurality of control values to the one or more control variables.

In any of the disclosed embodiments, providing the control values to the quantum computing emulation device may include playing out a portion of the control values stored in the one or more control variables to the quantum computing emulation device via a device interface of the quantum computing emulation platform.

In another aspect, a disclosed non-transitory, computer readable medium may store instructions that are executable by a processor to control a quantum emulation device. The non-transitory, computer-readable medium may store program instructions that, when executed by a processor cause the processor to perform receiving, via an input interface of a quantum computing emulation platform, input identifying a quantum computing exercise to be performed by analog electronic circuits within a quantum computing emulation device, determining, by a master controller of the quantum computing emulation platform dependent on the received input, a plurality of control values for programming, on the quantum computing emulation device, an initial quantum state for the quantum computing exercise, a number of gate operations to be applied to the initial quantum state in one or more sets of execution runs during performance of the quantum computing exercise, a transformation type for each execution run, and a sequence of one or more gate operations to be applied in each set of execution runs, defining, by the master controller of the quantum computing emulation platform, one or more data collection variables for the quantum computing exercise and allocating storage for the one or more data collection variables in a memory, initiating performance of the quantum computing exercise by the analog electronic circuits within the quantum computing emulation device, where the initiating includes providing the control values to the quantum computing emulation device, and storing, by the master controller of the quantum computing emulation platform to the data collection variables, data collected from the quantum computing emulation device during performance of the quantum computing exercise.

In any of the disclosed embodiments, the plurality of control values may include a respective control value for controlling each of a plurality of switch type circuits on the quantum computing emulation device. The plurality of switch type circuits control selection of a number of qubits to be operated on, a particular one of the qubits to be operated on, or the initial quantum state for the quantum computing exercise.

In any of the disclosed embodiments, the plurality of control values may further include a control value for controlling, for at least one of the qubits to be operated on, whether the quantum state of the qubit is represented in the frequency domain, in the time domain, or in both the frequency domain and the time domain.

In any of the disclosed embodiments, the plurality of control values may include a plurality of gate coefficients for programming the analog electronic circuits to perform a particular one of a plurality of gate operations implemented on the quantum computing emulation device.

In any of the disclosed embodiments, initiating performance of the quantum computing exercise may include initiating performance of one or more operations, by a set controller of the quantum computing emulation platform, to prepare control values for one or more gate operations to be performed by the quantum computing emulation device during each execution run in each set of execution runs and to prepare the quantum computing emulation platform to collect results of the quantum computing exercise.

In any of the disclosed embodiments, when executed by the processor, the program instructions may also cause the processor to perform initiating, by the set controller of the quantum computing emulation platform for each execution run, performance of one or more operations, by a run controller of the quantum computing emulation platform, to provide the control values for the one or more gate operations to be performed by the quantum computing emulation device during the execution run and to record results of the execution run in one or more of the data collection variables in the memory.

In any of the disclosed embodiments, initiating performance of the quantum computing exercise may include defining one or more control variables for the quantum computing exercise and allocating storage for the one or more control variables in the memory, and storing the plurality of control values to the one or more control variables.

In any of the disclosed embodiments, providing the control values to the quantum computing emulation device may include playing out a portion of the control values stored in the one or more control variables to the quantum computing emulation device via a device interface of the quantum computing emulation platform.

In yet another aspect, a disclosed system may include a device interface to couple the system to a quantum computing emulation device, the quantum computing emulation device to include analog electronic circuits operable to emulate a plurality of quantum computing operations, an input interface to receive input identifying a quantum computing exercise to be performed by analog electronic circuits within the quantum computing emulation device, at least one processor, and a memory storing program instructions that when executed by the processor implement a quantum computing emulation platform. The quantum computing emulation platform may include a master controller to determine, dependent on the received input, a plurality of control values operable to program, on the quantum computing emulation device, an initial quantum state for the quantum computing exercise, a number of gate operations to be applied to the initial quantum state in one or more sets of execution runs during performance of the quantum computing exercise, a transformation type for each execution run, and a sequence of one or more gate operations to be applied in each set of execution runs, to define one or more data collection variables for the quantum computing exercise and allocate storage for the one or more data collection variables in the memory, to initiate performance of the quantum computing exercise by the analog electronic circuits within the quantum computing emulation device, where to initiate performance of the quantum computing exercise, the master controller is to provide the control values to the quantum computing emulation device, and to store, to the data collection variables, data collected from the quantum computing emulation device during performance of the quantum computing exercise.

In any of the disclosed embodiments, the quantum computing emulation platform may also include a set controller to prepare control values for one or more gate operations to be performed by the quantum computing emulation device during each execution run in each set of execution runs, and to prepare the quantum computing emulation platform to collect results of the quantum computing exercise.

In any of the disclosed embodiments, the quantum computing emulation platform may also include a run controller to provide the control values for the one or more gate operations to be performed by the quantum computing emulation device during the execution run, and to record results of the execution run in one or more of the data collection variables in the memory.

In any of the disclosed embodiments, the plurality of control values may include a respective control value operable to control each of a plurality of switch type circuits on the quantum computing emulation device, and a plurality of gate coefficients operable to program the analog electronic circuits to perform a particular one of a plurality of gate operations implemented on the quantum computing emulation device. The plurality of switch type circuits may control selection of a number of qubits to be operated on, a particular one of the qubits to be operated on, or the initial quantum state for the quantum computing exercise.

In any of the disclosed embodiments, the input interface may include a command line interface, a script-based interface, or a graphical user interface (GUI).

In any of the disclosed embodiments, the quantum computing emulation platform may also include a simulator to simulate operation of the quantum computing emulation device, and a simulator interface through which the master controller is to initiate performance of a quantum computing exercise by the simulator.

### BRIEF DESCRIPTION OF THE DRAWINGS

Embodiments of the present disclosure may be better understood through reference to the following figures in which:

FIG. 1 illustrates an example conceptual representation of a single-qubit quantum computing operation;

FIG. 2 is a block diagram illustrating an example high-level system architecture for a quantum computing emulation system, according to one embodiment;

FIG. 3 illustrates an example of a method for emulating a quantum computer, according to one embodiment;

FIG. 4 illustrates an example notational computer architecture for a quantum computing emulation device, according to one embodiment;

FIG. 5 illustrates an example method for emulating the performance of a quantum computing operation in a quantum computing emulation device, according to one embodiment;

FIG. 6 illustrates an example circuit schematic for implementing a signal modulation device, according to one embodiment;

FIG. 7 illustrates an example circuit schematic for implementing a signal demodulation device, according to one embodiment;

FIG. 8 illustrates an example circuit schematic for implementing complex product calculation device, according to one embodiment;

FIG. 9 illustrates an example circuit schematic for implementing an inner product calculation device, according to another embodiment;

FIG. 10 illustrates an example circuit schematic for implementing a Basis generation device, according to one embodiment;

FIG. 11 illustrates an example circuit schematic for implementing a qubit generation device, according to one embodiment;

FIG. 12 illustrates an example circuit schematic for a quantum state synthesis device, according to one embodiment;

FIG. 13 illustrates an example method for generating signals representing an initial quantum state in a quantum computing emulation device, according to one embodiment;

FIG. 14 illustrates an example circuit schematic for implementing a one-qubit projection device, according to another embodiment;

FIG. 15 illustrates an example circuit schematic for implementing a two-qubit projection device, according to one embodiment;

FIG. 16 illustrates an example circuit schematic for implementing a two-qubit projection device, according to another embodiment;

FIG. 17 illustrates an example circuit schematic for a device that applies a single-qubit gate operation on an initial quantum state, according to one embodiment;

FIG. 18 illustrates an example circuit schematic for a programmable gate that applies a single-qubit gate operation to a given qubit, according to one embodiment;

FIG. 19 illustrates an example circuit schematic for a device for generating the complex conjugate component (Conj) of a complex signal, according to one embodiment;

FIG. 20 illustrates an example circuit schematic for a device representing a particular two-qubit gate, a Controlled NOT (CNOT) gate, according to one embodiment;

FIG. 21 illustrates an example circuit schematic for a device for performing a set of state transformations, according to one embodiment;

FIG. 22 illustrates an example schematic overview of a programmable gate component of a quantum computing emulation device, according to one embodiment;

FIG. 23 illustrates an example method for performing a gate operation in a quantum computing emulation device, according to one embodiment;

FIG. 24 illustrates an example circuit schematic for a device for extracting the constituent components of a quantum state, according to one embodiment;

FIG. 25 illustrates an example method for measuring the results of a quantum computing operation performed in a quantum computing emulation device and returning a digital answer, according to one embodiment;

FIG. 26 illustrates an example schematic for implementing the Deutsch-Jozsa algorithm in a quantum computing emulation device, according to one embodiment;

FIG. 27 illustrates an example method for programming and operating a quantum computing emulation device, according to one embodiment;

FIG. 28 illustrates an example system including a quantum computing emulation platform, according to one embodiment;

FIG. 29 illustrates an example method for controlling and simulating a quantum computing emulation device, according to one embodiment;

FIG. 30 is a flow diagram illustrating the operation of an example master controller, according to one embodiment;

FIG. 31 is a flow diagram illustrating the operation of an example set controller, according to one embodiment;

FIG. 32 is a flow diagram illustrating the operation of an example run controller, according to one embodiment; and

FIG. 33 illustrates an example computing system for controlling and simulating a quantum computing emulation device, according to one embodiment.

### DETAILED DESCRIPTION OF PARTICULAR EMBODIMENT(S)

In the following description, details are set forth by way of example to facilitate discussion of the disclosed subject matter. It should be apparent to a person of ordinary skill in the field, however, that the disclosed embodiments are exemplary and not exhaustive of all possible embodiments. For a more complete understanding of the present disclosure, reference is made to the following description and accompanying drawings.

The present disclosure relates to systems and methods for emulating a quantum computer. Some quantum computing systems rely upon maintaining a pure quantum state and are susceptible to decoherence, which, as noted above, may corrupt the desired pure state. In addition, some quantum computing systems have used a physical representation of the quantum state that is relatively difficult to prepare, maintain, and/or manipulate. The challenges with the physical representation in quantum computing implementations has become increasingly difficult as the number of qubits is increased and may limit the number of qubits to a low value.

The recent discovery of classical analogues to quantum systems has suggested that a classical emulation of a quantum computer may be feasible and both easier to build and far less susceptible to decoherence.

As noted above, a quantum computing system may use a set of gates in a circuit architecture to prepare and manipulate the quantum state, which is sometimes referred to as a “gate-based” model of quantum computing. In addition, one or more measurement gates may be used to output the results of the computational process.

In some embodiments of the present disclosure, a universal quantum computer may be emulated with a classical computing system, one that uses a signal of bounded duration and amplitude to represent an arbitrary quantum state. The signal may be of any modality (e.g., acoustic, electromagnetic, etc.). However, the example embodiments described herein are primarily focused on electronic signals. In at least some embodiments, quadrature modulation may be used to represent a single qubit. As described herein, this approach may be generalized to multiple qubits, in some embodiments. In at least some embodiments, individual qubits may be represented by in-phase and quadrature sinusoidal signals. Unitary gate operations may be performed using analog electronic circuit devices, such as four-quadrant multipliers, operational amplifiers, and analog filters, although non-unitary operations may be performed as well. Unlike some earlier approaches, which operate explicitly on the quantum state components, in some embodiments of the present disclosure, these gate operations may be performed by decomposing the quantum state into pairs of subspace projection signals, thereby avoiding an otherwise cumbersome spectral decomposition and re-synthesis process for each gate operation. In some embodiments, using a hidden-variable model of quantum measurement, these same projection operations may be used to realize statistical measurement gates. In this manner, the Hilbert space structure of the quantum state, as well as a universal set of gate operations, may be fully emulated classically. In some embodiments, the required bandwidth of this approach may scale exponentially with the number of qubits, which may limit the scalability of the approach. However, the intrinsic parallelism, ease of construction, and classical robustness to decoherence may, in some embodiments, lead to capabilities and efficiencies rivaling that of current high performance computers.

One of the properties of quantum computers that makes these efficiencies possible is the Hilbert space structure of the quantum state, which gives rise to linear superpositions of classical binary states over a complex scalar field. The quantum state is therefore one of a continuum of possible states, resembling more an analog than digital computer in this regard. Because the dimension of the Hilbert space scales exponentially with the number of quantum bits (or, qubits), a quantum computer may be considered to have vastly greater capability over a digital computer with an equivalent number of classical bits.

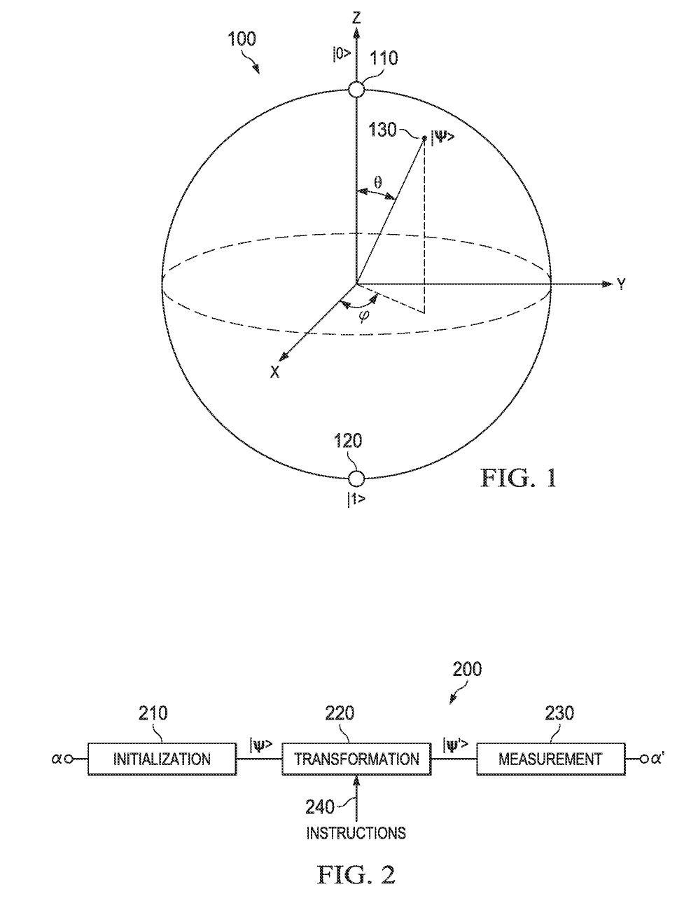

FIG. 1 illustrates an example conceptual representation of a single-qubit quantum computing operation. In this example, a single qubit state 130 may be thought of as a point on a sphere 100, where the north pole 110 represents a value of 0 and the south pole 120 represents a value of 1. In this example, a single-qubit operation may be thought of as taking the qubit at point 130 on sphere 100 and rotating it around the surface of sphere 100 to a different point on the sphere. As illustrated in this example, there may be a whole continuum of quantum computing operations that could be applied to the qubit to cause it to land on different points on sphere 100.

Described herein are methods for simulating and/or controlling a quantum computing emulation device that is built using analog signals and classical analog signal processing. This device may be built based on a signal model that is mathematically equivalent to a multi-qubit, gate-based quantum computer. In various embodiments, quantum bits (qubits) are represented using quadrature modulated tonals of an analog electronic signal. The device is well suited to solving particular types of numerical optimization problems. Based on initial prototyping, as described herein, it is believed that a device of between 10 and 20 qubits can be built on one or two integrated circuit chips and can outperform current digital processors.

As described in more detail below, the approach presented herein includes techniques for addressing individual qubits, or groups of qubits, and applying gate operations upon them using analog electronic adders, multipliers, and filters. A model of quantum measurement gates based on amplitude threshold detections has been constructed that is capable of reproducing phenomena such as quantum contextuality and entanglement, which are thought to be uniquely quantum in nature and important to quantum computing. As described herein, a physical (hardware) demonstration system has been constructed that is capable of emulating a two-qubit quantum device. In some embodiments of the present disclosure, a quantum computing emulation platform executing on a computing system may be used to control the operation of such a physical device. In other embodiments, the quantum computing emulation platform may be used to control a simulator that implements, at a high level, the functionality of such a physical device.

As described in detail herein, methods and systems for emulating a quantum computing system may involve, given a pure quantum state |ψ [symbol] in a mathematical Hilbert space [symbol] , constructing a physical representation using a time-domain signal. The signal may be embodied by electronic voltages, electromagnetic waves, acoustic waves, or another physical embodiment of the signal, as desired. Basic operations on the signal, such as addition, multiplication, scaling, and filtering, may be performed. Given a quantum computing algorithm, an initial quantum state may be constructed and then a sequence of quantum gates, represented by standard signal analysis and manipulation devices, may be applied. Finally a measurement gate, embodied using devices for signal analysis and/or signal manipulation, may be applied to obtain a result of the algorithm. Both types of gates utilize projection operators, in a manner described below.

FIG. 2 is a block diagram illustrating an example high-level system architecture for a quantum computing emulation system 200, according to one embodiment. In this example, the quantum computing emulation system 200 includes an initialization component 210, a transformation component 220, and a measurement component 230. As illustrated in this example, the inputs to the quantum emulation system 200 may include a vector of complex coefficients, α, and instructions 240 (e.g., data and controls) for a set of transformations to be applied to the system state. The vector α may be used to specify an initial system state, |ψ [symbol] , of the quantum computing emulation system 200. The initialization component 210 may include circuitry to generate, from a collection of basis state signals, a pair of signals that represent the initial quantum state specified by the vector α. The transformation component 220 may apply a matrix transformation to the an initial system state, |ψ [symbol] to produce the final system state, which is shown as |ψ′ [symbol] . A measurement may be performed on the final state by measurement component 230, which may produce, for example, a vector of complex numbers, α′, corresponding to the final system state. In this example, the vector α′ of complex values may represent an output of the quantum computing emulation system 200.

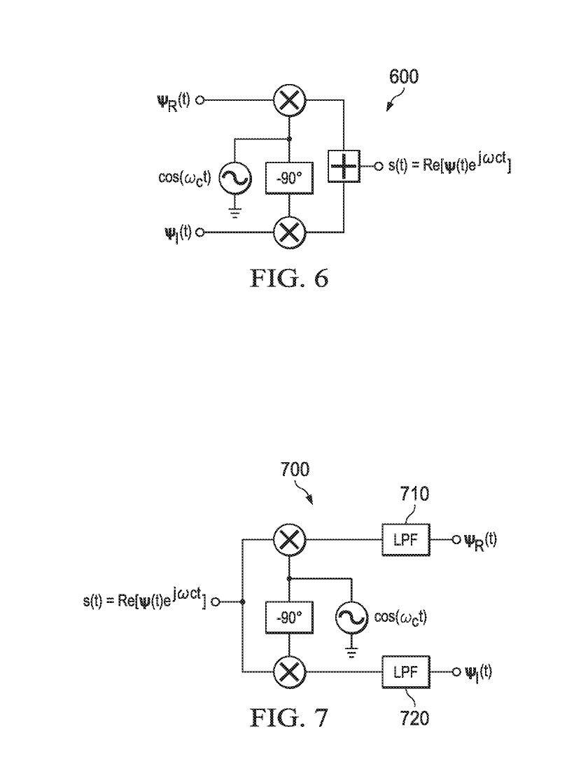

In this and other examples included herein, the signals representing a quantum state are described as a pair of signals representing the real and imaginary parts of a complex signal, respectively. However, in other embodiments, these two parts of a complex signal may be combined into a single signal through carrier modulation. In this case, two signals representing the quantum state may be encoded in the single carrier signal. In some embodiments, a signal modulation device (such as that illustrated in FIG. 6) may be employed in the quantum computing emulation device to modulate a complex signal to produce a (real) carrier signal. In some embodiments, a signal demodulation device (such as that illustrated in FIG. 7) may be employed to demodulate a (real) carrier signal into its corresponding real and imaginary components.

One example physical (hardware) quantum computing emulation device has been constructed that includes breadboards (circuit boards) for implementing at least some of the primary components of the device. This example device includes one breadboard containing circuitry to perform signal generation, one breadboard containing circuitry to receive those signals and generate a representation of an initial quantum state, and one breadboard containing circuitry to perform operation(s) on the basis state to produce an output representing a modified quantum state. Another example physical (hardware) quantum computing emulation device includes seven component (circuit board), including a basis board (which generates all of the basis functions for a 2-qubit system, including 2 kHz single qubit basis functions), a state synthesis board (on which complex coefficients of the programed quantum state are multiplied onto their respective basis functions and then summed together), a gate board (on which the multiplications for applying a single qubit gate or NOT gate takes place), a qubit A board (on which partial projections are created through complex multiplications with the conjugate qubit A basis functions), a qubit B board (on which partial projections are created through complex multiplications with the conjugate qubit B basis functions), a low-pass-filter (LPF) board (on which the actual gate operation of a controlled 2-qubit gate occurs), and an output board (on which the final signals that are to be recorded are switched and low-pass filtered in order to remove unwanted high frequency noise). In still other embodiments, the quantum computing emulation devices described herein may include more, fewer, or different components that collectively implement the functionally of the these devices.

In various embodiments, these and other example quantum computing emulation devices may be interfaced with a computing system (e.g., a desktop computer) that is then used to program the quantum computing emulation device. For example, through an interface of a quantum computing emulation platform executing on the computer, a user may specify a particular problem to be solved, an initial state, a sequence of gate operations to be performed on the initial state, and/or the measurements are performed on the final state to get a digital answer. More specifically, the platform may include an Application Programming Interface (API) through which configuration information and commands may be specified and one or more digital or analog interfaces to the device through which configuration information and commands (e.g., data and control signals) are presented to the appropriate breadboards. In one example, the interface between the desktop computer and the quantum computing emulation device includes D/A devices, which allow certain voltage signals to be specified through a user interface of the quantum computing emulation platform and presented to the circuit boards to control the operation of the device. Similarly, the interface between the quantum computing emulation platform and the quantum computing emulation device includes A/D devices through which intermediate and/or final result values may be presented to and recorded by a component of the quantum computing emulation platform executing on the desktop computer.

In various embodiments, the sequence of gates included in a quantum computing emulation device may include any combination of gates of the types that are used in quantum computing. These may include gates that perform operations similar to those performed by the logic gates in a digital computer as well as other operations that are associated with quantum computing. For example, in quantum computing, an AND gate is reversible. Therefore, unlike in a digital computer, an AND gate may include 3 inputs and 3 outputs. Note, however, that it may not be necessary to construct gates that have 3 inputs and 3 outputs, since it can be shown that any operation that to be perform on a quantum computer can be performed using combinations of single-qubit gates and two-qubit gates. In at least some embodiments of the present disclosure, the quantum computing emulation device may include a universal set of gates for performing operations on a two-qubit state, and these gates may be fully programmable.

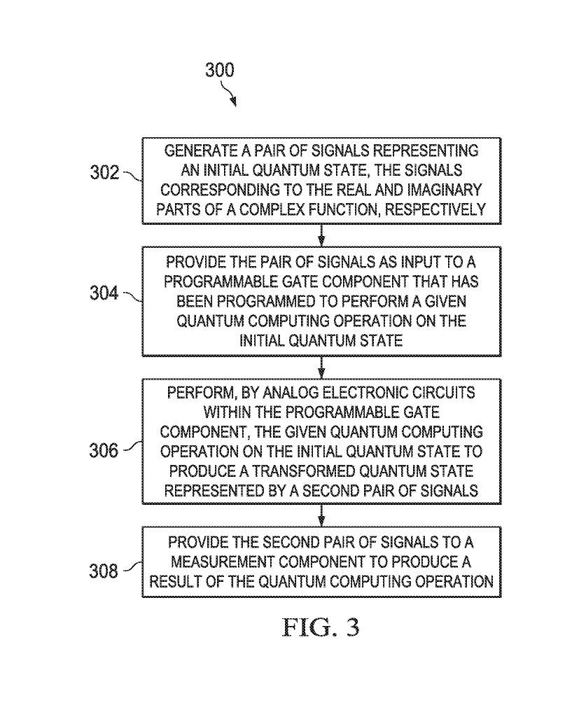

One example of a method 300 for emulating a quantum computer is illustrated by the flow diagram in FIG. 3, according to one embodiment. It is noted that some of the operations of method 300, as depicted in FIG. 3, may be optional. In various embodiments, method 300 may start or stop at any operation, and one or more of the operations of method 300 may be repeated and/or may be performed in a different order than the order depicted in FIG. 3. As illustrated at 302, the method may include generating a pair of signals representing an initial quantum state, where the signals corresponding to the real and imaginary parts of a complex function, respectively. As illustrated at 304, the method may include providing the pair of signals as inputs to a programmable gate component that has been programmed to perform a given quantum computing operation on the initial quantum state.

As illustrated at 306, the method may include performing, by analog electronic circuits within the programmable gate component, the given quantum computing operation on the initial quantum state to produce a transformed quantum state represented by a second pair of signals. The method may also include providing the second pair of signals to a measurement component to produce a result of the quantum computing operation, as shown at 308. In at least some embodiments, all or a portion of method 300 may be implemented by circuitry within a quantum computing emulation device.

In some embodiments, a quantum computing emulation device may support serial gate operations. For example, using D/A converters, the resultant states of at least some gate operations may be recorded and serially played back. In some embodiments, a sequence of gate operations may be specified (e.g., using the MATLAB® programming language developed by The MathWorks, Inc.) through a quantum computing emulation platform executing on a computing system (e.g., a desktop computer) that is interfaced to the device, and the output of each gate operation in the sequence may be recorded and then played back as the input state for the next gate operation in the sequence. In at least some embodiments, analog switches may be used to switch the inputs of single-qubit gates between qubits, as well as to switch to a controlled single-qubit gate. Thus, the quantum computing emulation device may, when operated in conjunction with the quantum computing emulation platform, implement universal programmability.

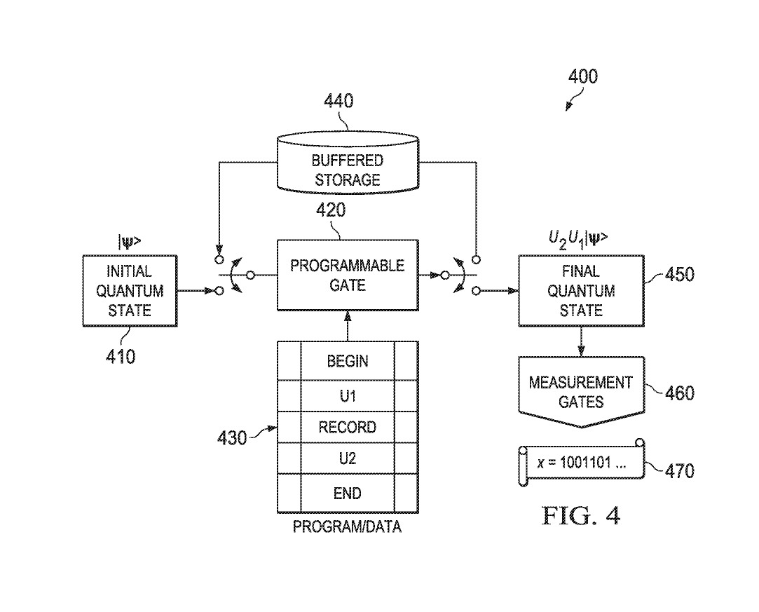

FIG. 4 illustrates an example notational computer architecture for a quantum computing emulation device, according to one embodiment. As illustrated in this example, a quantum computing emulation device 400 may include a component that includes circuitry for generating an initial quantum state (shown as initial quantum state component 410), a component that includes circuitry for performing any of multiple supported gate operations on the initial quantum state (shown as programmable gate component 420), a component that stores an output of programmable gate component 420 for use as an input to a subsequent gate operation (shown as buffered storage component 440), storage component a component that includes circuitry for obtaining the final quantum state (shown as final quantum state component 450), and one or more components that include circuitry for producing a digital signal representing the result of a quantum computing operation (shown as measurement gates 460). In this example, device 400 receives a sequence of instructions indicating the gate operations to be performed and the results to be recorded (shown as program/data 430), and outputs a digital result 470.

As described in more detail below, the initial quantum state component 410 may include circuitry for creating basis states for the input to the quantum computing emulation device and for performing quantum state synthesis to generate of a pair of complex signals in which information defining the initial quantum state is encoded in the frequency content of the signals.

As described in more detail below, the programmable gate component 420 may perform a type of matrix manipulation on these complex signals to transform them according to the specified gate operation, may record the result, and may (optionally) feed the result back to the input if there is a sequence of gate operations to be performed. In some embodiments, results of the gate operations may be recorded in the buffered storage component 440, which may take any of a variety of suitable forms. In some embodiments (e.g., those operating at relatively low frequencies), buffered storage component 440 may be implemented (e.g., digitally) in a memory device. For example, current memory devices may support operating frequencies of up to 1 Ghz for this application. In other embodiments (e.g., those operating at higher frequencies), buffered storage component 440 may be implemented using one or more delay lines (e.g., optical or acoustic delay lines). In embodiments in which the results are stored digitally, they may be converted to a digital representation for storage and then converted back to an analog representation before being fed back into the programmable gate component 420 as an input. In some embodiments, once the sequence of gate operations is completed, measurements may be taken on the signals representing the final quantum state (e.g., by measurement gates 460) to generate and output the digital representation of the result (shown as 470). For example, the measurement gates 460 may include circuitry to perform digital sampling, in some embodiments.

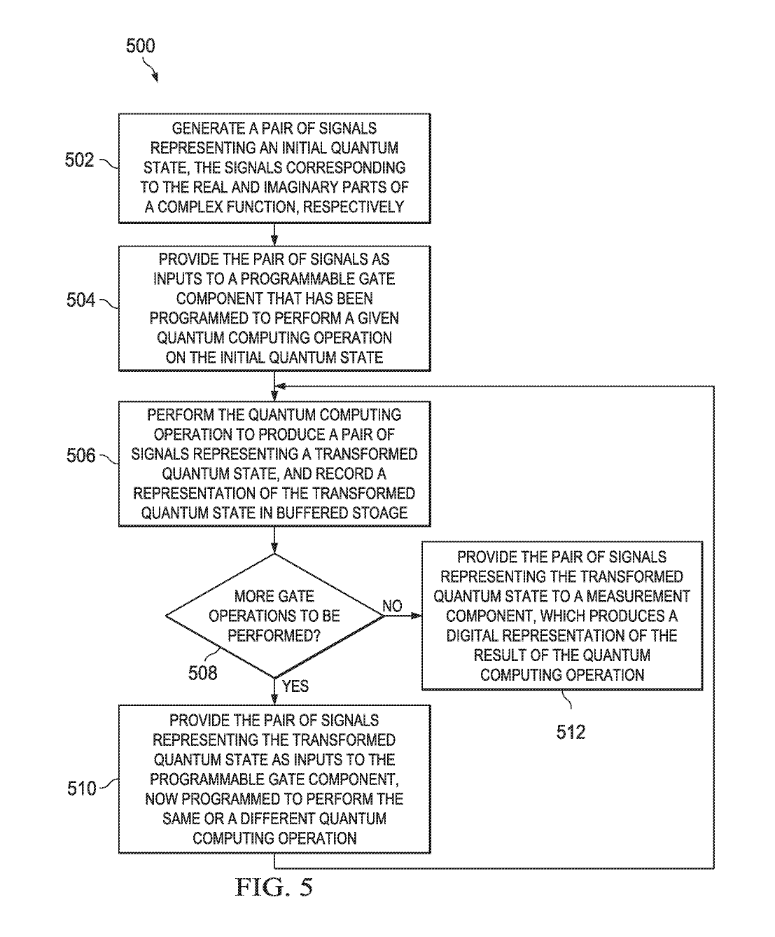

An example method 500 for emulating the performance of a quantum computing operation in a quantum computing emulation device (such as quantum computing emulation device 400 illustrated in FIG. 4) is illustrated by the flow diagram in FIG. 5, according to one embodiment. It is noted that some of the operations of method 500, as depicted in FIG. 5, may be optional. In various embodiments, method 500 may start or stop at any operation, and one or more of the operations of method 500 may be repeated and/or may be performed in a different order than the order depicted in FIG. 5. As illustrated at 502, in this example, the method may include generating a pair of signals representing an initial quantum state, where the signals correspond to the real and imaginary parts of a complex function, respectively. The method may also include providing the pair of signals as inputs to a programmable gate component that has been programmed to perform a given quantum computing operation on the initial quantum state (as in 504). The method may include performing the quantum computing operation on the signals representing the initial quantum state to produce a pair of signals representing a transformed quantum state, as in 506. As illustrated in this example, the method may also include recording a representation of the transformed quantum state (e.g., a representation of one or more pairs of signals) in buffered storage for a potential subsequent use.

If (at 508) it is determined that more gate operations are to be performed, the method may include providing the pair of signals representing the transformed quantum state as inputs to the programmable gate component, as in 510, and repeating the operation shown as 506 for each additional gate operation to be performed. As illustrated in this example, the programmable gate component may be programmed to perform the same quantum computing operation or a different quantum computing operation during each additional iteration. If, or once (at 508), it is determined that there are no additional gate operations to be performed, the method may include providing the pair of signals representing the transformed quantum state to a measurement component, as in 512, after which the measurement component may produce a digital representation of the result of the quantum computing operation. In at least some embodiments, all or a portion of method 500 may be implemented by circuitry within a quantum computing emulation device.

As will be described in more detail below, a physical representation of a multi-qubit quantum state is disclosed in terms of a physical system in which material resources may scale more efficiently than exponentially with the number of qubits. The systems and methods disclosed herein may provide a physical representation of the processing gates for a multi-qubit quantum computing system. Such a representation may be robust against decoherence and other undesirable effects that may degrade the purity and/or fidelity of the quantum state.

The pure quantum state of an n-qubit quantum computer may be represented by a mathematical object, an element of a Hilbert space. More specifically, it may be represented by an element |ψ [symbol] of a 2ⁿ-dimensional Hilbert space [symbol] taking on the particular form of a tensor product of n two-dimensional Hilbert spaces [symbol] ₀, . . . , [symbol] ₙ₋₁ such that [symbol] = [symbol] ₙ₋₁ [symbol] . . . [symbol] [symbol] ₀, where [symbol] is the tensor product. A single element of one of the n constituent Hilbert spaces constitutes a qubit. The specification of an inner product [symbol] φ|ψ [symbol] between states |φ and |ψ [symbol] in [symbol] completes the Hilbert-space description.

In one example, a pair of orthonormal basis states may be denoted by |0 [symbol] , and |1 [symbol] ᵢ, termed the computational basis, for [symbol] ᵢ and iε{0, . . . , n−1}. Taking tensor products of these individual basis states, a set of 2ⁿ orthonormal basis states is obtained for the product space [symbol] . A particular binary sequence x₀, . . . [symbol] ₙ₋₁ therefore corresponds to a single basis state |xₙ₋₁ [symbol] [symbol] . . . [symbol] |x₀ [symbol] ₀ For brevity, this binary sequence may be represented by its decimal form, x=x₀2⁰+ . . . +xₙ₋₁2ⁿ⁻¹ε{0, . . . , 2ⁿ⁻¹}, so that the corresponding basis state may be written succinctly as |x) or, more explicitly, as |xₙ₋₁ . . . x₀ [symbol] . Let [symbol] x|ψ [symbol] =aₓε [symbol] for a given state |ψ)ε [symbol] and basis state |x [symbol] . This state may then be written

$$\vert ψ 〉 = {\sum }_{x = 0}^{{2}^{n} - 1} {α}_{x} \vert x 〉$$

Thus, each of the 2ⁿ basis states may be written as |x [symbol] =|xₙ₋₁ [symbol] [symbol] . . . [symbol] |x₀ [symbol] , where x=xₙ₋₁2ⁿ⁻¹+ . . . +x₀2⁰ represents the decimal representation of xε{0, . . . , 2ⁿ⁻¹} and xₙ₋₁, . . . x₀ε{0, 1} are the corresponding binary digits. As used herein, |x [symbol] =|xₙ₋₁ . . . |x₀ [symbol] may be written for compactness, while the equivalent notation |x [symbol] =|xₙ₋₁ [symbol] ₙ₋₁ [symbol] . . . [symbol] |X₀ [symbol] ₀ may also be used in long form. A general, n-qubit quantum state |ψ [symbol] may be specified by 2ⁿ complex numbers, each corresponding to a component αₓ along a particular basis state |x [symbol] .

Completing the Hilbert space description involves a physical representation of the inner product function. The inner product may be represented by a mathematical object, specifically a sesquilinear form, such that any two quantum states |φ [symbol] and |ψ [symbol] may map to a complex number [symbol] φ|ψ [symbol] . An example physical representation of this mathematical construct is described later, according to one embodiment of the present disclosure.

For a degenerate, one-dimensional Hilbert space of zero qubits, a general pure quantum state |ψ [symbol] =α₀|0 [symbol] may be represented mathematically by a single complex number α₀=a₀+jb₀, where a₀ and b₀ are real numbers and j=\sqrt{−1} is the imaginary unit. This complex number may be represented as the sum of the in-phase and quadrature components of a real sinusoidal signal s of the form

s(t)=a₀ cos(ω_{c}t)−b₀ sin(ω_{c}t)

In this example, ω_{c} represents some carrier frequency (e.g., an angular frequency ω_{c}>0), and a=Re[α] and b=Im[α]. Multiplying signal s by the in-phase and quadrature reference signals, and applying a low-pass filter with a passband below 2w_{c} removes the higher frequency components and yields the in-phase and quadrature amplitudes. Although s is a real signal, it may be written in terms of a complex signal as follows:

=Re[αe^{iω}^{_{c}}^{t}]

Therefore, α may be viewed as a complex (DC, in this case) modulating signal with a carrier frequency of ω_{c}, in which case the (constant) function ψ given by ψ(t)=α may be identified as corresponding to the quantum state |ψ [symbol] . Given a zero-qubit signal s, the corresponding zero-qubit state ψ may be obtained by using the above time-averaging procedure to obtain the real and imaginary parts of ψ. Similarly, given the state ψ, the corresponding signal s may be obtained by modulating the in-phase and quadrature components of a carrier signal of frequency ω_{c}.

To define an inner product, it is worth noting that a time average of s(t)² over tε[0, T] yields the following:

$$\frac{1}{T} {\int }_{0}^{T} {s ( t )}^{2} dt = \frac{{a}^{2}}{2} + \frac{{b}^{2}}{2} = \frac{{\vert a \vert}^{2}}{2} = \frac{〈 ψ \vert ψ 〉}{2}$$

More generally, for a second signal of the form r(t)=Re[φ(t)e^{iω}^{_{c}}^{t}], where φ(t)=βε [symbol] , the following may be defined:

$$〈 φ \vert ψ 〉 = \frac{1}{T} {\int }_{0}^{T} {φ ( t )}^{*} ψ ( t ) dt = {β}^{*} α .$$

This may complete the Hilbert space description of this simple, one-dimensional space. It is worth noting that the zero-qubit signals considered here are often used as an encoding scheme in digital communications, with each value of a representing a different binary sequence. For example, a typical 64-QAM Ethernet protocol uses 64 different combinations of phases and amplitudes to represent a string of 6 (classical) bits. In what follows, quite a different approach may be taken to encoding information, e.g., using a nested sequence of modulating signals to represent a single n-qubit state in terms of its 2ⁿ complex amplitudes. For this reason, the term quadrature modulated tonals (QMT) may be used herein to refer to this sort of representation.

For the in-phase and quadrature components of a complex basebanded signal, it is convenient to use complex exponentials rather than sines and cosines. For example, for a Hilbert space of one qubit, a general pure quantum state |ψ [symbol] =α₀|0 [symbol] +α₁|1 [symbol] may be represented mathematically by a pair of complex numbers α₀=a₀+jb₀ and α₁=a₁+jb₁. The corresponding real signal may defined as s(t)=Re[ψ(t)e^{jω}^{_{c}}^{t}], where ψ represents the complex, basebanded, time-domain signal defined by

ψ(t)=α₀e^{jω}^{₀}^{t}+α₁e^{-jω}^{₀}^{t}, (10)

In this example, ω₀<ω_{c}. The functions φ₀^{ω}^{₀} and φ₁^{ω}^{₀} are the in-phase and quadrature signals, respectfully. These signals, defined by φ₀^{ω}^{₀}(t)=e^{jω}^{₀}^{t} and φ₁^{ω}^{₀} (t)=e^{-jω}^{₀}^{t}, are used to represent the computational basis functions (basis states) |0 [symbol] and |1 [symbol] , respectively. Other choices of basis states are possible.

In this way, it can be seen that the real and imaginary parts of ψ may serve as the in-phase and quadrature components modulating the carrier signal. Physically, these complex signals may be represented by two distinct real signals, each representing the real and imaginary parts of the complex, basebanded signal. For n qubits, the basis state |x [symbol] may be represented by the basis signal φₓ composed of a product of n single-qubit signals as follows:

φₓ(t)=φₓₙ₋₁^{ωn-1}(t) . . . φₓ₁^{ω1}(t)·φₓᵤ^{ωu}(t)

In this example, φ₀^{ωi}(t) and φ₁^{ωi}(t) are defined above. Note that the spectrum of φₓ will therefore consist of the 2ⁿ sums and differences of the n component frequencies. A representative circuit schematic of this process is shown in FIG. 6. Specifically, FIG. 6 illustrates an example circuit schematic for implementing a signal modulation device, according to one embodiment. In this example, signal modulation device 600 includes circuitry to modulate (Mod) a carrier signal, s(t), by a complex basebanded signal, ψ(t)=ψ_{R}(t)+jψ_{I}(t). In at least some embodiments, the signal modulation device 600 may be employed in a quantum computing emulation device to produce s(t) from ψ(t)=ψ_{R}(t)+jψ_{I}(t).

The mapping from ψ to s can be reversed through a process of demodulation. As in the zero-qubit case, this may be accomplished by alternately multiplying s(t) by the in-phase, cos ω_{c}t, and quadrature, −sin ω_{c}t, signals and then low-pass filtering. The result is as follows:

$$\frac{1}{T} {\int }_{t - T}^{t} 2 cos ( {ω}_{c} {t}^{′} ) s ( {t}^{′} ) {dt}^{′} = {ψ}_{R} ( t ) , \\ \frac{1}{T} {\int }_{t - T}^{t} - 2 sin ( {ω}_{c} {t}^{′} ) s ( {t}^{′} ) {dt}^{′} = {ψ}_{1} ( t )$$

A representative circuit schematic of this process is shown in FIG. 7. Specifically, FIG. 7 illustrates an example circuit schematic for implementing a signal demodulation device, according to one embodiment. In this example, signal demodulation device 700 includes circuitry to demodulate (Dem) a real signal, s(t), into its corresponding real, ψ_{R}(t), and imaginary, ψ_{I}(t), components. In at least some embodiments, the signal demodulation device 700, which includes two low-pass filters (shown as LPF 710 and LPF 720) may be employed in a quantum computing emulation device to produce ψ(t)=ψ_{R}(t)+jψ_{I}(t) from s(t). Note that because the mapping from ψ to s is reversible, the following discussion focuses on the former.

As noted in the previous discussion, to complete the Hilbert space description of this one-qubit representation, an inner product may be defined. For example, let ψ be defined as before and let φ be an arbitrary one-qubit state of the form

φ(t)=β₀φ₀^{ω}(t)+β₁φ₁^{ω}(t)

This corresponds to the quantum state |φ [symbol] =β₀|0 [symbol] +β₁|1 [symbol] . The inner product [symbol] φ|ψ [symbol] between the two is again defined to be the time average over the period T, where T is a multiple of the period 2π/ω₀ of the signal. Tε(2π/ω) [symbol] :

$$〈 φ \vert ψ 〉 = \frac{1}{T} {\int }_{0}^{T} {φ ( t )}^{*} ψ ( t ) dt$$

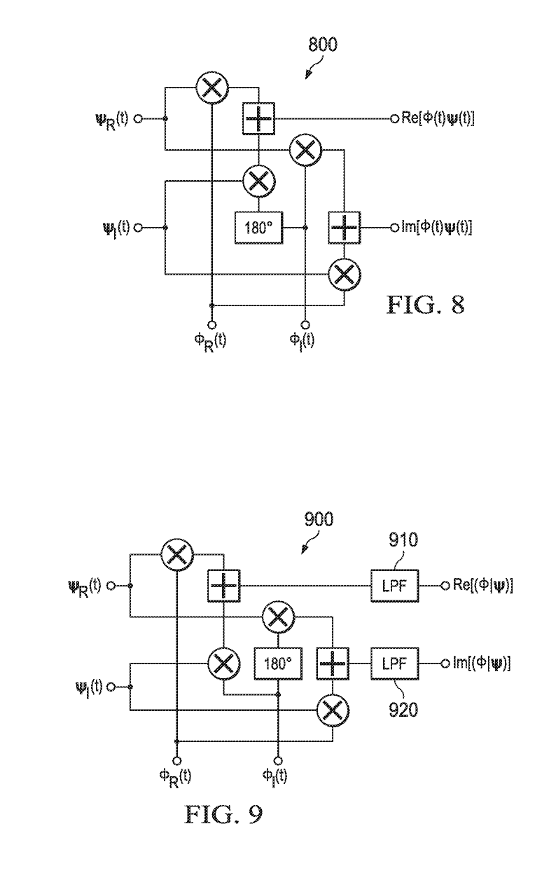

A representative circuit schematic implementing a complex product function is shown in FIG. 8. Specifically, FIG. 8 illustrates an example circuit schematic for implementing a complex product calculation device, according to one embodiment. In at least some embodiments, a complex product calculation device takes two complex signals, which are represented by pairs of real signals, as inputs, and it outputs another complex signal representing their product. In this example, a complex product calculation device 800 includes circuitry to perform calculating the complex product (Prod) of two complex signals, represented by ψ(t) and φ(t), in terms of their corresponding real and imaginary components. In at least some embodiments, inner product calculation device 800 may be employed in a quantum computing emulation device to produce ψ(t)φ(t) from ψ(t) and φ(t).

In this example, complex product calculation device 800 includes three four-quadrant multipliers, two operational amplifiers (op-amps) serving as adders, and one op-amp serving as an inverter. In this example, quantum states are represented as complex numbers (or complex functions). More specifically a quantum state is represented by two individual signals, one representing the real part and one representing the imaginary part of a complex signal. As described in more detail herein, multiplying two such signals together may include taking two pairs of signals, and breaking the operation down so that includes multiplying together pairs of real signals and then adding pairs of real signals, and so forth. As illustrated in FIG. 8A, two pairs of signals are input to the complex product calculation device 800, and a single pair of signals is output from the complex product calculation device 800. In various embodiments, the low-level multiplication and summation operations may be performed by circuitry within complex product calculation device 800, such as by individual integrated circuit components.

In the example illustrated in FIG. 8A, the real and imaginary parts of the complex signal may be kept separate. In another embodiment, a single signal by be used to represent the quantum state. In such an embodiment the phase of the signal may be measured prior to performing any processing on the signal and then the signal may be put back together in its new phase. In this example, in order to operate an individual qubits, phase detections may be performed to pull out phases representing those qubits. This may involve a lot of DC computation, in which case the circuitry may should be precise enough to handle DC offset, drift, and/or other potential complications.

In some embodiments, such as in a larger scale system that supports operations on a larger number of qubits, the quantum state may still be represented by a single pair of signals that represents all of the qubits. For example, the real part of the complex signal for the quantum state (for all of the qubits) may collectively be represented by one signal and the imaginary part of the complex signal for the quantum state (for all of the qubits) may collectively be represented by another signal.

In some embodiments, the inner product may be formed by first applying a complex conjugate (Conj) operation to φ (i.e., inverting φ₁) before multiplying it by ψ, then passing the resultant real and imaginary parts through low-pass filters. Performing this integration, it can be verified that

[symbol]

φ|ψ [symbol] =β₀*α₀+β₁*α₁.

Therefore, the definition produces the correct result. Note that the inner product corresponds to a low-pass filter, and that [symbol] φₓ|ψ [symbol] =aₓ represents a pair of DC values giving the components of the quantum state for the |x [symbol] basis state.

A representative circuit schematic implementing the inner product function is shown in FIG. 9. Specifically, FIG. 9 illustrates an example circuit schematic for implementing an inner product calculation device, according to another embodiment. In contrast to the complex product calculation device illustrated in FIG. 8, this circuit produces a pair of DC voltages as an output. In this example, an inner product calculation device 900 includes circuitry to perform calculating the inner product of two complex signals, represented by ψ(t) and φ(t), in terms of their corresponding real and imaginary components. In at least some embodiments, inner product calculation device 900 may be employed in a quantum computing emulation device to produce [symbol] φ|ψ [symbol] from inputs |ψ [symbol] and |φ [symbol] . In this example, inner product calculation device 900 includes four four-quadrant multipliers, two operational amplifiers (op-amps) serving as adders, one op-amp serving as an inverter, and two low-pass filters LPF (shown as LPF 910 and LPF 920).

The definition described above makes it possible to identify [symbol] φ|, the dual of [symbol] φ|, as the functional which maps a complex basebanded signal to the corresponding inner product [symbol] φ|ψ [symbol] . From the definition of the inner product, it can also be seen that the one-qubit computational basis states φ₀^{ω} and φ₁^{ω} are orthonormal. This allows the components of the state to be extracted by performing a time average, due to the following:

[symbol]

φ₀^{ω}|ψ [symbol] = [symbol] 0|ψ [symbol] =α₀,

[symbol]

φ₁^{ω}|ψ [symbol] = [symbol] 1|ψ [symbol] =α₁,

This analysis procedure may be complemented by one of synthesis, in which the state ψ may be constructed from the components α₀ and α₁ by multiplying each by the corresponding basis state and summing the two resulting signals.

For a four-dimensional Hilbert space representing two qubits (A and B), a general pure quantum state may be represented mathematically by four complex numbers as follows:

|ψ [symbol] =α₀₀|00 [symbol] +α₀₁|01 [symbol] +α₁₀|10 [symbol] +α₁₁|11 [symbol] . (11)

The corresponding real signal may defined as s(t)=Re [ω(t)e^{jω}^{_{c}}^{t}], where ψ represents the complex, basebanded, time-domain signal defined by

ψ(t)=e^{jω}^{_{A}}^{t}[α₀₀e^{jω}^{_{B}}^{t}+α₀₁e^{jω}^{_{B}}^{t}]+e^{jw}^{_{A}}^{t}[α₁₀e^{jω}^{_{B}}^{t}+α₁₁e^{jω}^{_{B}}^{t}]

In this example, ω_{A}>ω_{B}, and it is assumed that the carrier frequency is sufficiently large so that ω_{A}+ω_{B<}ω_{c}.

Much as before, the following are defined: φ₀¹⁰⁷ (t)=e^{iω}^{_{A}}^{t} and φ₁^{ω}^{_{A}}(t)=e^{-jω}^{_{A}}^{t}. In addition, the basis functions φ₀^{ω}^{_{A}} and φ₁^{ω}^{_{A}} may be identified with the qubit states |0 [symbol] _{A} and |1 [symbol] _{A}, respectively. Similarly, the basis functions φ₀^{ω}^{_{B}} and φ₁^{ω}^{_{B}} may be identified with the computational basis states |0 [symbol] _{B} and |1 [symbol] _{B}, respectively. Finally, the function product φ₀^{ω}^{_{A}}·φ₁^{ω}^{_{B}}=φ₁^{ω}^{_{B}}·φ₀^{ω}^{_{A}} say, may be identified with the tensor product |0 [symbol] _{A} [symbol] |1 [symbol] _{B}=|1 [symbol] _{B} [symbol] |0 [symbol] _{A}=|01 [symbol] . Note that, unlike the Kronecker product between two matrices, the function product between qubits is commutative. Thus, the complex basebanded signal ψ may be identified with the two-qubit quantum state |ψ [symbol] .

Note that the signal ψ consists of four distinct frequencies (1) ω_{A}+ω_{B}>0, corresponding to α₀₀, (2) ω_{A}−ω_{B}>0 corresponding to α₀₁, (3) −ω_{A}+ω_{B}<0, corresponding to α₁₀, and (4) −ω_{A}−ω_{B}<0, corresponding to α₁₁. The modulated signal given by s(t)=Re[ψ(t)e^{iω}^{_{c}}^{t}] consists of these four frequencies shifted to the right by +ω_{c} and to the left by −ω_{c}. Thus, s consists of eight frequencies in all, ranging from −ω_{c}−ω_{A}−ω_{B} to ω_{c}+ω_{A}+ω_{B}, four of which are positive and four of which are negative, as befits a real signal.

Given the set of four complex numbers α₀₀, . . . , α₁₁, the two-qubit signal s may be produced by first constructing the real and imaginary parts, ψ_{R} and ψ_{I} respectively, of ψ. As before, s may be produced by using ψ_{R} as the in-phase signal and ψ_{I} as the quadrature signal for a carrier of frequency ω_{c}, to wit:

s(t)=ψ_{R}(t)cos(ω_{c}t)−ψ₁(t)sin(ω_{c}t),

This approach may be generalized to n qubits as follows. Let xε{0, 1, . . . , 2ⁿ−1} and define φₓ as the function product such that

φₓ(t)=φₓ_{_{n−1}}^{ω}^{_{n−1}}(t) . . . φₓ_{₁}^{ω}^{₁}(t)·φₓ_{₀}^{ω}^{₀}(t).

Here, φ₀^{ω}^{ₖ}(t)=e^{iω}^{ₖ}^{t}, φ₁^{ω}^{ₖ}(t)=e^{-w}^{ₖ}^{t}, and x₀, . . . , xₙ₋₁ are the binary digits of x. By convention, it is assumed that 0<ω₀< . . . <ωₙ₋₁. The n-qubit signal can now be written in the form s(t)=RE[ψ(t)e^{-iω}^{_{c}}^{t}], where ωₙ₋₁+ . . . ω₀<ω_{c} and

ψ(t)=Σₓ₌₀²^{ⁿ}⁻¹aₓφₓ(t).

For two such signals φ and ψ, the inner product is defined, as before, to be as follows:

$$〈 φ \vert ψ 〉 = \frac{1}{T} {\int }_{0}^{T} {φ ( t )}^{*} ψ ( t ) dt$$

Here, the time average is over a multiple of the period T (where T is a multiple of the period 2π/ω₀ of the signal) of the lowest frequency qubit. This completes the Hilbert space description.

To represent s, n+1 frequencies may be used, including one for each of the n qubits plus a carrier frequency ω_{c}. The product of these n+1 frequencies in s will have spectral components at the sums and differences of these frequencies. This can be achieved most easily by taking ωᵢ=2ⁱΔω and ω_{c}=ω_{b}+2ⁿΔω, where Δω>0 and ω_{b}≧0 is some baseband offset. This may be referred to as the octave spacing scheme. Using this approach, the positive frequencies of s will therefore range from ωₘᵢₙ=ω_{c}−(ωₙ₋₁+ . . . +ω₀)=ω_{b}+2ⁿΔω−(2ⁿ−1)Δω=ω_{b}+Δω to ωₘₐₓ=ω_{c}+(ωₙ₋₁ . . . +ω₀)=ω_{b}+(2ⁿ⁺¹−1)Δω, in increments of 2Δω, so there will be 2ⁿ different (positive) frequencies in all. The ordering of the frequencies is such that the complex coefficient αₓ is encoded in the frequencies ±ω_{c}+Ωₓ, where Ωₓ=(2ⁿ−1−2x)Δω for xε{0, . . . , 2ⁿ−1}.

In the octave spacing scheme, each qubit corresponds to one of n frequencies, while each basis state corresponds to one of 2ⁿ frequencies. Here, ωᵢ may be referred to as the qubit frequency for qubit i and Ωₓ may be referred to as the basis frequency for basis state |x [symbol] . To synthesize a quantum state ψ, then, one may explicitly define each of the 2ⁿ complex components, multiply this by the corresponding basis states, and sum the resulting products. Likewise, to analyze a given quantum state ψ, one may multiply by each of the 2ⁿ basis states, compute the inner product by time averaging, and thereby obtain the corresponding complex component. In some embodiments, using such a procedure, one may manipulate and transform the quantum state via any desired transformation, unitary or otherwise. Such a ‘brute force’ approach to implementing gate operations may not very efficient, however. A different and more effective strategy for addressing and manipulating individual qubits or pairs of qubits is described below.

In a digital computer, the state of the computer is given by a sequence of binary values. In a quantum computer, the state of the system may be represented by a superposition of all binary states. Thus, a collection of basis states may represent each of the individual binary strings, and the full quantum state may be represented by a sum over those basis states in accordance with a collection of complex coefficients. In at least some embodiments of the present disclosure, the basis states may be constructed such that the phase between all of the signals (all of the components) is maintained coherently. For example, in some embodiments, the basis states may be constructed using a single reference oscillator in to maintain phase coherence. After creating the basis states (which is a collection of frequencies that do not contain any information about the quantum state of the system), generating the initial quantum state may be thought of as encoding the information that defines the initial quantum state into the signal.

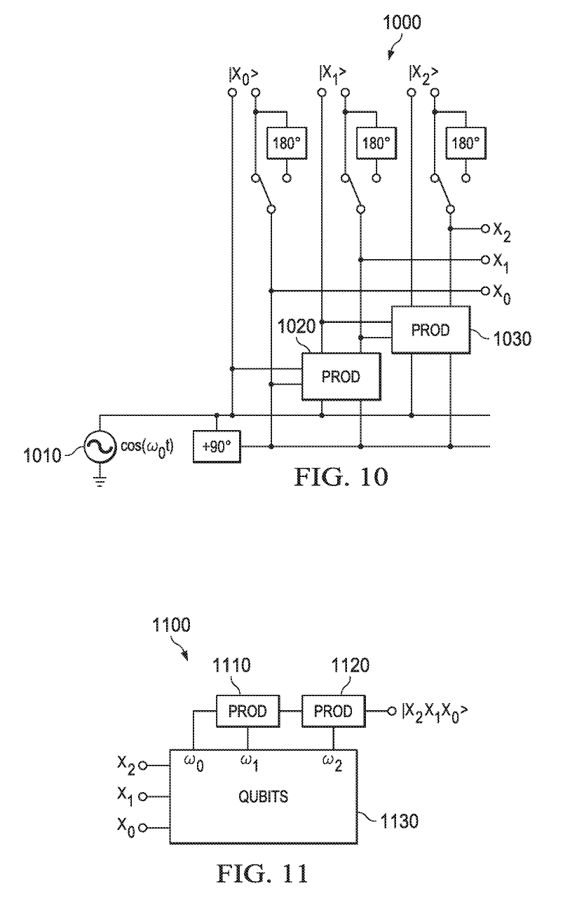

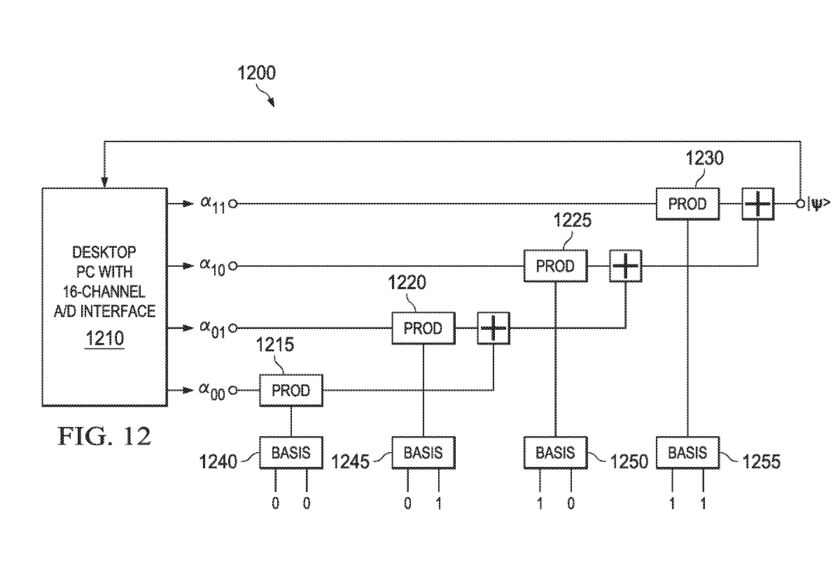

FIG. 10 illustrates an example circuit schematic for implementing a Basis component, such as one of the Basis components illustrated in FIG. 12 and described below. Specifically, FIG. 10 illustrates a schematic for one embodiment of a device 1000 that includes circuitry to generate a computational basis state corresponding to the binary indexing parameters x₀, x₁, x₂, . . . , xₙ₋₁, where n is the number of qubits and xᵢε{0, 1} for iε{0, . . . , n−1}. In at least some embodiments, basis state generation device 1000 may be employed in a quantum computing emulation device to produce basis states |x₂x₁x₀ [symbol] from the binary values x₀, x₁, x₂. In this example, basis state generation device 1000 includes a signal generator 1010 from which phase-coherent basis signals are derived, three op-amps that serve as inverters, one op-amp that serves as a 90° phase shifter, and two inner product calculation components (shown as Prod 1020 and Prod 1030).

FIG. 11 illustrates an example circuit schematic for implementing a Qubits component. Specifically, FIG. 11 is a schematic of one embodiment of a qubit generation device 1100 for generating individual qubits, where each qubit corresponds to a pair of signals representing the real and imaginary components of a complex signal. In at least some embodiments, qubit generation device 1100 may be employed in a quantum computing emulation device to produce the individual qubit signals |x₀ [symbol] , |x₁ [symbol] , |x₂ [symbol] from the binary values x₀, x₁, x₂. In this example, qubit generation device 1100 includes two inner product calculation components (shown as Prod 1110 and Prod 1120), along with additional qubit generation circuitry shown as qubits circuitry 1130.

FIG. 12 illustrates an example circuit schematic for a device that synthesizes a quantum state. Specifically, FIG. 12 is a schematic of one embodiment of a quantum state synthesis device 1200 that includes circuitry to synthesize a quantum state from complex components with respect to a computational basis. In the example illustrated in FIG. 12, thick lines correspond to complex signals, while thin lines represent real signals. In this example, complex signals may be represented by separate real and imaginary components of a complex signal. Complex signals may also be represented by modulation of a carrier signal. In at least some embodiments, quantum state synthesis device 1200 may be employed in a quantum computing emulation device to produce an initial quantum state |ψ [symbol] from a set of complex coefficients α. In the example illustrated in FIG. 12, quantum state synthesis device 1200 includes (or is communicatively coupled to) a desktop computer 1210 that includes a 16-channel A/D interface. In this example, complex coefficients that define the initial quantum state may be input using the desktop computer 1210. Quantum state synthesis device 1200 also includes four inner product calculation components (shown as Prod components 1215, 1220, 1225 and 1230), four basis state generation device components (shown as Basis components 1240, 1245, 1250, 1255), and three op-amps that serve as adders. In this example, the synthesized quantum state |ψ [symbol] (shown as an output of quantum state synthesis device 1200) may be fed back to desktop computer 1210 (as shown) and/or provided to a programmable gate component.

The example quantum state synthesis device 1200 illustrated in FIG. 12 may be used to synthesize an initial quantum state in a two-qubit system. In such a system, there are four different basis states. The synthesized quantum state is a combination of those four basis states, where the particular combination is defined by a collection of four pairs of DC values that are specified by inputs to the desktop computer. In some embodiments, the problems to be solved (or the algorithms to apply in solving the problems) using the quantum computing emulation device may be of a type in which, once the system is initialized to a specified quantum state, the device would perform a specified sequence of gate operation to solve the problem (e.g., to apply the algorithm defined by the sequence of gate operations).

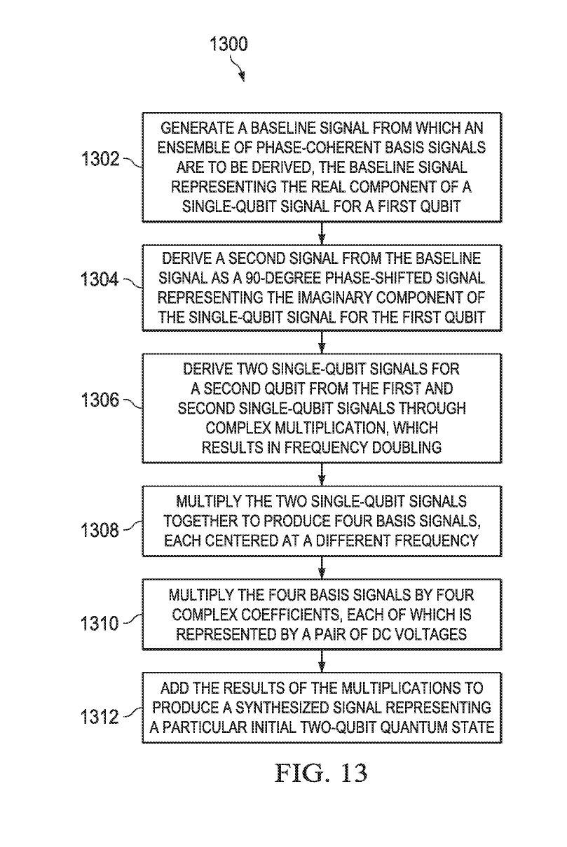

FIG. 13 illustrates an example method 1300 for generating signals representing an initial quantum state in a quantum computing emulation device, according to one embodiment. It is noted that some of the operations of method 1300, as depicted in FIG. 13, may be optional. In various embodiments, method 1300 may start or stop at any operation, and one or more of the operations of method 1300 may be repeated and/or may be performed in a different order than the order depicted in FIG. 13. As illustrated in this example, the method may include generating a baseline signal from which an ensemble of phase-coherent basis signals are to be derived, as in 1302. In this example, the baseline signal may represent the real component of single-qubit signal for a first qubit. The method may include (at 1304) deriving a second signal from the baseline signal as a 90-degree phase-shifted signal representing the imaginary component of the single-qubit signal for the first qubit. As illustrated at 1306 in FIG. 13, the method may include deriving two single-qubit signals for a second qubit from the first and second single-qubit signals through complex multiplication, which results in frequency doubling.

As illustrated in this example, the method may include multiplying the two single-qubit signals together to produce four basis signals, each centered at a different frequency (as in 1308). The method may include multiplying the four basis signals by four complex coefficients, each of which is represented by a pair of dc voltages (as in 1310). The method may also include adding the results of the multiplications together to produce a synthesized signal representing a particular initial two-qubit quantum state (as in 1312). In at least some embodiments, all or a portion of method 1300 may be implemented by circuitry within a quantum computing emulation device.

In another embodiment (e.g., in a system in which the state includes a large number of qubits), the initial quantum state may be created in other ways. For example, in one embodiment, an initial quantum state may be created by performing an inverse Fast Fourier Transform (FFT). In this example, after providing data containing phase information for the respective elements, which are primarily 1s and 0s, and an inverse FFT may be performed (e.g., by optical processing or another mechanism) to create the ensemble of signals for the initial quantum state.

A basic step in quantum computation is the application of unitary or measurement gates to one or more specific qubits. A quantum gate may be represented mathematically by a transformation on elements of a Hilbert space [symbol] . The transformation may be linear and, in particular, unitary, while nonlinear transformations may also be possible. The application of a quantum gate upon the current quantum state of a quantum computing system may produce a new quantum state in the corresponding physical system. When the quantum state is represented by certain components with respect to the computational basis, then the quantum gate may be represented by a matrix acting on a vector including the components. Quantum gates may act upon one or more qubits, and may leave the remaining quibts unchanged. A one-qubit gate acts upon one qubit at a time, a two-qubit gate acts upon two-qubits at a time, and so on. Because a general result from the theory of quantum computing states that a Universal Quantum Computer may be constructed from a set of one-qubit and two-qubit gates, the practical realization of one-qubit and two-qubit gates, as disclosed herein, may represent a significant advancement in the art of quantum computing.

In at least some embodiments of the present disclosure, projection operators may be used to divide the quantum state into projections onto the relevant subspaces corresponding to the qubit(s) being addressed (i.e., the qubits on which the gate operation is to be performed). A projection operator may be thought of as a type of gate in which an output state may be represented by an element of a lower-dimensional Hilbert space than an input state. Quantum gates may use projection operators to address individual qubits. A single qubit may be addressed by applying a pair of projection operators mapping an n-qubit state to an (n−1)-qubit state and corresponding to the particular qubit to be addressed. For a general, n-qubit quantum state of the form

$$\vert ψ 〉 = {\sum }_{x = 0}^{{2}^{n - 1}} {α}_{x} \vert x 〉 ,$$

the projection operators for addressing qubit i may be defined as follows:

$${Π}_{0}^{( i )} \vert ψ 〉 = {\sum }_{x \text{:} {x}_{i} = 0} {α}_{x} \vert {x}_{n - 1} … {x}_{i + 1} … 0 {x}_{i - 1} … {x}_{o} 〉 = {\vert 0 〉}_{i} ⊗ \vert {ψ}_{0}^{( i )} 〉$$

$${Π}_{1}^{( i )} \vert ψ 〉 = {\sum }_{x \text{:} {x}_{i} = 1} {α}_{x} \vert {x}_{n - 1} … {x}_{i + 1} … 1 {x}_{i - 1} … {x}_{o} 〉 = {\vert 1 〉}_{i} ⊗ \vert {ψ}_{1}^{( i )} 〉 .$$

Here, |ψ₀⁽ⁱ⁾ [symbol] and |ψ₁⁽ⁱ⁾ [symbol] represent (n−1)-qubit states. The four projection operators for addressing qubits i and j may be defined as follows:

$$\begin{matrix}{Π}_{ba}^{( ji )} \vert ψ 〉 = {\sum }_{x \text{:} {x}_{i} = a , {x}_{j} = b} {α}_{x} \vert {x}_{n - 1} … {x}_{j + 1} … {bx}_{j - 1} … {x}_{i + 1} α {x}_{i - 1} … {x}_{o} 〉 \\ = {\vert 0 〉}_{j} ⊗ {\vert 1 〉}_{i} ⊗ \vert {ψ}_{ba}^{( ji )} 〉 .\end{matrix}$$

Here, a, bε{0, 1} and |ψ_{ba}^{(ji)} [symbol] represents an (n−2)-qubit state.

The action of a projection operator on qubit i may be achieved by constructing from ψ the signals ψ₀⁽ⁱ⁾ and ψ1⁽ⁱ⁾ corresponding to the quantum states |ψ₀⁽ⁱ⁾ [symbol] and |ψ₁⁽ⁱ⁾ [symbol] . The corresponding projections may then be represented by e^{jω}^{ᵢ}^{t}ψ₀⁽ⁱ⁾(t) and e^{-jω}^{ᵢ}^{t}(t), respectively. This may be achieved in the following manner: Given an n-qubit state |ψ [symbol] , multiply the corresponding signal ψ(t) by either φ₀^{ω}^{ᵢ}(t)*=e^{-jw}^{ᵢ}^{t}, to construct tie ψ₀⁽ⁱ⁾(t), or by φ₁^{ω}^{ᵢ}(t)*=e^{jω}^{ᵢ}^{t}, to construct ψ₁⁽ⁱ⁾(t). For the former case,

$$\begin{matrix}{{φ}_{0}^{{ω}_{i}} ( t )}^{*} ψ ( t ) = {\sum }_{x = 0}^{{2}^{n} - 1} {α}_{x} {e}^{i ( {Ω}_{x} - {ω}_{i} ) t} \\ = {\sum }_{x \text{:} {x}_{i} = 0} {α}_{x} {e}^{i ( {Ω}_{x} - {ω}_{i} ) t} + {\sum }_{x \text{:} {x}_{i} = 1} {α}_{x} {e}^{i ( {Ω}_{x} - {ω}_{i} ) t} .\end{matrix}$$

Here, xᵢ=mod [floor(x/2ⁱ), 2] may represent the value of bit i in the binary expansion x=x₀2⁰+ . . . +xₙ₋₁2ⁿ⁻¹ and ωₓ may be defined as follows:

Ωₓ=(−1)^{x}^{_{n−1}}ωₙ₋₁+ . . . +(−1)^{x}^{₀}ω₀.

To construct the signal ψ₀⁽ⁱ⁾(t), the 2ⁿ⁻¹ frequencies of the form ωₓ−ωᵢ corresponding to xᵢ=0 may be bandpass filtered or, equivalently, the 2ⁿ⁻¹ frequencies Ωₓ−ωᵢ corresponding to xᵢ=1 may be bandstop filtered. In an octave spacing scheme, where ωᵢ=2ⁱΔω, the frequencies are Ωₓ−ωᵢ=(2ⁿ−2ⁱ−1−2x)Δω for x=0, . . . , 2ⁿ−1, of which only those for which xᵢ=0 are bandpassed. Once bandpass filtering is done, the bandpassed signal, ψ₀⁽ⁱ⁾(t), may be multiplied by e^{jw}^{ᵢ}^{t} to obtain the result of the projection operator.

A similar procedure may be used to obtain ψᵢ⁽ⁱ⁾(t) and its corresponding projection. In this case, ψ(t) is multiplied by φ₁⁽ⁱ⁾(t)*=e^{jw}^{ᵢ}^{t} and the resulting signal is bandpass filtered to obtain

$${ψ}_{1}^{( i )} ( t ) = {\sum }_{x \text{:} {x}_{i} = 1} {α}_{x} {e}^{i ( {Ω}_{x} + {ω}_{i} ) t} .$$

To construct the signal ψ₁⁽ⁱ⁾(t), the frequencies Ωₓ+ωᵢ may be bandpass filtered such that xᵢ=1. These are, in fact, the same frequencies as Ωₓ+ω₁ for xᵢ=0, so the same bandpass filter may be used. Thus, a total of n distinct bandpass filters may be used, each bandpass filter may be unique and specific to the corresponding qubit to be addressed.

To address two qubits, the following procedure may be used. For a state ψ(t) with n≧2 and i<j, ψ_{ba}^{(ji)} (t) may be constructed by first multiplying ψ(t) by φ_{b}^{ω}^{ⱼ}(t)*φₐ^{ω}^{ᵢ}(t)*. This results in a signal with frequencies Ωₓ−(−1)^{b}ωⱼ−(−1)^{a}ωᵢ for x=0, . . . , 2ⁿ−1. For xᵢ=a and xⱼ=b, all components due to qubits i and j are to be removed using a bandpass filter. The following result is obtained:

$${ψ}_{ba}^{( ji )} ( t ) = {\sum }_{x \text{:} {x}_{i} = a , {x}_{j} = b} {α}_{x} exp [ i ( {Ω}_{x} - {( - 1 )}^{b} {ω}_{j} - {( - 1 )}^{a} {ω}_{i} ) t ] .$$

The final result of the projection operator may be obtained by multiplying the equation above by the product signal φ_{b}^{ω}^{ⱼ}(t)φₐ^{ω}^{ᵢ}(t). This approach may be generalized to address m out of n qubits, in some embodiments.

An additional discussion of general theory and notation for the emulation of a quantum computing system follows below. In general, in order to address qubit A, a general two-qubit state may be written as follows:

$$\begin{matrix}\vert ψ 〉 = {\vert 0 〉}_{A} ⊗ [ {α}_{00} {\vert 0 〉}_{B} + {α}_{01} {\vert 1 〉}_{B} ] + {\vert 1 〉}_{A} ⊗ [ {α}_{10} {\vert 0 〉}_{B} + {α}_{11} {\vert 1 〉}_{B} ] \\ = {\vert 0 〉}_{A} ⊗ \vert {ψ}_{0}^{( A )} 〉 + {\vert 1 〉}_{A} ⊗ \vert {ψ}_{1}^{( A )} 〉 .\end{matrix}$$

Alternately, qubit B may be addressed as follows:

$$\begin{matrix}\vert ψ 〉 = {\vert 0 〉}_{B} ⊗ [ {α}_{00} {\vert 0 〉}_{A} + {α}_{10} {\vert 1 〉}_{A} ] + {\vert 1 〉}_{B} ⊗ [ {α}_{01} {\vert 0 〉}_{A} + {α}_{11} {\vert 1 〉}_{A} ] \\ = {\vert 0 〉}_{B} ⊗ \vert {ψ}_{0}^{( B )} 〉 + {\vert 1 〉}_{B} ⊗ \vert {ψ}_{1}^{( B )} 〉 .\end{matrix}$$

Note that, although the order of the tensor products has been reversed, the subscript is used on the ket to keep track of which qubit it refers to, so there is no ambiguity of notation. The (unnormalized) two-qubit state |0 [symbol] _{B} [symbol] |ψ₀^{(B)} [symbol] , say, is the projection of |ψ [symbol] onto the subspace for which qubit B takes the value 0. The one-qubit state |ψ₀^{(B)} [symbol] may be referred to as the partial projection, which may play a significant role in the QMT implementation described herein.

For a general n-qubit state of the form below

$$\vert ψ 〉 = {\sum }_{x = 0}^{{2}^{n - 1}} {α}_{x} \vert x 〉 ,$$

a single qubit iε{0, . . . , n−1} with value a ε{0, 1} may be addressed by defining the projection operator, as follows:

$${Π}_{a}^{( i )} {\vert a 〉}_{i} ⊗ \vert {ψ}_{a}^{( i )} 〉 = {\sum }_{x \text{:} {x}_{i} = a} {α}_{x} \vert {x}_{n - 1} … {x}_{i - 1} {ax}_{i - 1} … {x}_{o} 〉 .$$

Here, the partial projection operator πₐ^{(n,i)}:

$${⊗}_{j = 0}^{n - 1} {ℋ}_{j} -> {⊗}_{j = i + 1}^{n - 1} {ℋ}_{j} ⊗ {⊗}_{j = 0}^{i - 1} {ℋ}_{j}$$

is defined to be πₐ^{(n,i)}|ψ [symbol] =ψₐ⁽ⁱ⁾. In the special case that n=1, then Πₐ⁰|ψ [symbol] =α_{α}|α [symbol] and π_{α}^{(1,0)}|ψ [symbol] =α_{α}. Note that Π₀⁽ⁱ⁾+Π₁⁽ⁱ⁾=1 is the identity operator.

A two-qubit projection may be defined similarly. For n≧2, i, jε{0, . . . , n−1}, a, b ε{0,1}, and i≠j, the projection operator onto qubits i and j with values a and b, respectively, may be defined as Π_{ab}^{(ij)}:=Π_{b}^{(j)}Πₐ⁽ⁱ⁾=Πₐ⁽ⁱ⁾Π_{b}^{(j)}=Π_{ba}^{(ji)}. Here, Π_{ab}^{(ij)}|ψ [symbol] =|b [symbol] ⱼ [symbol] |a [symbol] ᵢ [symbol] π_{b}^{(n-1,j)}πₐ^{(n,i)}|ψ [symbol] =|a [symbol] ᵢ [symbol] |b [symbol] ⱼ [symbol] ψ_{ab}^{(ij)} [symbol] ^{.}

In the special case that n=2, then

$$\vert Ψ \frac{( 10 )}{ab} 〉 = {a}_{ab} \vert Ψ \frac{( 01 )}{ba} 〉 .$$

In the degenerate case that i=j,

$$Π \frac{( ii )}{ab} = Π \frac{( i )}{a}$$

may be defined if a=b; otherwise, it may be undefined. Note that, for i≠j,

$$Π \frac{( ij )}{00} + Π \frac{( ij )}{01} + Π \frac{( ij )}{10} + Π \frac{( ij )}{11} = 1$$

may represent the identity operator. Thus approach may be generalized to projections onto an arbitrary number of qubits, in some embodiments.

Given an n-qubit state |Ψ [symbol] , as represented by a QMT complex basebanded signal ψ, it may be possible to construct the n-qubit state given by some projection

$$Π \frac{( i )}{0} \vert Ψ = \vert 0 〉 i ⊗ \vert Ψ 〉 \frac{( i )}{0} ,$$

say. It can be seen that this corresponds to a complex basebanded signal of the form e^{iwit}Ψ₀⁽ⁱ⁾(t), so the task may include determining the partial projection signal ψ₀⁽ⁱ⁾(t). This may be done in a brute-force manner by decomposing ψ (t) into its 2ⁿ complex components and then reconstructing the projection from these pieces. A construction scheme that does not require complete knowledge of the quantum state but relies only on the fact that it is a state of n qubits in described below.

Consider the one-qubit case Ψ(t)=a₀eⁱ^{_{ωt}}+a₁e−ⁱ^{_{ω}}^{t}. If n=1 and i=0, then Ψ₀⁽⁰⁾(t)=a₀ is a constant (DC) signal (i.e., a zero-qubit state). This may be constructed by multiplying Ψ (t) by ₀^{ω}(t)*=e−^{iωt} and low-pass filtering. In fact, this corresponds to the one-qubit inner product function described earlier. In some embodiments, Ψ(t) may be constructed as ψ₁⁽⁰⁾(t)=a₁ in a similar manner.

Now consider the two-qubit case with ω₁=ω_{A} and ω₀=ω_{B}. To address qubit A, ψ₀^{(A)}(t) may be constructed by multiplying ψ(t) by φ₀ ω^{A}(t)*=e−^{iωAt} and applying low-pass filtering. To illustrate this, note the following:

$$\begin{matrix}{{φ}_{0}^{{ω}_{A}} ( t )}^{*} ψ ( t ) = {α}_{00} {e}^{i {ω}_{B} t} + {α}_{01} {e}^{- i {ω}_{B} t} + {α}_{10} {e}^{- i ( 2 {ω}_{A} - {ω}_{B} ) t} + {α}_{11} {e}^{- i ( 2 {ω}_{A} - {ω}_{B} ) t} \\ = {ψ}_{0}^{( A )} ( t ) + [ {α}_{10} {e}^{- i ( 2 {ω}_{A} - {ω}_{B} ) t} + {α}_{11} {e}^{- i ( 2 {ω}_{A} - {ω}_{B} ) t} ] .\end{matrix}$$

Here, the first term has frequencies ±ω_{B}, as desired. The remaining terms have frequencies −(2^{ωA}±^{ω}_{B}). Since ω_{A}≧2ω_{B}>0, it can be seen that 2ω_{A}±ω_{B}≧4ω_{B}−ω_{B}=3ω_{B}. Thus, by using a low-pass filter with a passband of |ω|<3ω_{B}, these remaining terms may be eliminated to obtain ψ₀^{(A)}(t). A similar approach may be used to construct ψ₁^{(A)}(t)==a₁₀e^{iωBt}+a₁₁e −^{iωBt}. Given ψ₀^{(A)}(t) and ψ₁^{(A)}(t), the corresponding projections may be constructed by multiplying the former by e^{iωAt} and the latter by e^{-iωAt}.

Addressing qubit B may, in some embodiments, be slightly more complicated. For example, multiplying ψ(t) by φ^{ωB}(t)* yields

$$\begin{matrix}{{φ}_{0}^{{ω}_{B}} ( t )}^{*} ψ ( t ) = {α}_{00} {e}^{i {ω}_{A} t} + {α}_{10} {e}^{- i {ω}_{A} t} + {α}_{01} {e}^{i ( {ω}_{A} - 2 {ω}_{B} ) t} + {α}_{11} {e}^{- i ( {ω}_{A} - 2 {ω}_{B} ) t} \\ = {ψ}_{0}^{( 0 )} ( t ) + [ {α}_{01} {e}^{i ( {ω}_{A} - 2 {ω}_{B} ) t} + {α}_{11} {e}^{- i ( {ω}_{A} - 2 {ω}_{B} ) t} ] .\end{matrix}$$

Here, the first term has frequencies ±ω_{A}, as desired. The remaining terms have frequencies ω_{A}−2ω_{B}≧0 and −(ω_{A}+2ω_{B})<0. Since ω_{A}≧2ω_{B}>0, it can be seen that that 0≦ω_{A}−2ω_{B}<ω_{A}<ω_{A}+2ω_{B}. Thus, by using a bandpass filter with a passband of |ω−ω_{A}|<2ω_{B}, these terms may be eliminated to obtain |ψ₀^{(B)} [symbol] . A similar approach may be used to construct ψ₁^{(B)}(t)=a₀₁e^{iωAt}+a₁₁e−^{iωAt}. Again, multiplication of ψ₀^{(B)}(t) by e^{iωBt} and ψ₁^{(B)}(t) by e^{iωBt} yield the corresponding projections.

Now suppose n>2. For this case, i=n−1 is easy, i=0 is as before, and 0<i<n−1 is complicated. Construction may begin, as before, by multiplying ψ(t) by either φ₀^{ωi}(t)*=e−^{iωit}, to construct ψ⁽ⁱ⁾(t), or φ₁^{ωi}(t), to construct ψ⁽ⁱ⁾(t). In the former case,

$${{φ}_{0}^{{ω}_{i}} ( t )}^{*} ψ ( t ) = {\sum }_{x = 0}^{{2}^{n} - 1} {α}_{x} {e}^{i ( {Ω}_{x} - {ω}_{i} ) t} = {\sum }_{x : {x}_{i} = 0} {α}_{x} {e}^{i ( {Ω}_{x} - {ω}_{i} ) t} + {\sum }_{x : {x}_{i} = 1} {α}_{x} {e}^{i ( {Ω}_{x} - {ω}_{i} ) t} ,$$

where xᵢ=mod [floor(x/2ⁱ), 2] is the value of bit i in the binary expansion x=x₀2⁰+ . . . +xₙ₋₁2ⁿ⁻¹ and

Ωₓ:=(−1)^{x}^{_{n−1}}ωₙ₋₁+ . . . +(−1)^{x}^{₀}ω₀.

Note that the individual frequencies may be written in the form

$${Ω}_{x} - {ω}_{i} = \{ \begin{matrix}[ {Ω}_{x} - {( - 1 )}^{{x}_{i}} {ω}_{i} ] & if {x}_{i} = 0 \\ [ {Ω}_{x} - {( - 1 )}^{{x}_{i}} {ω}_{i} ] - 2 {ω}_{i} & if {x}_{i} = 1\end{matrix}$$

From this, it may be deduced that

$${ψ}_{0}^{( i )} ( t ) = {\sum }_{x : {x}_{i} = 0} {α}_{x} {e}^{i ( {Ω}_{x} - {ω}_{i} ) t} .$$

To actually construct this signal, the 2ⁿ⁻¹ frequencies Ωₓ−ωᵢ corresponding to xᵢ=0 may be bandpass filtered or, equivalently, the 2ⁿ⁻¹ frequencies Ωₓ−ωᵢ corresponding to xᵢ=1 may be bandpass filtered. In the octave spacing scheme described herein, the frequencies are Ωₓ−ωᵢ=(2ⁿ−1−2x−2ⁱ)Δω for x=0, . . . , 2ⁿ−1, of which only those for which xᵢ=0 are bandpassed. Once this is done, the bandpassed signal, ψ₀⁽ⁱ⁾(t), may be multiplied by e^{iωit} to obtain the projection signal. Note that the state ψ need not be known in order to construct this filter. Instead, only the total number of qubits, n, and the particular qubit to be addressed, i, may need to be specified.

A similar procedure may be used to obtain ψ₁⁽ⁱ⁾(t) and its corresponding projection. In this case, ψ(t) may be multiplied by φ₁⁽ⁱ⁾(t)*=e^{iωi}t to obtain the following:

$${ψ}_{1}^{( i )} ( t ) = {\sum }_{x : {x}_{i} = 1} {α}_{x} {e}^{i ( {Ω}_{x} + {ω}_{i} ) t} .$$

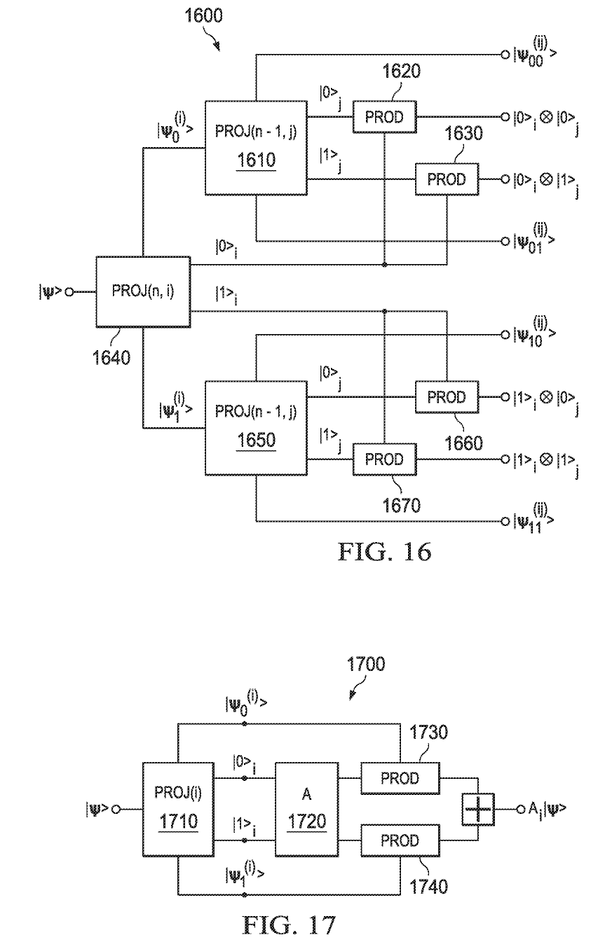

To construct this signal, frequencies Ωx+ωi may be bandpass filtered such that xᵢ=1. Note that these are the same frequencies as Ωx−ωi for xᵢ=0. An example circuit schematic for the projection process is illustrated in FIG. 16 and described below.

To address two distinct qubits, a set of four partial projection signals of the form

$$ψ \frac{( ij )}{ab} ab$$

for a, b ε{0, 1} may be constructed from the single QMT signal ψ. This may be done by first projecting onto the a subspace of qubit i to obtain

$$ψ \frac{( i )}{a} ,$$

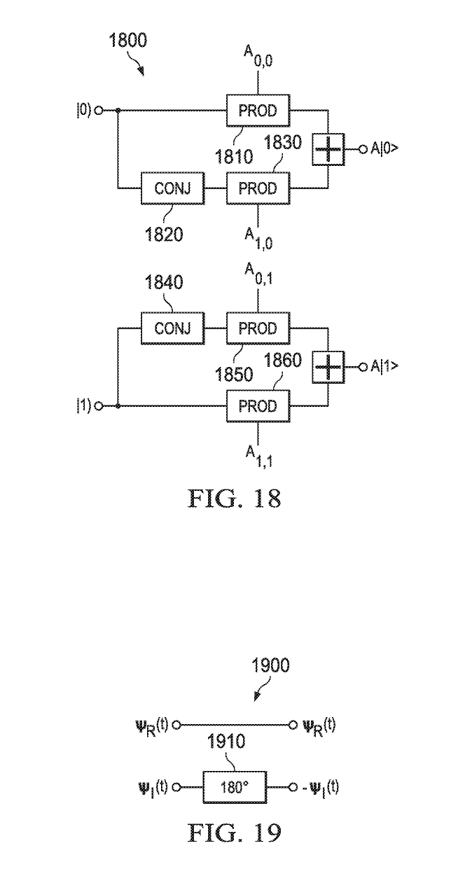

as described above, and then applying this same procedure to project onto the b subspace of qubit i. An example circuit schematic for the two-qubit projection process is illustrated in FIG. 18 and described below.

This approach may be generalized to multi-qubit addressing, in some embodiments. In particular, when projecting onto all n subspaces, then

πₓ_{₀}^{(1,0)}πₓ_{₁}^{(2,1)} . . . πₓ_{_{n−2}}^{(n-1,n-2)},πₓ_{_{n−1}}^{(n,n-1)}|ψ [symbol] = [symbol] xₙ₋₁. . . x₀|ψ [symbol] =aₓ.

Note that each partial project may involve only the use of a low-pass filter. This may prove useful when considering the implementation of measurement gates, as described later.

In at least some embodiments, the projection scheme described above may use comb-like bandpass filters to construct the partial projection signals. In another embodiment, an alternative, yet equivalent, scheme may be to convolve the state ψ with a template signal having the desired passband frequency components. The convolution of two such signals corresponds, in the frequency domain, to the product of their Fourier transforms. Thus, in such a scheme, the template signal would serve as a mask to eliminate undesired frequency components. In this way, simple analog devices such as Surface Acoustic Wave (SAW) elastic convolvers or optical charge-coupled device (CCD) convolvers may be used to construct programmable bandpass filters for each qubit.

For an n-qubit state represented by ψ, the partial projection state ψ₀⁽ⁱ⁾ may be constructed for qubit i as follows. Using phase shifters and multipliers, a template signal of the following form may be constructed:

φ⁽ⁱ⁾(t):=2ⁿ⁻¹ cos(ωₙ₋₁t) . . . cos(ωᵢ₊₁t)·cos(ωᵢ₋₁t) . . . cos(w₀t)

Note that the Fourier transform of φ⁽ⁱ⁾ is

$${φ}^{( i )} ( ω ) = {\int }_{- ∞}^{∞} {φ}^{( i )} ( t ) {e}^{- ω t} dt = 2 π {\sum }_{y : {y}_{i} = 0}^{ } δ ( ω - {Ω}_{y} + {ω}_{i} ) .$$

Now, consider the Fourier transform of

$${ψ}_{0}^{( i )} ( t ) := {e}^{- i {ω}_{i} t} ψ ( t ) \frac{1}{T} {1}_{[ - \frac{T}{2} , \frac{T}{2} ]} ( t ) ,$$

given by

$${ψ}_{0}^{( i )} ( ω ) = {\sum }_{x = 0}^{{2}^{n} - 1} {α}_{x} sin c [ ( ω - {Ω}_{x} + {ω}_{i} ) T / 2 ] .$$

Here, sinc represents the unnormalized sinc function. The convolution of φ⁽ⁱ⁾ and ψ₀⁽ⁱ⁾ is therefore

$$( {ψ}_{0}^{( i )} * {φ}^{( i )} ) ( t ) = {\sum }_{x = 0}^{{2}^{n} - 1} {\sum }_{y : {y}_{i} = 0}^{ } {α}_{x} sin c [ ( {Ω}_{y} - {Ω}_{x} ) T / 2 ] {e}^{i ( {Ω}_{y} - {ω}_{i} ) t} .$$

For Ω_{y}=Ωₓ, the argument of the sinc function is zero and, hence, takes on a value of 1. For the remaining terms, the sinc function become vanishingly small as T becomes large. In the special case of the octave spacing scheme and an integer number of periods [i.e., Tε(2π/ω₀) [symbol] ], the argument of the sinc function becomes (Ω_{y}−Ωₓ)T/2ε2π(x−y) [symbol] . Therefore, all terms such that x≠y drop out, leaving only those such that xᵢ=0. The result is precisely the desired partial projection signal, as follows:

$$( {ψ}_{0}^{( i )} * {φ}^{( i )} ) ( t ) = {\sum }_{x : {x}_{i} = 0}^{ } {α}_{x} {e}^{i ( {Ω}_{x} - {ω}_{i} ) t} = {ψ}_{0}^{( i )} ( t ) .$$

In at least some embodiments, a similar procedure may be followed to obtain other qubit projection states.

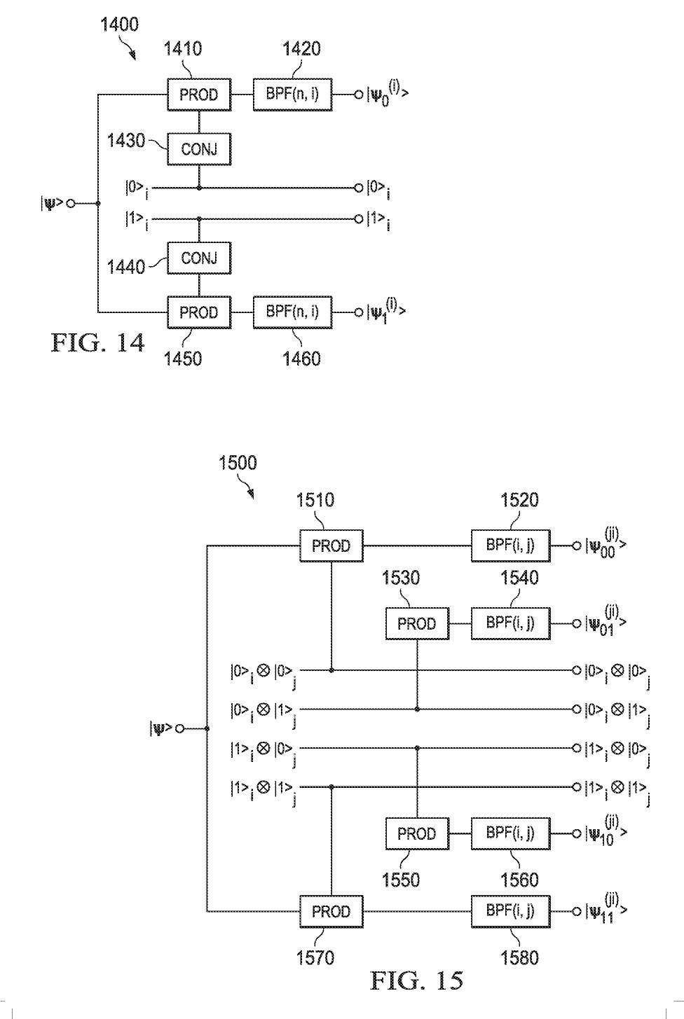

A representative circuit schematic for implementing the projection process described herein is shown in FIG. 14. Specifically, FIG. 14 illustrates an example circuit schematic for implementing a one-qubit projection device, according to another embodiment. As in the previous example, projection device 1400 includes circuitry to obtain single-qubit projection states for a qubit i. More specifically, projection device 1400 includes circuitry to obtain the single-bit projection Proj(n,i) for a qubit i of an n-qubit state. In this example, the projection device 1400 includes two complex product calculation components (shown as Prod components 1410 and 1450), two complex conjugate function components (shown as Conj components 1430 and 1440), and two bandpass filters (shown as BPF(n,i) components 1420 and 1460). In this example, the BPF(n,i) components, which are bandpass filters corresponding to qubit i of an n-qubit state, may be employed in a quantum computing emulation device to address qubit i. As in the previous example, the four output signals may be related to the input signal by |ψ [symbol] =|0 [symbol] ᵢ [symbol] |ψ₀⁽ⁱ⁾ [symbol] +|1 [symbol] ᵢ [symbol] |ψ₁⁽ⁱ⁾ [symbol] .

Note that, in FIG. 14, each of the heavy lines represents a pair of lines/signals (with a real and imaginary part). In this example, bandpass filters are where the separation of frequency content into the two halves is performed. In at least some embodiments, the two bandpass filters are the same, but they operate on different portions of the input signal. In different embodiments, a projection device 1400 or a projection device 1500 may provide input to a gate operation component of a quantum computing emulation device.

FIG. 15 illustrates an example circuit schematic for implementing a two-qubit projection device, according to one embodiment. In this example, projection device 1500 includes circuitry to obtain two-qubit projection states for a pair of qubits i and j. In other words, projection device 1500 includes circuitry to obtain the two-qubit projection Proj(i, j) for qubits i and j. In this example, the projection device 1500 includes four complex product calculation components (shown as Prod components 1510, 1530, 1550, and 1570), and four bandpass filters (shown as BPF(i,j) components 1520, 1540, 1560, and 1580). In this example, the BPF(i, j) components may be employed in a quantum computing emulation device to address qubits i and j. In this example, the eight output signals of projection device 1500 are related to the input signal via the relation |ψ [symbol] =|0 [symbol] ᵢ [symbol] |0 [symbol] ⱼ [symbol] |ψ₀₀^{(ji)} [symbol] +|0 [symbol] ᵢ [symbol] |1 [symbol] ⱼ [symbol] ψ₀₁^{(ji)} [symbol] +|1 [symbol] ᵢ [symbol] 0 [symbol] ⱼ [symbol] |ψ₁₀^{(ji)} [symbol] +|1 [symbol] ᵢ [symbol] |1 [symbol] ⱼ [symbol] |ψ₁₁^{(ji)} [symbol] .

FIG. 16 illustrates an example circuit schematic for implementing a two-qubit projection device, according to another embodiment. In this example, projection device 1600 includes circuitry to obtain two-qubit projection states for a pair of qubits i and j of an n-qubit state. In other words, projection device 1600 includes circuitry to obtain the two-qubit projection Proj(n, i, j) for qubits i and j. In this example, the two-qubit projection device 1600 includes three one-qubit projection devices (shown as Proj components 1610, 1640, and 1650), any or all of which may be similar to projection device 1400 illustrated in FIG. 14 and described above. In this example, projection device 1600 also includes four complex product calculation components (shown as Prod components 1620, 1630, 1660, and 1670). In at least some embodiments, projection device 1600 may be employed in a quantum computing emulation device to address qubits i and j. As in the previous example, the eight output signals of projection device 1600 are related to the input signal via the relation |ψ [symbol] =|0 [symbol] ᵢ [symbol] |0 [symbol] ⱼ [symbol] |ψ₀₀^{(ji)} [symbol] +|0 [symbol] ᵢ [symbol] |1 [symbol] ⱼ [symbol] |ψ₀₁^{(ji)} [symbol] +|1 [symbol] ᵢ [symbol] |0 [symbol] ⱼ [symbol] |ψ₁₀^{(ji)} [symbol] +|1 [symbol] ᵢ [symbol] |1 [symbol] ⱼ [symbol] |ψ₁₁^{(ji)} [symbol] .

A quantum computation may be thought of as a 2×2 matrix transformation on a complex signal. When transforming complex matrices, the data to be transformed may be encoded in the phase of the AC signals, which have both amplitude and phase information. In at least some embodiments, the amplitude may be normalized and the quantum state information may be encoded in the phase content of the signals. This information may be the input to a matrix transformation that is performed using analog electronic circuits, such as analog computational circuits for analog multiplication, summation, and filtering operations. These circuits may be combined to create the mathematical matrix transformations that are typically used in quantum computing.

In some embodiments, the quantum computing emulation devices described herein may emulate the logical operations of the digital domain, including AND, OR, NOR, and NOT gates, for example. In addition, the analog circuitry within these quantum computing emulation devices may be used to emulate quantum computations. The types of problems that can be solved using quantum computation may lend themselves to parallelism of the computation since the data set includes a whole array of frequencies all in one signal set. In some embodiments, the quantum computing emulation devices described herein may leverage this characteristic to achieve a level of parallelism that cannot be achieved in a digital computer.

As previously noted, in at least some embodiments, a quantum computing emulation device may include a gate component that is programmable to perform different gate operations at different times. For example, in some embodiments, an array of DC coefficients may be provided to program the gate. In such embodiments, as an AC signal representing a quantum state passes through the gate, it may be transformed in a manner that is dependent on the DC coefficients. For example, the DC coefficients may select which one or more multipliers (e.g., in an array of multipliers) will transform different portions of the incoming signal, which adders will be used to combine various transformed and untransformed components of the signal, and/or which filtering operations will transform the input signals or the output signals. In some embodiments, by specifying particular DC coefficients, the gate may be programmed to perform any one of a variety of single gate transformations corresponding to quantum gate operations. In some embodiments, the DC coefficients may control switches for control gates, thus providing a mechanism to control whether or not a given gate operation will be performed on a particular qubit (e.g., dependent on the value of a different qubit).

A general one-qubit gate may be represented by a matrix A of the form.

$$A = [ \begin{matrix}{A}_{0 , 0} & {A}_{0 , 1} \\ {A}_{1 , 0} & {A}_{1 , 1}\end{matrix} ]$$

The application of this gate on qubit i may be given by

Aᵢ|ψ [symbol] =[A_{0,0}|0 [symbol] ᵢ+A_{1,0}|1 [symbol] ᵢ] [symbol] |ψ₀⁽ⁱ⁾ [symbol] +[A_{0,1}|0 [symbol] ᵢ+A_{1,1}|1 [symbol] ᵢ] [symbol] |ψ₁⁽ⁱ⁾ [symbol] ^{.}

In some embodiments, to construct a one-qubit gate, denoted A and applied to qubit i, ψ₀⁽ⁱ⁾ and ψ₁⁽ⁱ⁾ may be constructed as described above and the new formed signal ψ′ may be given by

ψ′(t)=[A_{0,0}e^{jω}^{ᵢ}^{t}+A_{1,0}e^{-jω}^{ᵢ}^{t}]ψ₀⁽ⁱ⁾(t)+[A_{0,1}e^{jω}^{ᵢ}^{t}+A_{1,1}e^{-jω}^{ᵢ}^{t}]ψ₁⁽ⁱ⁾(t).

In this example, the new signal ψ′ corresponds to the quantum state |ψ′ [symbol] =Aᵢ|ψ [symbol] . In at least some embodiments, the one-qubit gate may operate on the state |ψ [symbol] , represented by the complex basebanded signal ψ, by decomposing it into subspace projection signals and operating on each component.

Two-qubit gate operations may be constructed similarly, in some embodiments. For example, to construct a two-qubit gate, denoted B and applied to qubits i and j, the four signals ψ₀₀^{(ji)}, ψ₀₁^{(ji)}, ψ₁₀^{(ji)}, and ψ₁₁^{(ji)} may be constructed as described above and then the new signal ψ′ may be given by:

$${ψ}^{′} ( t ) = {\sum }_{a , b = 0}^{1} [ {\sum }_{{a}^{′} , {b}^{′} = 0}^{1} {B}_{{b}^{′} {a}^{′} , ba} {φ}_{{b}^{′}}^{( wj )} {φ}_{{a}^{′}}^{( {w}_{i} )} ] {ψ}_{ba}^{( ji )} .$$

Using a different notation, a quantum state |ψ [symbol] ε [symbol] may be mathematically decomposed into the two orthogonal subspaces corresponding to a qubit i as follows:

$${{\vert ψ 〉 = {II}_{0}^{i} \vert ψ 〉 + {II}_{1}^{i} \vert ψ 〉 = \vert 0 〉}_{i} ⊗ \vert ψ \frac{( i )}{0} 〉 + \vert 1 〉}_{i} ⊗ \vert ψ \frac{( i )}{1} 〉 .$$

Here,

$$\vert ψ \frac{( i )}{0} 〉 and \vert ψ \frac{( i )}{0} 〉$$

are the (n−1)-qubit partial projection states.

As previously noted, a linear gate operation on a single qubit may be represented by a complex 2×2 matrix U, where

$$U = ( \begin{matrix}{U}_{0 , 0} & {U}_{0 , 1} \\ {U}_{1 , 0} & {U}_{1 , 1}\end{matrix} )$$

Here, if U acts on qubit i of state |ψ [symbol] , then the transformed state may be given as

|ψ′ [symbol] =[U_{0,0}|0 [symbol] ᵢ+U_{1,0}|1 [symbol] ᵢ] [symbol] |ψ₀⁽ⁱ⁾ [symbol] +[U_{0,1}|0 [symbol] ᵢ+U_{1,1}|1 [symbol] ᵢ] [symbol] |ψ₁⁽ⁱ⁾

Thus, the gate operation is applied only to the addressed qubit basis states, not to the partial projections. This, of course, is only a mathematical operation. A physical method of construction is needed to realize the transformation.

In a QMT representation, a pair of complex signals ψ₀⁽ⁱ⁾(t) and ψ₁⁽ⁱ⁾(t) corresponding to the partial projection states |ψ₀⁽ⁱ⁾ [symbol] and |ψ₁⁽ⁱ⁾ [symbol] may be produced by taking the initial complex signal ψ(t), multiplying copies of it by φ₀^{w}^{₁}(t) and φ₁^{w}^{₁}(t), respectively, and passing them through a pair of specialized bandpass filters that output the desired projection signals. Given this pair of complex signals, along with the complex, single-qubit basis signals φ₀^{w}^{₁}(t) and φ₁^{w}^{₁}(t), the transformed signal ψ′(t) may be constructed using analog multiplication and addition operations as follows:

ψ′(t)=[U_{0,0}φ₀^{w}^{₁}(t)+U_{1,0}φ₁^{w}^{₁}(t)]ψ₀⁽ⁱ⁾(t)+[U_{0,1}φ₀^{w}^{₁}(t)+U_{1,1}φ₁^{w}^{₁}(t)]ψ₁⁽ⁱ⁾(t).

In various embodiments, the quantum computing emulation devices described herein may be programmed to perform any of a variety of two-qubit gate operations, including Controlled NOT (CNOT) gates. An example circuit for implementing a CNOT gate is illustrated in FIG. 21 and described below, according to one embodiment. In addition to supporting logical NOT and/or CNOT operations, the quantum computing emulation devices described herein may include analog circuitry to implement more exotic types of gates, such as gates that change the phase of a qubit. For example, since qubits are superpositions of zero and one states, when an operation is performed on a qubit, the complex coefficients associated with those binary states are changed. The approach described above may be generalized to an m-qubit gate, in some embodiments.

A schematic illustration of the process described above is shown in FIG. 17 using a linear gate A. More specifically, FIG. 17 illustrates an example circuit schematic for a device that applies a single-qubit gate operation on an initial quantum state, according to one embodiment. In this example, device 1700 includes circuitry to receive the initial state, represented by |ψ [symbol] , which is then passed into a one-qubit projection device, shown as Proj component 1710. In this example, Proj component 1710 produces a set of signals corresponding to the projection of the initial state onto the subspace corresponding to qubit i. Examples implementations of Proj component 1710 are illustrated in FIGS. 14 and 15 and described above, according to different embodiments. As illustrated in FIG. 17, the output of Proj component 1710 may be provided to gate component (shown as gate component 1720), which applies a single-qubit gate operation A to qubit i. An example implementation of gate component 1720 is illustrated in FIG. 18 and described below. In the example illustrated in FIG. 17, device 1700 also includes two complex product components (shown as Prod components 1730 and 1740), and an op-amp that serves as an adder. The functionality of these components is described in more detail below. In at least some embodiments, device 1700 may be employed in a quantum computing emulation device to cause the single-qubit gate Aᵢ, to act on qubit i of quantum state |ψ [symbol] , as programmed.

In the example illustrated in FIG. 17, various operations are performed going from left to right. For example, on the far left is an input signal representing the current quantum state. Next, a projection operation (which is a filtering operation) is performed on that input signal to splits it up into two complementary signals, each of which includes a respective half of the frequency content of the original signal. Following the projection operation, the qubit that is being addressed (which is labeled as qubit i) is operated upon by the gate operation A to create a new transformed qubit. More specifically, gate operation A performs an operation specified by DC coefficients that were input to the quantum computing emulation device (e.g., as DC voltages). Following the performance of the gate operation, the two halves of the signal that were previously split off are combined with the new transformed qubit (the outputs of gate operation A) through a pair of complex multiplication operations and then those two resulting signals are added together to produce the final transformed state.

FIG. 18 illustrates an example circuit schematic for a programmable gate that applies a single-qubit gate operation to a given qubit, according to one embodiment. For example, in one embodiment, gate component 1720 illustrated in FIG. 17 may be implemented by the device 1800 illustrated in FIG. 18. In this example, device 1800 includes circuitry to implement a 2×2 complex matrix A, which represents a single-qubit gate acting on an individual single-qubit basis state. In this example, the operation to be applied by device 1800 is specified by four complex-valued components. The components A_{0,0} and A_{1,0} represent the first column of A, while A_{0,1} and A_{1,1} represent the second column of A. In this example, device 1800 includes four complex product components (shown as Prod components 1810, 1830, 1850, and 1860), and two complex conjugate components (shown as Conj components 1820 and 1840). Each of the complex conjugate components generates an output signal in which the real component is equal to the real component of its input, and in which the imaginary component is equal in magnitude to the imaginary component of its input but is opposite in sign. One example implementation of a complex conjugate function component is illustrated in FIG. 19. In at least some embodiments, device 1800 may be employed as a programmable gate in a quantum computing emulation device to one of a variety of supported operations to an individual qubit of an input quantum state.

In one embodiment, the programmable gate may include multiple four-quadrant multipliers, each multiplier of which is associated with one of the DC coefficients presented to the quantum computing emulation device.

FIG. 19 illustrates an example circuit schematic for a device 1900 that includes circuitry for generating the complex conjugate component (Conj) of a complex signal. In this example, component 1910 represents a 180° phase shifter. In at least some embodiments, device 1900 may be employed in a quantum computing emulation device to produce ψ(t)* from ψ(t).

The action of a NOT gate X, where

$$X = ( \begin{matrix}0 & 1 \\ 1 & 0\end{matrix} ) ,$$

on qubit 0 of a two-qubit state may be given as follows:

$$\begin{matrix}{{{X}_{0} \vert ψ 〉 = \vert 1 〉}_{0} ⊗ \vert {ψ}_{0}^{( 0 )} 〉 + \vert 0 〉}_{0} ⊗ \vert {ψ}_{1}^{( 0 )} 〉 \\ {{{{= \vert 1 〉}_{0} ⊗ [ {α}_{00} \vert 0 〉}_{0} + {α}_{10} {\vert 1 〉}_{1} ] + {\vert 0 〉}_{0} ⊗ [ {α}_{01} \vert 0 〉}_{1} + {α}_{11} \vert 1 〉}_{1} ] \\ = {α}_{00} \vert 01 〉 + {α}_{01} \vert 00 〉 + {α}_{10} \vert 11 〉 + {α}_{11} \vert 10 〉\end{matrix}$$

Similarly, for a two-qubit operator B of the form.

$$B = [ \begin{matrix}{B}_{00 , 00} & {B}_{00 , 01} & {B}_{00 , 10} & {B}_{00 , 11} \\ {B}_{01 , 00} & {B}_{01 , 01} & {B}_{01 , 10} & {B}_{01 , 11} \\ {B}_{10 , 00} & {B}_{10 , 01} & {B}_{10 , 10} & {B}_{10 , 11} \\ {B}_{11 , 00} & {B}_{11 , 01} & {B}_{11 , 10} & {B}_{11 , 11}\end{matrix} ]$$

acting on qubits i and j, the result of applying this gate may be as follows:

$${{{B}_{ji} \vert ψ 〉 = {\sum }_{a , b = 0}^{1} [ {\sum }_{{a}^{′} , {b}^{′} = 0}^{1} {B}_{{b}^{′} {a}^{′} , ba} \vert {b}^{′} 〉}_{j} ⊗ \vert {a}^{′} 〉}_{i} ] ⊗ \vert {ψ}_{ba}^{( ji )} 〉 .$$

In one specific example, the action of a controlled NOT (CNOT) gate C, where

$$C = [ \begin{matrix}1 & 0 \\ 0 & X\end{matrix} ] ,$$

acting on qubits i and j, with i being the controlling or source qubit and j being the controlled or target qubit, may be given as follows:

$$\begin{matrix}{{{C}_{ij} \vert ψ 〉 = {C}_{ij} [ \vert 0 〉}_{i} ⊗ {π}_{0}^{( n , i )} \vert ψ 〉 + \vert 1 〉}_{i} ⊗ {π}_{i}^{( n , i )} \vert ψ 〉 ] \\ {{= {\vert 0 〉}_{i} ⊗ \vert {ψ}_{0}^{( i )} + {C}_{ij} {\vert 1 〉}_{i} ⊗ [ \vert 0 〉}_{j} ⊗ \vert {ψ}_{10}^{ij} 〉 + \vert 1 〉}_{j} ⊗ \vert {ψ}_{11}^{ij} 〉 ] \\ {{= {\vert 0 〉}_{i} ⊗ \vert {ψ}_{0}^{( i )} 〉 + {\vert 1 〉}_{i} ⊗ [ \vert 1 〉}_{j} ⊗ \vert {ψ}_{10}^{ij} 〉 + \vert 0 〉}_{j} ⊗ \vert {ψ}_{11}^{ij} 〉 ] .\end{matrix}$$

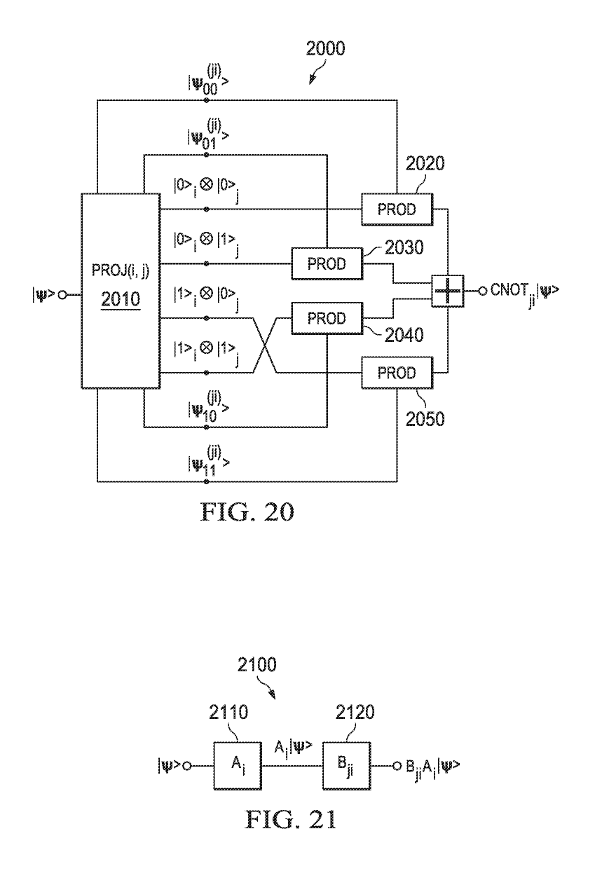

FIG. 20 illustrates one possible schematic for implementing this gate. Specifically, FIG. 20 illustrates an example circuit schematic for a device representing a particular two-qubit gate, a Controlled NOT (CNOT) gate, according to one embodiment. In at least some embodiments, device 2000 may be employed in a quantum computing emulation device to act on qubits j and i. More specifically, the two-qubit CNOTⱼᵢ gate implemented by device 2000 uses qubit i as the target and qubit j as the control. In this example, device 2000 includes a two-qubit projection component (shown as Proj(i, j) component 2010), and four complex product calculation components (shown as Prod components 2020, 2030, 2040, and 2050). In different embodiments, Proj(i, j) component 2010 may be implemented, for example, by device 1400 illustrated in FIG. 14 or by device 1500 illustrated in FIG. 15.

As illustrated in FIG. 20, a CNOT gate takes two inputs and produces two outputs. The two inputs include a controlling (or control) bit (qubit j) and a controlled (or target) bit (qubit i). As illustrated in this example, if the value of the control bit is 1, a NOT operation is applied to the target bit. Otherwise, the target bit is not changed. As in other examples, the implementation of the CNOT gate includes a set of projection operations. However, in this case the input signal is broken into four pieces, rather than two pieces. The control NOT operation is implemented by switching the particular branch on which the controlling bit is one and flipping the target bit. In other words, the conditional is built into the circuit. The use of a CNOT gate in the quantum computing emulation devices described herein may allow these devices to implement a problem solution that include “if” statements or other conditional statements. The CNOT gate, as illustrated in FIG. 20, splits the signal into the parts that need to be operated on and the parts that do not need to be operated on, performs the operation, and then puts the signal components back together again through multiplication and addition operations. In at least some embodiments, rather than constructing gates that operate on 3, 4, or 5 qubits, the quantum computing emulation devices described herein may be scaled up by combining single-qubit gates, two-qubut gates, and CNOT gates. As the device is scaled up, there may be more individual qubits to operate on and more pairs of qubits to operate on, but the corresponding complex signals may not need to be split it up into more than two or four sets of signals in any of these operations. Therefore, emulation of a universal quantum computer may be achieved using this small set of gate types.

For the application of any linear operator, the same general procedure may be followed. Frst, the partial projection signals corresponding to the qubit(s) on which to apply the operator may be constructed. Next, the remaining basis states may be transformed according to the operator matrix elements. Finally, these signals may be multiplied by the partial projection signals to obtain the transformed state.

As previously noted, in some embodiments, a sequence of gate operations may be presented to the quantum computing emulation device in order to perform a computation or implement a problem solution. For example, a first gate operation may be applied to one or two of the qubits represented in the input pair of signals (e.g., the pair of signals representing the initial quantum state). The first gate operation may effect a manipulation or transformation that has been selected by the specification of a collection of DC coefficients. While the gate operation itself may be directed to a subset of the qubits, the entire signal is presented to the programmable gate component as input and the entire signal is put back together following the manipulation or transformation of that subset of qubits. The output of the first gate operation (the transformed signal as a whole) may be stored (e.g., in an analog delay line or, after an A/D conversion, on a digital storage medium). Any subsequent gate operations in the sequence of gate operations may receive, as input, the entire signal as transformed by the previous gate operation and stored. If the transformed signal was stored using a digital representation, it may be converted back to an analog signal by a D/A converter prior to its presentation to the programmable gate component. If the next gate operation in the sequence is different than the previous operation, or if the qubits on which it is to operate are different, a different collection of DC coefficients may be specified for that gate operation prior to presenting the input signal to the programmable gate component (or prior to enabling its operation or output). Once the sequence of gate operations is complete, the entire signal, as transformed by the last gate operation in the sequence, may be directed to a measurement component whose output is a digital representation of the problem solution.

In some embodiments, two or more individual gate operation components within the programmable gate component may act on an input signal prior to the storage of the transformed signal or its output to a measurement component. FIG. 21 illustrates an example circuit schematic for a device 2100 that includes circuitry for performing a set of state transformations, according to one embodiment. In FIG. 21, the initial state, represented by |ψ [symbol] , is first transformed by applying a single-qubit gate A, shown as gate 2110 (for example, a Hadamard gate) to qubit i of state |ψ [symbol] . Subsequently, a two-qubit gate B, shown as gate 2120 (for example, a Controlled NOT (CNOT) gate, acting on qubits i and j), is applied upon the transformed state, Aᵢ|ψ [symbol] , resulting in a final state represented by |ψ′=BⱼᵢAᵢ|ψ [symbol] . In at least some embodiments, device 2100 may be employed in a quantum computing emulation device to effect a state transformation component using two gates.

The above procedures describe how to apply general linear transformations to the QMT state. This includes, but is not limited to, unitary transformations. In some embodiments, this approach to performing gate operations requires only a single subspace decomposition of the original signal into two constituent signals and does not require a full spectral decomposition, as would be required if one were performing an explicit matrix multiplication operation over the entire 2ⁿ-component state. This approach may provide a significant practical advantage to implementation and may more closely emulate the intrinsic parallelism of a true quantum system than some earlier approaches to quantum computing emulation.

In another embodiment, nonlinear transformations may be applied to the QMT state, with interesting implications. For example, it has been shown that the ability to perform nonlinear transformations in a quantum computer may allow one to solve oracle-based #P and NP-complete problems in polynomial time. This result has thus far been of mere theoretical interest, as quantum mechanics appears to be stubbornly linear, but the approach to quantum computing emulation described herein suggests that it may yet be of some practical utility.

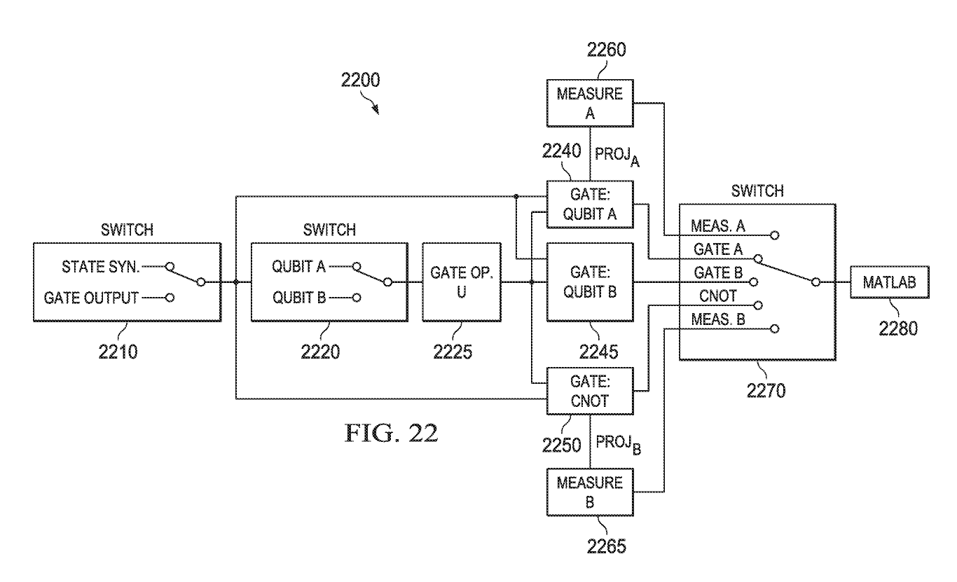

FIG. 22 illustrates an example schematic overview of a programmable gate component of a quantum computing emulation device, according to one embodiment. For example, in one embodiment, gate component 1720 illustrated in FIG. 17 may be implemented by the device 2200 illustrated in FIG. 22. In this example, device 2200 includes circuitry to perform a gate operation on a complex signal that represents a two-qubit quantum state. In this example, device 2200 includes a gate operation component 2225 that includes circuitry to perform a gate operation specified by a collection of complex coefficients. Device 2200 also includes circuitry to provide the output of gate operation component 2225 to three additional gates, shown as gates 2240, 2245, and 2250. The input to gate operation component 2225 is controlled by two switches, shown as 2210 and 2220. In this example, switch 2210 is used to direct either a signal generated by a quantum state synthesis device or a signal that is output from gate 2225 (or one of gates 2240, 2245, or 2250) to the second switch 2220. Switch 2220 is then used to direct the portion of the input signal representing a selected one of the two qubits to the input of gate operation component 2225.

In this example, device 2200 also includes two measurement devices (shown as 2260 and 2265), each of which includes circuitry to produce a digital signal representation of an output of a respective one of gates 2240 and 2250. In this example, the outputs of gates 2240, 2245, and 2250, and the outputs of measurement devices 2260 and 2265 are provided to a switch 2270. Switch 2270 is used to direct one of these outputs to a computer that controls and/or monitors the operation of device 2200 (e.g., a computer on which a quantum computing emulation platform is executing that programs the quantum computing emulation device to produce a solution to a quantum computing problem). This computer is represented in FIG. 22 by element 2280. In one embodiment, this computer may execute a sequence of instructions in a computational language such as the MATLAB® programming language to control and/or monitor the operations of device 2200. For example, various instructions may be presented to device 2200 to select an input complex signal, to select one or more qubits on which to operate, to control a sequence of gate operations to be performed, to select an output to be fed back to the input, to select an output to be measured, and/or to select an output to be recorded, in different embodiments.

In the example illustrated in FIG. 22, device 2200 is a two-qubit device, with qubits labeled as A and B. Processing of the initial quantum state proceeds from left to right. The first switch (switch 2210) selects as the input to the process either a signal generated by a quantum state synthesis device to represent an initial quantum state (e.g., at the beginning of a sequence of gate operations) or a previously transformed signal (e.g., for a subsequent gate operation in the sequence). In this example, the switch is set for the initial quantum state. As noted above, the second switch (switch 2220) controls which of the two qubits is to be operated on by gate operation component 2225. Note that entire the input signal, which is actually a pair of signals, is directed to the gate operation component 2225. In addition, the input signal is split into two additional branches (one of which is further split off into two branches), and each of these branches is directed to one or more of gates 2240, 2245, and 2250. In this example, gate operation component 2225 receives the DC voltage inputs that specify the gate operation to be performed and operates on the qubit signals for either A or B (depending on switch 2220), after which the output of gate operation component 2225 is directed to three different places. Specifically, the output of gate operation component 2225 is split off and sent to the three gates 2240, 2245, and 2250, one of which selects qubit A, one of which selects qubit B, and one of which performs a CNOT operation. The outputs of gates 2240 and 2250 are directed to measurement components 2260 and 2265, respectively. In this example, gates 2240, 2245, and 2250 do not perform gate operations such as the matrix transformations performed by gate operation component 2225. Instead, each of these gates performs a function that is similar (but opposite) of the projection components described herein in that they filter, separate, and/or put different combinations of constituent signals together to create different output options for device 2200. The different output options may include portions of the input signal that have been transformed and/or portions of the input signal that have not been transformed, depending on which qubit(s) were selected to be operated on and which operations were applied to the selected qubit(s).

In this example, on the far right, a third switch (switch 2270) selects the output option that is to be taken as the result of the gate operation from among the outputs of the three gates 2240, 2245, and 2250 and the two measurement components 2260 and 2265. In this example, switch 2270 is set to select the output of gate A (gate 2240). As illustrated in this example, while the signals transformed by gate operation component 2225 are also fed into the other two gates (2245 and 2250), only the output of gate A (2240) is read as the result. In other words, while the gate operation component 2225 operates on the input signal as a whole, the output is selected based on which of the outputs is the result of the specified operation on the specified qubit. In this example, if the switch selects the output of gate 2240, gate 2245 or gate 2250, the selected output may be stored for potential use as an input to a subsequent gate operation. However, if the switch selects the output of measurement component 2260 or measurement component 2265, the selected output may be a DC value representing a final decision or result.

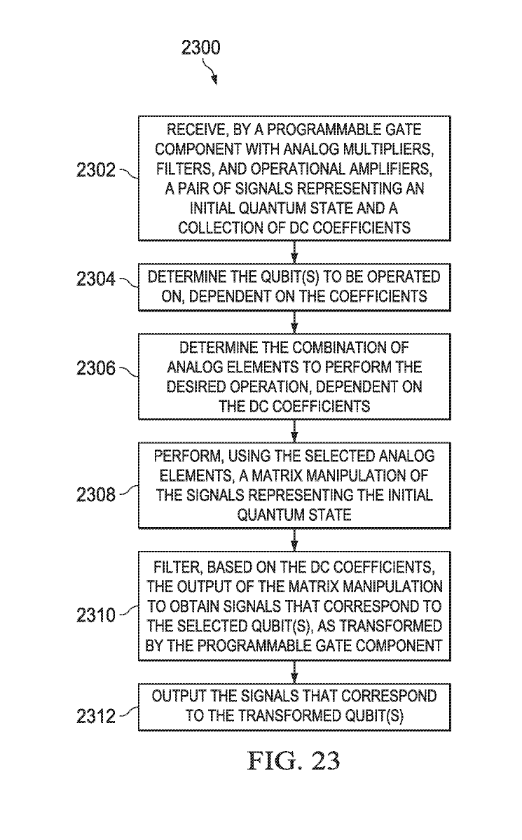

FIG. 23 illustrates an example method 2300 for performing a gate operation in a quantum computing emulation device, according to one embodiment. It is noted that some of the operations of method 2300, as depicted in FIG. 23, may be optional. In various embodiments, method 2300 may start or stop at any operation, and one or more of the operations of method 2300 may be repeated and/or may be performed in a different order than the order depicted in FIG. 23. As illustrated in this example, method 2300 may include receiving, by a programmable gate component that includes analog multipliers, filters, and operational amplifiers, a pair of signals representing an initial quantum state and a collection of DC coefficients (as in 2302). As described in more detail later, in some embodiments, the pair of signals may represent an initial quantum state for one or more qubits in the frequency domain, or an initial quantum state of one or more qubits in the time domain. In another embodiment, multiple parallel pairs of signals may be received to represent an initial quantum state in both the frequency domain and the time domain for one or more qubits. The domain or domains in which each qubit is represented during a given operation may be different. For example, one or more of the qubits to be operated on may be represented in the frequency domain, while other qubits to be operated on may be represented in the time domain or in both the frequency domain and the time domain.

The method may include determining the qubit(s) that are to be operated on, dependent on the coefficients (as in 2304), and determining the combination of analog elements to perform the desired operation, dependent on the DC coefficients (as in 2306). For example, one or more of the DC coefficients may be used to identify the qubit(s) to be operated on (e.g., to control a switch that selects which of the qubits are to be operated on, such as switch 2220 illustrated in FIG. 22), while other ones of the DC coefficients may be used to specify the operation to be performed on the identified qubit(s). In other embodiments, a different type of input may be used to control a switch that selects which of the qubits are to be operated on. In some embodiments, one or more of the DC coefficients may be used to specify, for at least one of the qubits to be operated on, whether the quantum state of the qubit is to be represented in the frequency domain, in the time domain (e.g., using time-bin encoding), or in both the frequency domain and the time domain.

As illustrated in this example, method 2300 may include performing, using the selected analog elements, a matrix manipulation of the signals representing the initial quantum state (as in 2308). The method may include filtering, based on the DC coefficients, the output of the matrix manipulation to obtain signals that correspond to the selected qubit(s), as transformed by the programmable gate component (as in 2310). The method may also include outputting the signals that correspond to the transformed qubit(s) (as in 2312).

A measurement gate may map the quantum state of a quantum computing system to a result that may be useful for solving a particular problem or completing a particular task for which the quantum computing system may be designed to perform. The output of a quantum computing system may be provided by measurement gates. Certain quantum computing algorithms may also use measurement gates in solving a particular problem. As previously noted, in at least some embodiments, the quantum computing emulation devices described herein may include one or more measurement gates to extract information from the transformed signal w representing the transformed quantum state |ψ [symbol] . These measurement gates may include circuitry to take an analog signal generated by the gate operation component, such as an analog signal representing a transformed quantum state, and reduce it to a binary signal. For example, following the performance of one or more gate operations on a complex signal representing an initial quantum state, the resulting complex signal represents a combination of several different binary states. In this example, the measurement gates may be used to collapse result that into one of those binary states.

In some embodiments, collapsing the result into a binary state may be done by sequentially collapsing each of the qubit states. For example, for a given qubit, the signal representing the qubit may be broken into two halves, and the relative amplitude of those two halves may be examined. In one embodiment, a measurement component may include circuitry to computes a root-mean-squared (RMS) voltage between the two halves and may use the result to make a decision about whether to collapse that qubit to the zero state or the one state. After sequentially processing all of the qubits in this manner, the output analog signal may be reduced to a final digital representation of the decision or result.

In some embodiments, the procedure for performing measurements may be similar to the procedure for performing gate operations. For example, to perform a measurement on a qubit i, the partial projection signals ψ₀ⁱ(t) and ψ₁ⁱ(t) may be constructed, and their root-mean-square (RMS) values may be measured. In some embodiments, this may be done by adding the real and imaginary parts of ψ₀ⁱ(t), measuring the RMS value of the sum, and then squaring the result.

In some embodiments, information from the signal ψ representing the quantum state |ψ [symbol] may be extracted by performing a full analysis of all complex components αₓ. This is an order 2ⁿ procedure in the number of required operations, which is referred to herein as the Brute Force approach. For true quantum systems, of course, this cannot be done. Instead, information must be extracted by measuring individual qubits, thereby obtaining a binary sequence and a projection of the state according to the particular sequence of outcomes. Performing sequential measurements of this sort is an order n procedure.

In various embodiments, the output of a measurement gate may be random. In other words, the quantum state may determine a statistical distribution of possible outcomes but may not provide any information about any single or particular outcome.

A measurement gate may use projection operators to determine outcomes. To measure qubit i, the projections Π₀⁽ⁱ⁾|ψ [symbol] and ∇₁⁽ⁱ⁾|ψ [symbol] may be constructed, after which the square magnitude of these states, denoted q₀⁽ⁱ⁾=∥Π₀⁽ⁱ⁾|ψ [symbol] ∥² and q₁⁽ⁱ⁾=∥Π₁⁽ⁱ⁾|ψ [symbol] ∥², may be computed. According to quantum theory, the outcome of such a measurement is 0 with probability p₀⁽ⁱ⁾=q₀⁽ⁱ⁾/(q₀⁽ⁱ⁾+g₁⁽ⁱ⁾) and 1 with probability p₁⁽ⁱ⁾=q₁⁽ⁱ⁾/(q₀⁽ⁱ⁾+q₁⁽ⁱ⁾).

In some embodiments, a measurement gate may be constructed by applying an inner product between the final state, |ψ′ [symbol] , and each basis state, with α′ₓ= [symbol] x|ψ′ [symbol] representing the component of |ψ′ [symbol] corresponding to the basis state |x [symbol] .

Measurement gates may also be constructed by modifying the quantum state to include a random component. Specifically, for a general n-qubit quantum state |ψ [symbol] given by

$$\vert ψ 〉 = {\sum }_{x = 0}^{{2}^{n - 1}} {α}_{x} \vert x 〉$$

the signal \tilde{ψ} is constructed corresponding to the modified quantum state [symbol] given by

$$= {\sum }_{x = 0}^{{2}^{n - 1}} ( {α}_{x} + {v}_{x} ) \vert x 〉 ,$$

where vₓ, represents a random variable following a particular statistical distribution.

In one embodiment, given \tilde{ψ}, the projection signals \tilde{ψ}₀⁽ⁱ⁾ and \tilde{ψ}₁⁽ⁱ⁾ may be constructed in the manner described above, after which the squared magnitudes may be obtained via a low-pass filter of their square magnitude values. This results in the values \tilde{q}₀⁽ⁱ⁾ and \tilde{q}₁⁽ⁱ⁾. For a specified threshold γ²>0, an outcome of 0 may be deemed to have occurred if \tilde{q}₀⁽ⁱ⁾>γ² and \tilde{q}₁⁽ⁱ⁾≦γ², while an outcome of 1 may be deemed to have occurred if \tilde{q}₁⁽ⁱ⁾>γ² and \tilde{q}₀⁽ⁱ⁾≦γ². Otherwise, the result may be marked as invalid. In some embodiments, invalid measurements may be rejected in the final analysis of results. Other representations of measurement gates may be possible, in different embodiments.

In some embodiments, a process to measure qubit i may begin by constructing the projections Π₀⁽ⁱ⁾|ψ [symbol] from the partial projections |ψ₀⁽ⁱ⁾ [symbol] and |ψ₁⁽ⁱ⁾ [symbol] , respectively. Let

q₀⁽ⁱ⁾:=∥Π₀⁽ⁱ⁾|ψ∥²=<ψ|Π₀⁽ⁱ⁾|ψ [symbol] , q₁⁽ⁱ⁾:=∥Π₁⁽ⁱ⁾|ψ∥²=<ψ|Π₁⁽ⁱ⁾|ψ

[symbol]

denote the magnitudes of these projections.

According to the generalized Born rule, the outcomes 0 and 1 occur with probability p₀⁽ⁱ⁾ ∝q₀⁽ⁱ⁾ and p₁⁽ⁱ⁾∝g₁⁽ⁱ⁾, and these probabilities may be computed explicitly through analog sum and division operations. For each such qubit measurement, a random input DC voltage representing a random number uᵢ, chosen uniformly in the interval [0, 1], may be input to a comparator device such that when uᵢ>p₀⁽ⁱ⁾ a binary outcome of 1 is obtained with a probability given by the Born rule.

Therefore, according to the generalized Born rule, the probability of outcome aε{0, 1} is

$${P}_{a}^{( i )} := \frac{〈 ψ \vert {II}_{a}^{( i )} \vert ψ 〉}{ψ \vert ψ 〉} = \frac{{q}_{a}^{( i )}}{{q}_{0}^{( i )} + {q}_{1}^{( i )}} .$$

In this example, |ψ [symbol] is not assumed to be normalized.

The quantum state after measurement, in accordance with the projection postulate of wavefunction collapse, will be one of the two projections (either Π₀⁽ⁱ⁾|ψ [symbol] or |₁⁽ⁱ⁾|ψ [symbol] ), depending upon which outcome is obtained. Equivalently, the collapsed state may be taken to be one of the partial projections (either |ψ₀⁽ⁱ⁾ [symbol] or |ψ₁⁽ⁱ⁾ [symbol] ), thereby collapsing to a state of n−1 qubits.

To measure a second qubit j≠i, the same procedure is followed, but it may use the (unnormalized) “collapsed” state II₀⁽ⁱ⁾|ψ [symbol] or II₁⁽ⁱ⁾|ψ [symbol] , depending upon whether outcome 0 or 1, respectively, was obtained in the first measurement. In some embodiments, the selection of the collapsed state may be implemented through a simple switch controlled by the binary measurement output. This procedure may be repeated until all n qubits are measured. Doing so results in an n-bit digital output whose distribution follows the quantum mechanical predictions, at least to the limits of hardware fidelity.

From the collapsed state |ψ¹ [symbol] =Πₐ⁽ⁱ⁾|ψ [symbol] the conditional weights may be computed, as follows, for bε{0, 1}

q_{b|a}^{(j|i)}:= [symbol] ψ¹|Π_{b}^{(j)}|ψ^{l} [symbol] = [symbol] ψ|Πₐ⁽ⁱ⁾Π_{b}⁽ⁱ⁾Πₐ⁽ⁱ⁾|ψ [symbol] = [symbol] ψ|Πₐ⁽ⁱ⁾Π_{b}⁽ⁱ⁾|ψ

[symbol]

The conditional probability of obtaining outcome b on qubit j, given outcome a on qubit i, is therefore

$${P}_{b \vert a}^{j \vert i} := \frac{〈 ψ \vert {II}_{a}^{( i )} {II}_{b}^{j} \vert ψ 〉}{〈 ψ l \vert {II}_{a}^{( i )} \vert ψ 〉} = \frac{{q}_{b \vert a}^{( j \vert i )}}{{q}_{a}^{( i )}}$$

The joint probability of both outcomes is then P_{ab}^{(ij)}:=Pₐ⁽ⁱ⁾P_{ba}^{(ji)}= [symbol] |IIₐ⁽ⁱ⁾II_{b}^{j}|ψ [symbol] / [symbol] ψ|ψ [symbol] .

In the QMT representation described thus far, there is no sense of a random outcome; whereas, a quantum computer is generally conceived as being probabilistic. There are several approaches one might take, then, to representing a measurement gate. One approach, the Brute Force approach described earlier, would be to extract explicitly all 2ⁿ complex components of the state. Three alternative approaches are presented below, according to different embodiments.

Binary Search:

in many quantum computing algorithms, the final state has either a single non-zero component or one dominant component, corresponding to the correct answer. In this case, an order −n scaling procedure may be used to compute sequentially first q₀⁽⁰⁾ and q₁⁽⁰⁾), then either

$$q \frac{( 0 \vert 0 )}{0 \vert 0} and q \frac{( 1 \vert 0 )}{1 \vert 0} ( if {q}_{0}^{( 0 )} > {q}_{1}^{( 0 )} ) or q \frac{( 0 \vert 1 )}{0 \vert 1} and q \frac{( 1 \vert 1 )}{1 \vert 1} ( otherwise ) ,$$

etc., selecting the larger of the two at each stage and thereby perform a binary search to identify the non-zero (or dominant) component.

Simulation:

with a ready supply of random numbers serving the role of hidden variables, one could replicate the generalized Born rule and thereby replicate quantum statistics rather trivially. Suppose u₀, u₁, . . . , uₙ₋₁ is a realization of n independent and identically distributed uniform random variables drawn from the unit interval [0, 1]. In this example, it may be assumed that the outcome of measuring qubit 0, denoted x₀, is 1 if u₀>P₀⁽⁰⁾ and is 0 otherwise. The signal ψ may then be replaced by that corresponding to the collapsed projection IIₓₒ⁽⁰⁾|ψ [symbol] . Continuing in this manner, a measurement of qubit i, given the previous outcomes xo, . . . , xᵢ₋₁, yields xᵢ=1 if

uᵢ>P_{0|xi-1, . . . , x0}^{(i|i-1, . . . 0)}= [symbol] ψ|II₀⁽ⁱ⁾IIₓᵢ₋₁⁽ⁱ⁻¹ . . . IIₓ₀⁽⁰⁾|ψ/ [symbol] ψ|IIₓᵢ₋₁⁽ⁱ⁻¹⁾ . . . IIₓₒ⁽⁰⁾|ψ [symbol] and xᵢ=0 otherwise for i=0, . . . , n−1. This approach may be useful for quantum simulation. For the case in which there is one dominant component, this approach reduces to a binary search.

Threshold Detection:

This approach may use a wholly deterministic formulation of the measurement procedure that nevertheless reproduces, or at least approximates, the generalized Born rule. One example would be to use a signal-plus-noise model with amplitude threshold detection. In this scheme, each aₓ is replaced by aₓ=saₓ+vₓ, where s≧0 is a scale factor and each vₓ is a complex random variable representing a hidden variable state. Collectively, v₀, . . . , v₂ₙ₋₁ follow a certain joint probability distribution. For example, they may be independent and identically distributed complex Gaussian random variables with zero mean. The quantum state described earlier may now be represented by a random signal of the form

$$ψ ( t ) = {\sum }_{x = 0}^{2 n - 1} {a}_{x} {∅}_{x} ( t ) .$$

In this example, the weights q₀⁽ⁱ⁾= [symbol] ψ|Π₀⁽ⁱ⁾|ψ [symbol] and q₁⁽ⁱ⁾= [symbol] ψ|Π₁⁽ⁱ⁾|ψ [symbol] , now random variables by virtue of the noise term, may be computed in the same manner but are now compared against a threshold γ²>0 for a particular realization of ψ. If exactly one of the two components exceeds the threshold, then it may be said that a single detection has been made (i.e., a valid measurement has been performed) and the outcome is either 0 or 1, depending upon whether q₀⁽ⁱ⁾>γ² or q₁⁽ⁱ⁾>γ², respectively. In some embodiments, multi-qubit measurements may use wavefunction collapse to the detected subspace projection, as described above. Surprisingly, for many cases of interest to quantum computing, it can be shown that such an approach yields results that are comparable, if not identical, to those predicted by the Born rule.

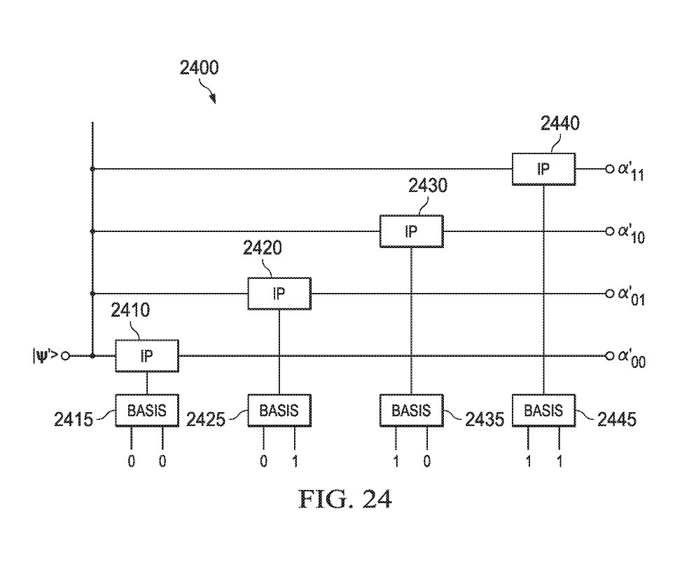

FIG. 24 illustrates an example circuit schematic for a device 2400 that includes circuitry for extracting the constituent components of a quantum state, according to one embodiment. In this example, device 2400 includes four basis state generation components (shown as Basis components 2415, 2425, 2435, and 2445), and four inner product components (shown as IP components 2410, 2420, 2430, and 2440). In one embodiment, one or more of Basis components 2415, 2425, 2435, or 2445 may be implemented by device 1000 illustrated in FIG. 10. In FIG. 24, the input state ψ′ [symbol] is related to the output components α′ via the relation |ψ [symbol] =α′₀₀|00 [symbol] α′₀₁|01 [symbol] +α′₁₀|10 [symbol] +α′₁₁|11 [symbol] . In at least some embodiments, device 2400 may be employed in a quantum computing emulation device to implement a state analysis measurement component that produces α′ from |ψ′).

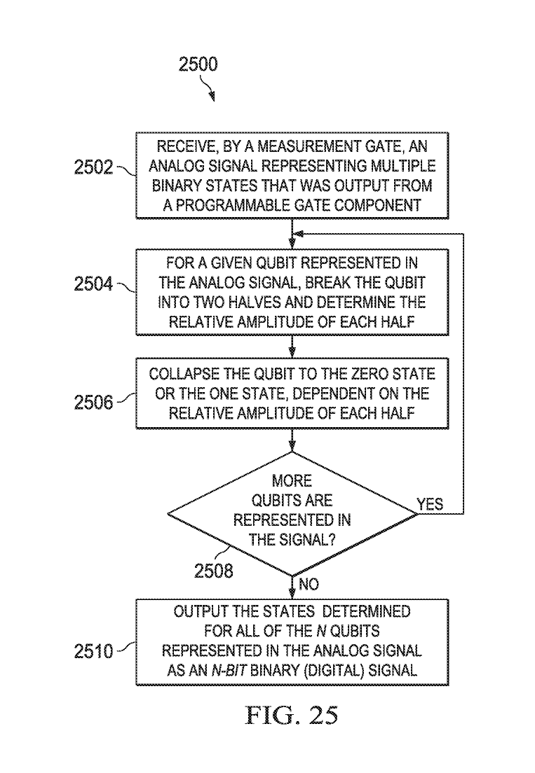

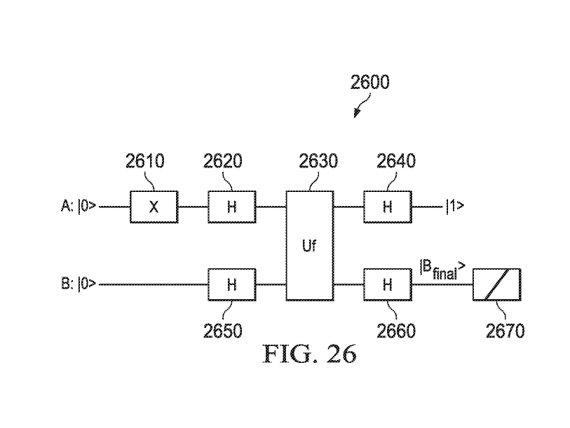

FIG. 25 illustrates an example method 2500 for measuring the results of a quantum computing operation performed in a quantum computing emulation device and returning a digital answer, according to one embodiment. It is noted that some of the operations of method 2500, as depicted in FIG. 25, may be optional. In various embodiments, method 2500 may start or stop at any operation, and one or more of the operations of method 2500 may be repeated and/or may be performed in a different order than the order depicted in FIG. 25. As illustrated in FIG. 25, method 2500 may include receiving, by a measurement gate, an analog signal representing multiple binary states that was output from a programmable gate component (as in 2502). The method may include, for a given qubit represented in the analog signal, breaking the qubit into two halves and determining the relative amplitude of each half (as in 2504). The method may include collapsing the qubit to the zero state or the one state, dependent on the relative amplitude of each half (as in 2506). As described herein, other methods may be used to determine a measurement outcome. For example, in some embodiments, the relative amplitudes may be used to determine a probability for obtaining 0 or 1 and then an outcome may be randomly selecting according to this probability.

If (at 2508) there are more qubits represented in the signal, the operations shown as 2504 and 2506 may be repeated for each additional qubit that is represented in the signal. If, or once (at 2508), there are no additional qubits represented in the signal, the method may include outputting the states that were determined for all of the n qubits that were represented in the analog signal as an n-bit binary (digital) signal (as in 2510).

As previously noted, a quantum computing emulation device capable of initializing the system into an arbitrary two-qubit state and operating one of a universal set of gate operations has been built it hardware. This device uses a signal generator to produce a baseline 1000 Hz tonal, from which all other signals are generated and are thereby phase coherent. The lower frequency qubit, qubit B, is taken from the signal generator, with a separate, 90-degree phase-shifted signal used to represent the imaginary component. The higher frequency qubit, qubit A, is derived from qubit B via complex multiplication, which results in frequency doubling. Thus, ω_{A}=2π(2000 Hz) and ω_{B}=2π(1000 Hz). The two single-qubit signals are multiplied to produce the four basis signals φ₀₀ (t)=e^{j(ω}^{_{A}}^{+ω}^{_{B}}⁾^{^{t}}, φ₀₁(t)=e^{j(ω}^{_{A}}^{-ω}^{_{B}}⁾^{^{t}}, φ₁₀(t) =e^{j(-ω}^{_{A}}^{+ω}^{_{B}}⁾^{^{t}}, and φ_{11l (t)=e}^{j(-ω}^{_{A}}^{-ω}^{_{B}}⁾^{^{t}} centered at frequencies+3000 Hz, +1000 Hz, −1000 Hz, and −3000 Hz, respectively.

In this device, state synthesis is performed by multiplying these four basis signals by four complex coefficients α₀₀, α₀₁, α₁₀, and α₁₁, each represented by pairs of direct current (DC) voltages, and adding the results to produce the final, synthesized signal ψ(t) representing the quantum state |ψ [symbol] . In one example, a synthesized signal, which is a pair of signals representing the real and imaginary parts of ψ(t) were generated in the hardware. In this example, the state was specified by the complex coefficients α₀₀=0.6579-0.2895j, α₀₁=0.5385+0.1383j, α₁₀=−0.2280+0.3953j, and α₁₁=−0.2460-0.4277j.

To implement gate operations, the device includes a set of analog four-quadrant multipliers, filters, and operational amplifiers to realize the mathematical operations described herein. For example, to perform a gate operation on qubit A, a pair of low-pass filters is used to remove the 2000 Hz component from e^{±jω}^{_{A}}^{t}ψ(t). The resulting partial projections ψ₀^{A}(t) and ψ₁^{A}(t) are a pair of 1000 Hz signals corresponding to qubit B. To perform the gate operation, a matrix U, given by

$$U = [ \begin{matrix}{U}_{00} & {U}_{01} \\ {U}_{10} & {U}_{11}\end{matrix} ] = [ \begin{matrix}0.1759 + 0.1836 j & 0.4346 + 0.8460 j \\ - 0.4346 + 0.8640 j & 0.1759 - 0.1836 j\end{matrix} ]$$

is used it to construct two qubit-A signals of the form U₀₀e^{jω}^{_{A}}^{t}+U₁₀e^{-jω}^{_{A}}^{t} and U₀₁e^{jω}^{_{A}}^{t}+U₁₁e^{-jω}^{_{A}}^{t}. These, in turn, are multiplied by the corresponding partial projections and added to form the final signal ψ′(t), given by

ψ′(t)=(U₀₀e^{jω}^{_{A}}^{t}+U₁₀e^{-jω}^{_{A}}^{t})ψ₀^{A}(t)+(U₁₀e^{jω}^{_{A}}^{t}+U₁₁e^{-jω}^{_{A}}^{t})ψ₁^{A}(t)

The quality of a quantum state or gate operation is typically measured in terms of the gate fidelity, a number between 0 and 1, where 1 is ideal. For an ideal state |ψ [symbol] and measured state |\tilde{ψ} [symbol] , the fidelity is

$$F ( \hat{ψ} , ψ ) = \frac{\vert 〈 \hat{ψ} \vert ψ 〉 \vert}{‖ \hat{ψ} ‖ ‖ ψ ‖}$$

Using this definition, the fidelity of a state synthesis or gate operation over an ensemble of random realizations can be measured.

As an illustration, a synthesis of the entangled singlet state |ψ [symbol] =[|01 [symbol] −|10 [symbol] ]/\sqrt{2} was performed and the fidelity of the signal used to emulate this state (just prior to performing a gate operation on it) was examined. Using the fidelity equation shown above, the ideal quantum state was compared to the state that was measured, using the recorded signal to compute the inner product [symbol] \tilde{ψ}|ψ [symbol] and the normalization ∥\tilde{ψ}∥. The results of this analysis, which included a histogram of fidelity over 500 realizations of the emulated signal, indicated a mean state fidelity of 0.991≈99%.

A similar technique was used to measure gate fidelity. Given a pure singlet state, a random ensemble of unitary gates was applied on qubit A. For each realization of a gate U, the ideal quantum state is |ψ′ [symbol] =U|ψ [symbol] . If the measured state is denoted by \hat{ψ}′, then the gate fidelity will be F(\hat{ψ}′, ψ′). The results for this example indicated that, over an ensemble of 500 runs, a mean fidelity of 0.989≈99% was obtained.

As previously noted, a quantum computing device, and the quantum computing emulation devices described herein, may be well suited to solving particular types of numerical optimization problems. One of the first demonstrations of the computational advantage of a quantum computer was given by David Deutsch. The original problem concerns a simple Boolean function ƒ: {0, 1} [symbol] {0, 1} and determining whether it is such that ƒ(0)=ƒ(1) or ƒ(0)≠ƒ(1). In the more general DeutschJozsa problem, the goal is to determine whether a given function ƒ: {0, 1}ⁿ [symbol] {0, 1} is either constant (i.e., ƒ(x)=ƒ(y) for all x, y) or balanced (i.e., ƒ(x) =0 for exactly half of the possible values of x), assuming it is one of the two. On a classical (digital) computer, the only way to do this, with certainty, is to evaluate ƒ for up to 2ⁿ/2+1 inputs (in case the first half all give the same value). On a quantum computer, only a single application of ƒ is needed, due to quantum parallelism.

To follow the standard quantum computing algorithm, but using a QMT signal representation, one may begin with a signal of the form

ψ(t)=e^{iω}^{ₙ}^{t}. . . e^{iω}^{₁}^{t}e^{-iω}^{₀}^{t}.

This signal may represent the (n+1)-qubit quantum state |ψ [symbol] =|0 . . . 0 [symbol] |1 [symbol] . More specifically, the left n qubits may represent the input register, while the right qubit may represent the output register. In accordance with the quantum algorithm, n Hadamard gates may be applied to the input register and one Hadamard gate may be applied to the output register to obtain

ψ′(t)=i2^{(n+1)/2} cos(ωₙt) . . . cos(ω₁t)sin(ω₀t).

This provides a superposition of all 2ⁿ possible inputs. More explicitly, one may write

$${ψ}^{′} ( t ) = i {\sum }_{{x}_{n} = 0}^{1} … { \sum }_{{x}_{i} = 0}^{1} \frac{{φ}_{{x}_{n}}^{{ω}_{n}} ( t ) … {φ}_{{x}_{1}}^{{ω}_{1}} ( t ) }{\sqrt{{2}^{n - 1}}} sin ( {ω}_{0} t ) .$$

Next, an n-qubit unitary gate U_{ƒ} may be applied to the input register, and a Hadamard gate may be applied to the output register, such that the resulting signal is

$${ψ}^{n} ( t ) = {\sum }_{x ∈ {\{ 0 , 1 \}}^{n}}^{ } \frac{{( - 1 )}^{f ( x )}}{\sqrt{{2}^{n}}} {φ}_{{x}_{n}}^{{ω}_{n}} ( t ) … {φ}_{{x}_{n}}^{{ω}_{1}} ( t ) {e}^{- i {ω}_{0} t} .$$

Here, x=(x₁, . . . , xₙ). It is known that a Uƒ may be constructed from a polynomial number of one- and two-qubit gates, and the same is true for signals using analog filters.

In particular, ƒ may be specified uniquely by a parameter a ε{0, . . . , 2ⁿ⁺¹−1} whose (little endian) binary representation is written aₙ . . . a₁a₀. In terms of a, then, Uf may be written explicitly as

U_{ƒ}=Cₙ₀^{a}^{ₙ} . . . Cₗ₀^{α}^{₁}X₀^{α}^{₀}.

Here, Cᵢ₀ is a CNOT gate with control qubit i and target qubit 0, X₀ is a NOT gate applied to qubit 0, and a zero exponent corresponds to the identity. Note that ƒ is constant if and only if a<2. In the final step, n Hadamard gates may be applied to the input register to obtain

$${ψ}^{m} ( t ) = {\sum }_{x , y ∈ {\{ 0 , 1 \}}^{n}}^{ } \frac{{( - 1 )}^{f ( x ) + x \cdot y}}{{2}^{n}} {φ}_{{x}_{n}}^{{ω}_{n}} ( t ) … {φ}_{{y}_{1}}^{{ω}_{1}} ( t ) {e}^{- i {ω}_{0} t} .$$

Here, x·y=x₁y₁+ . . . +xₙyₙ (modulo 2).

The resulting signal is such that there is always exactly one non-zero frequency component (i.e., the quantum state has exactly one non-zero amplitude). In particular, ƒ will be constant if and only if the component |0 . . . 0 [symbol] |1 [symbol] of |ψ′″ [symbol] has unit magnitude. To determine whether or not this is the case, one need only measure the input register.

As described above in the discussion of measurement gates, qubits n through 1 may be measured sequentially by first multiplying ψ′″(t) by e^{-iω}^{₀}^{t}, low-pass filtering the resulting signal, and then computing the magnitude of the resulting projection state. Continuing in this manner allows an efficient binary search over the n input register qubits. If the outcome of any of these measurements is not 0, then it may be concluded that ƒ is balanced; otherwise, it may be concluded that ƒ is constant.

Interestingly, one can go further and extract the actual value of the parameter a. For example, it can be shown that the first n binary digits of a (i.e., aₙ, . . . , a₁) are given the measurement outcomes of qubits n through 1, respectively. Now, by construction, the qubit 0 state is |1 [symbol] , independent of a₀; however, if the sign of the non-zero frequency component examined (which is not possible in a true quantum system), it may be deduced that a₀=0 if it is positive and a₀=1 if it is negative. Specifically, using the deduced values of the first n qubits, the inner product [symbol] aₙ . . . a₁1|ψ′″ [symbol] may be computed. If the real part of this inner product is positive, then a₀=0; otherwise, a₀=1. In this way, in addition to determining whether ƒ is constant or balanced, the one of the 2ⁿ+1 possible functions that was implemented may be uniquely identified using only a single application of the oracle.

This algorithm has been implemented in the MATLAB® programming language using a digital simulation of the signals and gate operations, such as those described herein. Idealized filters and lossless components were assumed in the simulation. To study robustness, white Gaussian noise was added to the input signal. The results of one such run of the Deutsch Jozsa algorithm for n=5 showed the final signal, prior to measurement, with noise added to the signal to achieve a 10 dB signal-to-noise ratio (SNR). Despite the low SNR value, the simulated measurements were easily able to correctly estimate the function parameter value (a=101000, in this case).

FIG. 26 illustrates an example schematic for implementing the Deutsch-Jozsa algorithm in a quantum computing emulation device, such as those described herein. In this example, the device 2600 includes an n-qubit unitary gate U_{ƒ} (shown as gate 2630), two Hadamard gates on the inputs (shown as gates 2620 and 2650), and two Hadamard gates on the outputs (shown as gates 2640 and 2660). In this example, device 2600 also includes a NOT gate 2610 and a circuit 2670 to add noise to the final signal prior to measurement.

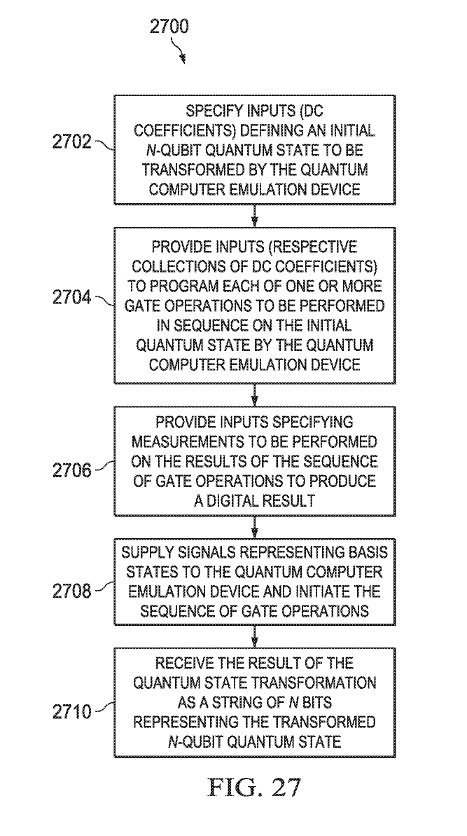

FIG. 27 illustrates an example method 2700 for programming and operating a quantum computing emulation device, according to one embodiment. It is noted that some of the operations of method 2700, as depicted in FIG. 27, may be optional. In various embodiments, method 2700 may start or stop at any operation, and one or more of the operations of method 2700 may be repeated and/or may be performed in a different order than the order depicted in FIG. 27. As illustrated in this example, method 2700 may include specifying inputs (e.g., DC coefficients) defining an initial n-qubit quantum state to be transformed by the quantum computer emulation device (as in 2702). The method may include providing inputs (e.g., respective collections of DC coefficients) to program each of one or more gate operations to be performed in sequence on the initial quantum state by the quantum computer emulation device (as in 2704). The method may also include providing inputs specifying measurements to be performed on the results of the sequence of gate operations to produce a digital result (as in 2706).

Once the quantum computing emulation device has been programmed as in 2702, 2704, and 2706, the method may include supplying signals representing a collection of basis states to the quantum computer emulation device and initiating the programmed sequence of gate operations (as in 2706). The method may also include receiving the result of the quantum state transformation as a string of n bits representing the transformed n-qubit quantum state (as in 2710).

One quantum computing emulation device that has been constructed as a demonstration system is limited to two qubits. In other embodiments, additional qubits may be implemented, with additional bandwidth requirements that may scale exponentially with the number of qubits. The complexity of the filters needed to perform the subspace projection operations may increase similarly with the number of qubits. Based on results of prototyping and simulations, it is expected that, using current integrated circuit technology, a device of up to 20 qubits may fit easily on single integrated circuit device, while 40 qubits may represent a practical upper limit on such a device.

A variety of different software packages currently exist for simulating quantum computers. These existing software packages rely on representing the quantum state and quantum operations in terms of matrix operations. In some embodiments of the systems described herein, a quantum computing emulation platform may (unlike existing software packages) provide a means to interface with a physical (hardware) electronic device capable of emulating quantum states and quantum computing operations using analog electronic signals to represent quantum states and analog electronic circuits to perform operations on those signals. In some embodiments, the quantum computing emulation platform may also be capable of controlling a simulator of such a device, which simulates the analog electronic signals and their attendant operations. In other words, the quantum computing emulation platform may be used both to simulate and to interface with a quantum computing emulation device, through respective interfaces. The quantum computing emulation platform may understand the operation of a class of quantum emulation devices and may be configured to interface with one or more particular hardware implementations of such devices through specific device interfaces. For example, the quantum computing emulation platform may include software components that, when executed, program various gates of a quantum computing emulation device, configure the initial settings on the device, and control the starting and stopping of the performance of a quantum computing exercise by the analog electronic circuits of the device. In some embodiments, a simulator of a quantum computing emulation device may simulate many of the basic operations of the device, although at a higher level. For example, the simulator may not simulate all of the individual circuits of the device, but may simulate the high-level functionality of the device and/or various device components of the device.

In some embodiments, many of the components of the quantum computing emulation platform may be used for controlling both a quantum computing emulation device and a corresponding simulator. However, some of the interface components that would be used to drive the simulator may, in order to control the quantum computing emulation device, be replaced with interface components that enable data and control signals to be provided to the device. In some embodiments, the quantum computing emulation platform may include one or more device interfaces and one or more simulator interfaces, one of which may be selected for use during a given quantum computing exercise depending on whether the exercise is to be performed on a quantum computing emulation device or on a simulator of such a device.

In at least some embodiments of the present disclosure, the quantum computing emulation platforms described herein may be used to control a variety of different quantum computing emulation devices or corresponding simulators with very little modification. For example, in some embodiments, in order to interact with a different quantum computing emulation device, only the device interface may need to be replaced. For example, in an embodiment in which a quantum computing emulation device is implemented on a single printed circuit board, the interface between the quantum computing emulation platform and the quantum computing emulation device may be very different than in an embodiment in which the quantum computing emulation device is implemented on multiple printed circuit boards or breadboards. In some embodiments, the quantum computing emulation platforms described herein may include multiple device interfaces and/or simulator interfaces, specific ones of which are selectable at runtime time drive particular quantum computing emulation devices and/or simulators.

As described in more detail below, the quantum computing emulation platforms described herein may include multiple controllers for interfacing with a quantum computing emulation device, programming the device to perform particular quantum computing operations, and collecting data representing the results of those operations. In at least some embodiments, a master controller (implemented as a master control script) may be used to initialize the device to perform particular sets of gate operations, a second controller (implemented a set control script) may be used to program the specific gate operations performed during individual execution runs in each set of gate operations and prepare to collect the results, and a third controller (implemented as a run control script) may control the starting, stopping, and data collection for each specific gate operation (each individual execution run in the set).

In some embodiments, a quantum computing emulation platform may be implemented by program instructions executing on a computing system. For example, the computing system on which the quantum computing emulation platform is implemented may be a desktop computing, a laptop computer, a tablet device or another type of portable wired or wireless computing device. The computing system may run any suitable operating system including, but not limited to, the Windows® operating system, the Linux® operating system, and/or the Mac OS® operating system. In some embodiments, the program instructions that implement the quantum computing emulation platform may include or call methods provided in a commercially available signal processing or data acquisition packages, such as the Signal Processing Toolbox™ and/or Data Acquisition Toolbox™ available from The Mathworks, Inc. One such software package may include program instructions that, when executed, generate the control and data signals for interacting with particular A/D convertors, D/A convertors, and/or other hardware components on the quantum computing emulation device and provide these signals at an interface (e.g., on particular pins) of the device through which the quantum computing emulation platform is coupled to the device. Various components of the quantum computing emulation platform may be implement as scripts written in the MATLAB® programming language or another suitable scripting language. In one embodiment, one or more components of the quantum computing emulation platform that are used solely for simulation may be implemented using Octave, a high-level interpretive language similar distributed under the GNU General Public License.

As noted above, in some embodiments, the quantum computing emulation platforms described herein may include a variety of scripts to implement different operations on a quantum computing emulation device and/or a simulator of such a device. In one embodiment, there are three main control scripts used when collecting data resulting from the performance of quantum computing operations: a master control script, a set control script, and a run control script. The master control script may be used to set the properties of the device or simulator for the type of data acquisition to be done, including programming in the initial state, the number of gates to be run and the specific gates to be runs, and setting up data acquisition session properties, as well as the data collection variables in which data to be played out and/or recorded is to be stored. Once the general properties of the session are set in the master control script, the set control script may set specific properties for each set of gate runs in the acquisition session and may loop through the runs in each set, calling the run control script for each one. Finally, the run control script may set up and invoke each individual gate run, including allocating the data in and data out after each gate. For each single gate operation, a data acquisition session is created, the gate coefficients for implementing the gate operation and other control signals are played out, and the results are recorded in the variables that are configured to collect it.

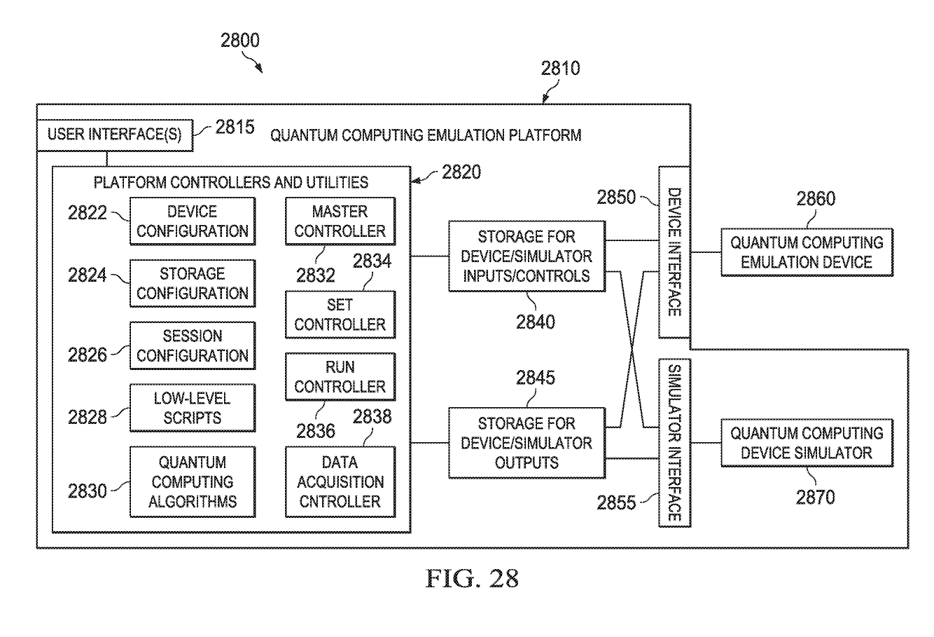

FIG. 28 illustrates an example system 2800 including a quantum computing emulation platform 2810, according to one embodiment. In this example embodiment, quantum computing emulation platform 2810 includes one or more user interfaces 2815, multiple platform controllers and utilities 2820, storage for device and/or simulator controls and other inputs (shown as 2840), storage for device and/or simulator outputs (shown as 2845), a device interface 2850, through which quantum computing emulation platform 2810 interacts with a quantum computing emulation device 2860, and a simulator interface 2855, through which other components of quantum computing emulation platform 2810 interact with a quantum computing device simulator 2870.

In various embodiments, user interfaces 2815 may include any of a variety of script-based interfaces, command-line-based interfaces, or graphical user interfaces (GUIs) through which the quantum computing emulation platform 2810 may be programmed to control the performance of quantum computing operations by quantum computing emulation device 2860 and/or quantum computing device simulator 2870. In some embodiments, users may exchange inputs and/or outputs provided to or received from device interface 2850 and/or simulator interface 2855 via user interfaces 2815 (not shown).

In at least some embodiments, quantum computing emulation device 2860 may be similar to quantum computing emulation device 400 illustrated in FIG. 4 and described above. In one embodiment, quantum computing emulation device 2860 may include a basis board (which generates all of the basis functions for a 2-qubit system, including 2 kHz single qubit basis functions), a state synthesis board (on which complex coefficients of the programed quantum state are multiplied onto their respective basis functions and then summed together), a gate board (on which the multiplications for applying a single qubit gate or NOT gate takes place), a qubit A board (on which partial projections are created through complex multiplications with the conjugate qubit A basis functions), a qubit B board (on which partial projections are created through complex multiplications with the conjugate qubit B basis functions), a low-pass-filter (LPF) board (on which the actual gate operation of a controlled 2-qubit gate occurs), and an output board (on which the final signals that are to be recorded are switched and low-pass filtered in order to remove unwanted high frequency noise). In other embodiments, quantum computing emulation device 2860 may include more, fewer, or different components that collectively implement some or all of the functionality of the quantum computing emulation devices described herein. In at least some embodiments, quantum computing device simulator 2870 may simulate, at a high level, the operations of quantum computing emulation device 2860.

In this example, platform controllers and utilities 2820 includes a device configuration component 2822, a storage configuration component 2824, a session configuration component 2826, one or more low-level scripts 2828 (e.g., scripts for generating an appropriate time series and trimming off transients, scripts for generating basis functions and calculating the effects of gates on signals from exact coefficients, scripts for emulating a gate operation, scripts for providing data and control signals to hardware components on a quantum computing emulation device, scripts for emulating arithmetic quantum functions, scripts for emulating the application of a single-qubit gate to a qubit, etc.), a quantum computing algorithms component (e.g., a Deutsch test script), a master controller 2832, a set controller 2834, a run controller 2836, and a data acquisition controller 2838. In other embodiments, platform controllers and utilities 2820 may include more, fewer, or different software component that collectively implement the functionality of the quantum computing emulation platforms described herein.

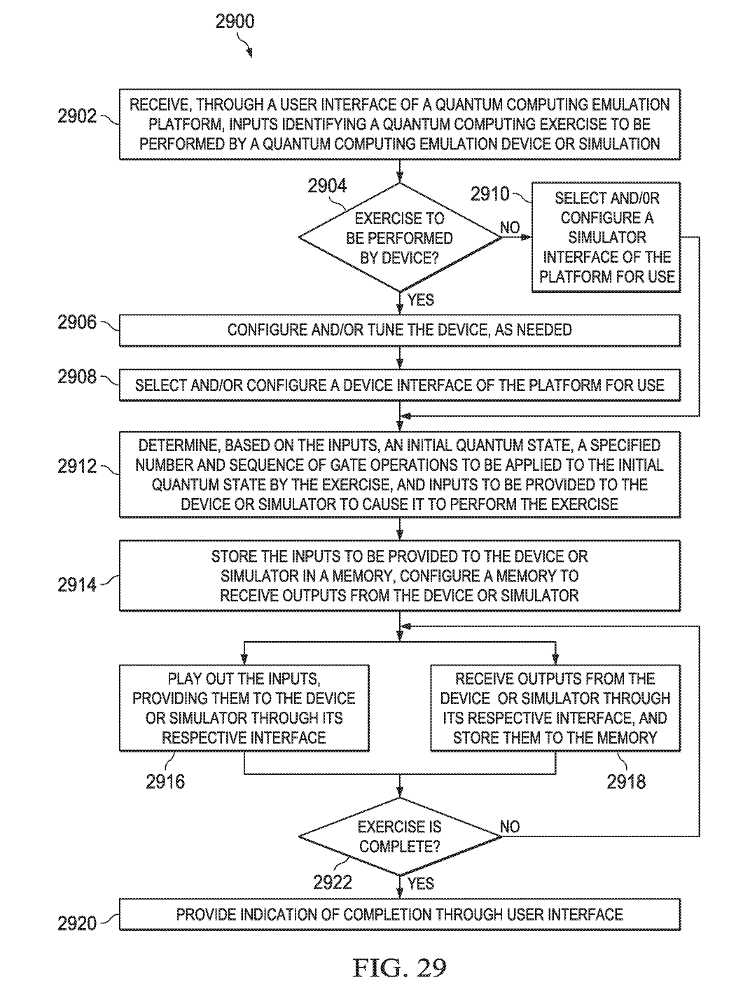

FIG. 29 illustrates an example method 2900 for controlling and simulating a quantum computing emulation device, according to one embodiment. It is noted that some of the operations of method 2900, as depicted in FIG. 29, may be optional. In various embodiments, method 2900 may start or stop at any operation, and one or more of the operations of method 2900 may be repeated and/or may be performed in a different order than the order depicted in FIG. 29. In this example embodiment, method 2900 includes (at 2902) receiving, through a user interface of a quantum computing emulation platform, inputs identifying a quantum computing exercise to be performed by a quantum computing emulation device or a simulation of such a device.

If (at 2904) it is determined that the quantum computing exercise is to be performed by a quantum computing emulation device, the method may proceed to 2906. Otherwise, the method may proceed to 2910. At 2906, method 2900 includes configuring and/or tuning the device, as needed. For example, in some embodiments, a hardware configuration may be modified or tuned depending on whether the quantum computing exercise include operations on a single gate or on two gates. Other tunable features of the quantum computing emulation device may include delays on one or more inputs, a gain or gain correction for the overall system or for one or more individual amplifiers (e.g., op amps), or the parameters of one or more filters. In some cases, the tuning may include re-wiring an input or output of a component of the device. In other cases, the tuning may include adjusting one or more trimmer potentiometers “trim pots”). Some parts of the system (e.g., basis function generation) may require tuning with each use, while other parts (e.g., various filters) may not require tuning as often.

Method 2900 includes (at 2908) selecting and/or configuring a device interface of the platform for use, after which the method proceeds to 2912. At 2910, method 2900 includes selecting and/or configuring a simulator interface of the platform for use, after which the method proceeds to 2912. Method 2900 includes (at 2912) determining, based on the inputs, an initial quantum state, a specified number and sequence of gate operations to be applied to the initial quantum state by the exercise, and/or inputs to be provided to the device or simulator to cause it to perform the exercise. Method 2900 includes (at 2914) storing the inputs to be provided to the device or simulator in a memory, and configuring a memory to receive outputs from the device or simulator.

Following the operations shown at 2914, method 2900 continues at 2916 and at 2918, substantially in parallel. At 2916, method 2900 includes playing out the inputs, i.e., providing them to the device or simulator through its respective interface. At 2918, method 2900 includes receiving outputs from the device or simulator through its respective interface, and storing them to the memory. Until all of the inputs to the quantum computing emulation device or the simulator have been played out and all of the outputs from the quantum computing emulation device or the simulator have been received, method 2900 may repeat the operations shown as 2916 and 2918. Once (at 2922) all of the inputs to the quantum computing emulation device or the simulator have been played out and all of the outputs from the quantum computing emulation device or the simulator have been received, the exercise may be complete, and method 2900 may include (at 2920) providing an indication of completion through the user interface.

In some embodiments, a master controller (such as master controller 2832), a set controller (such as set controller 2834), and a run controller (such as run controller 2836) may be implemented using a scripting language (such as the MATLAB® programming language or another suitable scripting language). For example, in one embodiment, the quantum computing emulation platform may include program instructions representing a master control script, a set control script, and a run control script. In this example embodiment, the following variables may be defined for the quantum computing emulation platform and the various components thereof.
1. logic—This variable is a vector that includes six entries. Each of the values of this vector may be set to 1 or 0. These six values may then be played out through digital outputs of the quantum computing emulation platform, which drive the six analog switches within the quantum emulation device. These switches may, for example, include the switches that select between the different basis functions of qubit A or B, which then get encoded with different gate coefficients, and that select whether the input for a gate run is fed back from a previous gate operation or is synthesized.
2. Gate-type—This variable is a vector that specifies the desired gate sequence for each set in the data acquisition session. The allowed values and functions are:
   0—Single qubit gate on qubit 0.
   1—Single qubit gate on qubit 1.
   2—Controlled NOT gate with control qubit 0.
   3—Measurement gate on qubit A.
   4—Measurement gate on qubit B.
3. U-type—This variable defines the specific gate values for each run in the gate sequence. In various embodiments, this variable defines a standard set of gate operations and may also be used to define other gate operations (e.g., any arbitrary 2×2 matrix). In one embodiment, the allowed values and functions are:
   0—Hadamard gate:

$$[ \begin{matrix}1 & 1 \\ 1 & - 1\end{matrix} ]$$

1—random unitary gate:

$$[ \begin{matrix}a & b \\ - conj ( b ) & conj ( a )\end{matrix} ]$$

2—identity gate:

$$[ \begin{matrix}1 & 0 \\ 0 & 1\end{matrix} ]$$

3—NOT gate:

$$[ \begin{matrix}0 & 1 \\ 1 & 0\end{matrix} ]$$

4—Pauli Y gate:

$$[ \begin{matrix}0 & - i \\ i & 0\end{matrix} ]$$

5—Pauli Z gate:

$$[ \begin{matrix}1 & 0 \\ 0 & - 1\end{matrix} ]$$

4. psi—This string variable defines the input quantum state that will either be synthesized or generated as input to the system. In some embodiments, an arbitrary quantum state may be defined in terms of the four basis states. In some embodiments, there may also be an option to add some controlled noise to the state (a condition referred to as being “dressed”). In one embodiment, the allowed values of psi may include:
   00, 01, 10, 11—Any of the four basis functions in a two qubit case (0 or 1 in the single qubit case).
   Dressed_q=0, Dressed_q=1—These correspond to a random pure state with added Gaussian noise.
   Bare—This corresponds to a random pure state.
   Manual—This allows for any specific desired state. To use this setting, the state coefficients are specified within the run control script.
5. runs—This variable specifies the number of single gate applications that will be implemented serially (in a set).
6. sets—This variable specifies how many different gate sequences (sets), each of a length equal to the number specified by the runs variable, will be implemented. For example, to run ten sets of three gates in each set, the runs variable would be set to 3, and the sets variable would be set to 10. In this example, each of the sets would pass an initial quantum through the same three gates, and these gates may include any arbitrary combination of gates.

In at least some embodiments, the master control script may include multiple sections, each of which performs a different function to control the performance of a quantum computing exercise. For example, in one embodiment, the master control script includes a system configuration portion, an acquisition configuration portion, a data type configuration and execution portion, and (optionally) a post-selection portion. In this example, the system configuration portion of the master control script is responsible for setting the properties for the data acquisition session that do not change from execution run to execution run or from set to set, nor do they change based on the Gate-type. For example, these properties may include the sampling frequency to be used, the signal length to be recorded, the signal type (e.g., the initial input type) to be recorded, and/or the transient cutoff time for the device. In some embodiments, an optional index variable whose value can be used for post operation data selection may be specified in this portion of the master control script. For example, if the quantum computing exercise is to generate a very large data set, the value of this index variable may be used to specify which of the outputs should be saved (e.g., the outputs of every other gate run or every fifth gate). In this example, the index value may be used to select only those outputs before recording the output data so that it does not take up as much space.

In one embodiment, the acquisition session configuration portion of the master control script is responsible for setting up one or more data acquisition sessions (e.g., in a data acquisition package) for the quantum computing exercise. In one example embodiment, there may be two data acquisition sessions, each corresponding to a different device, one of which (referred to herein as the s session) is used to play out the DC coefficients of the input state, psi, and the unitary gates, and the other of which (referred to here as the d session) controls the signal output and input, as well as the digital logic controls for the analog switches. In this example, the d session manipulates and implements all the recording and the playing out of the AC input signals. In other embodiments, a single data acquisition session may be created to play out the DC coefficients of the input state, psi, and the unitary gates, and to control the signal output and input, as well as the digital logic controls for the analog switches. In at least some embodiments, the data acquisition sessions are created and the data acquisition session properties (such as the output rate of the sessions) are defined in this portion of the master control script, and it is in this portion of the master control script in which the analog input and output channels used to play out data and the digital channels for recording data for the respective sessions are configured.

In one embodiment, the data type configuration and execution portion of the master control script is the portion of the master control script in which the different types of set data are specified and then executed by calling the set control script. This portion of the master control script includes a FOR loop on a loop variable for the session (referred to as “o”). For each value of o, a different set number, number of runs, input state (psi), unitary gate (U-type), and gate sequence (Gate-type) may be specified. In this portion of the master control script, variables for data collection may also be defined. For example, in one embodiment, a matrix B may record the actual analog input data (e.g., two input states that are sent into the system) and the output state data from each set of gate runs. A variable BT (B total) may store all of these B matrices. In one embodiment, a variable BB may collect the B matrix for each set into a 3-D array for easier processing, and the variable BT may then be filled in from the BB array after each set.

In one embodiment, the data type configuration and execution portion of the master control script may be responsible for creating two additional variables (referred to as AT and UT), based on the number of qubits specified for the session. The AT variable (A total) may collect individual A matrices, each of which contains the ideal complex amplitudes of each input state to each gate that was implemented in a set. Similarly, the UT variable (U total) may collect individual U matrices, each of which is a matrix of the gate coefficients for the unitary gates performed in each set of runs. In this example embodiment, at the end of the session, AT is a matrix of all the A matrices, each of which records the input state for each gate in each run of each set, and UT includes all of the gate information for every run executed during the data acquisition session. In some embodiments, an ideal input may be calculated from the information in AT, based on the gate(s) that were implemented.

In some embodiments, the number of sets per session is programmable, as is the number of runs in each of those sets (which may be different in different sets). In addition, different gate sequences may be implemented in each set. Once all of these variables are defined, the data type configuration and execution portion of the master control script may call the set control script once for each set (where the number is sets is reflected in a variable k). For each set, the set control script may implement the type of data collection specified by the o value specified for that set, after which the data for that set is collected into the AT, UT, BT variables after each set. As noted above, in some embodiments, an optional post-operation selection step based on a specified index variable may be used to select a subset of the generated data to be recorded. A save command of the master control script may save all (or the selected portion of) the data corresponding to each value of o.

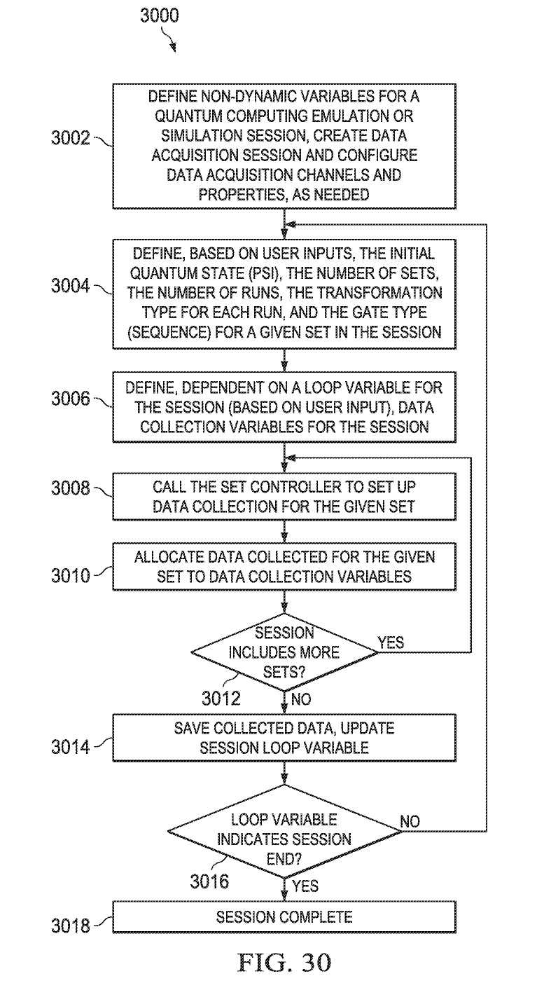

FIG. 30 depicts a flow diagram 3000 illustrating the operation of an example master controller of a quantum computing emulation platform, according to one embodiment. It is noted that some of the operations depicted in FIG. 30 may be optional. In various embodiments, the master controller may start or stop at any operation, and one or more of the depicted operations may be repeated and/or may be performed in a different order than the order depicted in FIG. 30. In this example embodiment (at 3002), the master controller defines non-dynamic variables for a quantum computing emulation or simulation session, creates one or more data acquisition sessions and configures data acquisition channels and properties, as needed. At 3004, the master controller defines, based on user inputs, the initial quantum state (psi), the number of sets, the number of runs, the transformation type for each run, and the Gate-type (sequence) for a given set in the session. At 3006, the master controller defines, dependent on a loop variable for the session (based on user input), data collection variables for the session.

In this example embodiment (at 3008), the master controller calls the set controller (or a method thereof) to set up data collection for the given set. At 3010, the master controller allocates the data collected for the given set to data collection variables. If (at 3012) it is determined that the session includes more sets, the master controller returns to 3008 to set up additional data collections. Otherwise (at 3014), the master controller saves the collected data, and updates the session loop variable.

If (at 3026) it is determined that the loop variable for the session indicates the end of the session has not yet been reached, the master controller may return to 3004 to repeat the operations shown as 3004-3014 one or more times for other collections of sets to be run during the session. Once (at 3026) it is determined that the loop variable for the session indicates the end of the session has been reached, then (at 3028) the session is complete.

In at least some embodiments, the set control script may include multiple sections, each of which performs a different function to implement a single set of gates, as designated by the Gate-type and U-type variables described above. For example, in one embodiment, the set control script includes a program quantum operations portion, a run data set portion, and (optionally) an analyze results portion. In one embodiment, the program quantum operations portion of the set control script may define two variables (referred to as Op-type and M-type). In this example embodiment, the value of Op-type specifies whether a Deutsch algorithm is to be implemented or a manually defined quantum computing algorithm is to be implemented. In some embodiments, if a Deutsch algorithm is to be implemented, a Deutsch test script may be called at runtime to set up the gate sequencing for the Deutsch algorithm and variables that are specific to that algorithm. In this example, the value of M-type specifies the type of measurement that should be performed (if and when a measurement is desired). The program quantum operations portion of the set control script may also define input/output data variables based on the Op-type. These variables may be where the individual gate data is first stored. In some embodiments, the value of the M-type variable may enable a selection between the use of relative measurements (in which the amplitudes of the projection states are compared and whichever one is higher is taken as the measurement) or a board measurement, which includes measurements taken from the board statistics. In some embodiments, both types of measurements may be specified for use.

In at least some embodiments, the set control script may define the B variable, the A variable, and the U variable, as described above, which are specific for each set. In addition, the M variable, an output matrix used to allocate the different logic values, may be defined in this portion of the set control script. If the output state is to be played out, instead of synthesizing the input from scratch, the output state may be stored in M by this portion of the set control script. In one embodiment, the first column of M may represent the input oscillator signal, and the next two columns may represent the real and imaginary parts of the quantum state to play out into the system. These columns may include recorded data from the previous gate, or an exact initial input state as specified for this set (e.g., as programmed in a scripting language or through a signal processing package).

In one example embodiment, B is a matrix that collects data from analog input channels of the output board. The first column of B represents the real part of the input state to the system as recorded from the output board, and the second column represents the imaginary part of this input state. In this example, the third and fourth columns of B represent the real and imaginary parts of the final output state of the system after a single gate, respectively.

In one example embodiment, A is a matrix that stores of the state coefficients of each transformed input state. The first column of A represents the complex coefficients of the initial input state to the system. The second column represents the ideal transformed coefficients of the input state, based on the unitary gate applied. In each column of A, the first two entries represent the real and imaginary parts of the coefficient on the 00 basis state, respectively. Similarly, rows three and four of each column of A correspond to the 01 basis state, respectively, rows five and six of each column of A correspond to the 10 basis state, respectively, and rows seven and eight of each column of A correspond to the 11 basis state, respectively.

In some embodiments, U is a matrix that records the gate coefficients of each implemented unitary gate. For a unitary matrix, such as that shown below

$$[ \begin{matrix}{U}_{00} & {U}_{01} \\ {U}_{10} & {U}_{11}\end{matrix} ]$$

the first two rows of each column of U represent the respective real and imaginary parts of U00, respectively. Similarly, rows three and four of each column of U correspond to the real and imaginary parts of U01 rows five and six of each column of U correspond to the real and imaginary parts of U10, and rows seven and eight of each column of U correspond to the real and imaginary parts of U11.

This portion of the set control script may (optionally) include a psi assignment to be used for diagnostic testing of the device (e.g., by inputting single gates with different basis functions to tune the circuitry). Another optional variable (referred to as q) may be defined to specify whether or not the initial input data is a dressed state.

In one embodiment, the run data set portion of the set control script may include a FOR loop on the value of a variable (referred to as p) indicating the current run number. Within this loop, a selected may be made between synthesized input to the system, programmed input to the system, and recorded data as input to the system. In other words, an exact input state may be specified and played out in the analog output channels, the input state may be specified and synthesized using the basis functions on board, or the output of a previous gate may be played out as the input state. Once the input has been specified, the Gate-type variable defines the control qubit, qubit addressed, and the logic values for each individual gate run. The run control script may then be called for each value of p.

As noted above, the set control script may include an optional section used to analyze recorded data. In this section of the set control script any script for analyzing the data may be called. In one example, a script called in this portion of the set control script may perform fidelity calculations on the final states, and may operate on the data that was recorded in the collection matrices described above.

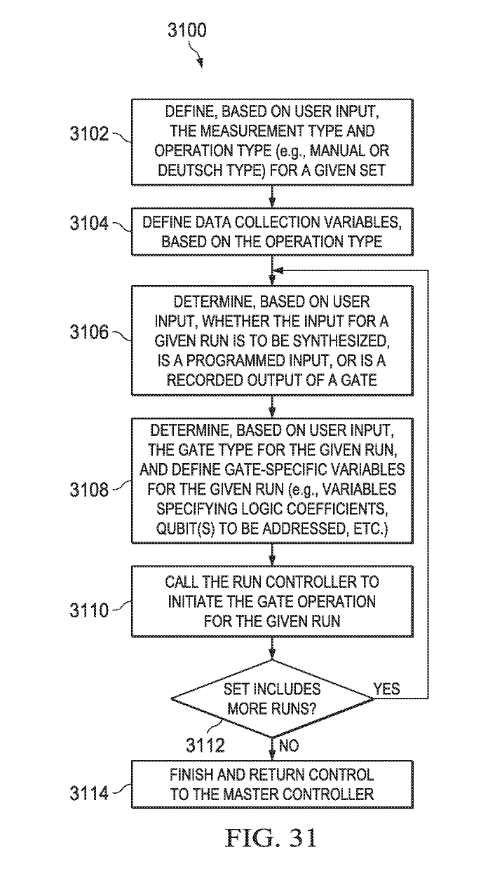

FIG. 31 depicts a flow diagram 3100 illustrating the operation of an example set controller of a quantum computing emulation platform, according to one embodiment. It is noted that some of the operations depicted in FIG. 31 may be optional. In various embodiments, the set controller may start or stop at any operation, and one or more of the depicted operations may be repeated and/or may be performed in a different order than the order depicted in FIG. 31. In this example embodiment (at 3102), the set controller defines, based on user input, the measurement type and operation type (e.g., a manual or Deutsch type operation) for a given set. At 3104, the set controller defines data collection variables, based on the operation type. In this example embodiment (at 3106), the set controller determines, based on user input, whether the input for a given run is to be synthesized, is a programmed input, or is a recorded output of a gate. At 3108, the set controller determines, based on user input, the Gate-type for the given run, and defines gate-specific variables for the given run (e.g., variables specifying logic coefficients, qubit(s) to be addressed, etc.).

At 3110, the set controller calls the run controller (or a method thereof) to initiate performance of the specified gate operation for the given run. If (at 3112) it is determined that the set includes more runs, the set controller may return to 3106 one or more times to set up for each additional run. Once (at 3112) it is determined that the set does not include any more runs, then (at 3114) the set controller may finish its work and return control to the master controller (or to a calling method thereof).

In at least some embodiments, the set control script may include multiple sections, each of which performs a different function to generate and assign the input/output quantum state data, generate and assign appropriate unitary gate data, and to start and stop data collection for a given run. For example, in one embodiment, the set control script includes a quantum state data portion, a gate data portion, and a start session portion. In one embodiment, the quantum state data portion of the run control script specifies the time vector, base frequency, and exact oscillator signal used to drive the system. If this if the first run in a set (e.g., if p=1), specified logic values may be immediately assigned to the matrix M, after which matrix D is created. As described above, matrix D may hold the DC values of both the input state and the unitary gate which are to be played out to the quantum computing emulation device. In some embodiments, the initial input data to the system is generated based on the variable psi that was defined in the master control script. The vector a is generated, which is a vector of the complex state amplitudes of the desired input state (e.g., the state vector representing that psi function). The complex coefficients of psi may be taken from the vector a, then allocated to the variable D, which is a matrix from which data is played out to the quantum computing emulation device (after being queued into the acquisition session).

In one example, if the number of qubits to be operated on is 1, a(1) is the coefficient on the 0 basis state and a(2) is the coefficient of the 1 basis state. The vector, a, is then assigned to columns 3-6 of the matrix D. If the number of qubits to be operated on is 2, a(1) is the 00 coefficient, a(2) is the 01 coefficient, a(3) is the 10 coefficient, and a(4) is the 11 coefficient. The vector a is then assigned to the first 8 columns of D. The real part of a(1) goes to D(:, 1) and the imaginary to D(:, 2). Similarly, the real and imaginary parts of a(2) go to D(:, 3:4), the real and imaginary parts of a(3) go to D(:, 5:6) and the real and imaginary parts of a(4) go to D(:, 7:8). In either case (whether the number of qubits is 1 or 2), the exact input state, psi, is generated and assigned to M. The logic values, however, are what decide whether the synthesized state, or a programmed state are passed through the circuitry. If this is not the first run of the set (e.g., if p is not 1), then the previous output of the system is assigned to the new input columns of M, along with the relevant logic values. In this case, the matrix D is specified as all zeros, because it is no longer used. In other words, the vector a represents the ideal coefficients. These coefficients are saved into the variable A if it is the first run. Otherwise, the coefficients of the previous column of A are used to generate the new coefficients for each subsequent run.

In some embodiments, the exact input state psi is always generated and assigned to the variable M. If the generated state psi is selected, it may be played it out, as defined by the logic. In some embodiments, this generated state psi may always be played out, but the logic values that operate the switches may be what determines whether or not that information actually propagates through the system as the input.

In at least some embodiments, the gate data portion of the run control script is where the matrix coefficients and date coefficients to be implemented are defined. These coefficients are created into a variable H and then are assigned to the second half of the matrix D (which is a 16 column matrix). Since matrix D contains what will be played out, it will play out the state coefficients and also the gate coefficients. In one embodiment, the gate data portion of the run control script begins by determining the value of U-type. A matrix H is created, which is the complex 2×2 unitary matrix to be implemented. These matrix values of H are then assigned appropriately to the second half of the matrix D. For example, D(:, 9:10) contains the respective real and imaginary parts of H00. D(:, 11:12) corresponds to H01, D(:, 13:14) corresponds to H10, and D(:, 15:16) corresponds to H11. The matrix, U, is then specified as the first row entry of the last eight columns of D.

In one embodiment, the gate data portion of the run control script also assigns the input quantum state coefficients to the matrix A. If p=1, then the matrix A is assigned the values from the first row of the first eight columns of D. When p is not 1, a new H matrix is formed, which is the unitary gate implemented in the previous gate run. This gate is then applied (e.g., through the) to the previous gate input state as specified by the p−1 column of A. This gives a vector, H-alpha, which is the exact input state vector for the gate process corresponding to the value of p. Finally, this input state vector is assigned to the matrix A, column p, as the state coefficients of the input state to the system.

In at least some embodiments, the start session portion of the run control script is where the data acquisition actually takes place. In one embodiment, data is queued to each of the two sessions, s and d. For example, the variable D is queued to session s, and the variable M is queued to session d. The session s provides the DC analog outputs of state coefficients and gate coefficients. The session d provides the logic output values, analog AC output channels, and analog input recording channels. The session s is then started as a background process, and then the session d begins. The recorded data of session d is then stored in the variable dataIn, which includes six columns. In this example embodiment, the first two columns correspond to the recorded input state to the system (first the real part, then the imaginary part). The fifth column of dataIn represents the recorded oscillator signal used as a reference in the analysis of signals. The third and fourth columns correspond to the recorded output state of the system. The sixth column represents the RMS value of the 0 basis state for whichever qubit is being measured (in the case of measurement). The seventh column represents the RMS value of the 1 basis state. The data from dataIn is then assigned to the appropriate variables. Finally, the recorded system output signals, now in the matrix B, are shifted 2 points in order to account for the constant lag acquired throughout the system circuitry relative to the input state. As in the set control script, an optional portion of the run control script may be used for processing and analysis.

In this example, after the start session portion of the run control script starts the session, the session is allowed to run to completion, at which point all the output data is stored in the variable B.

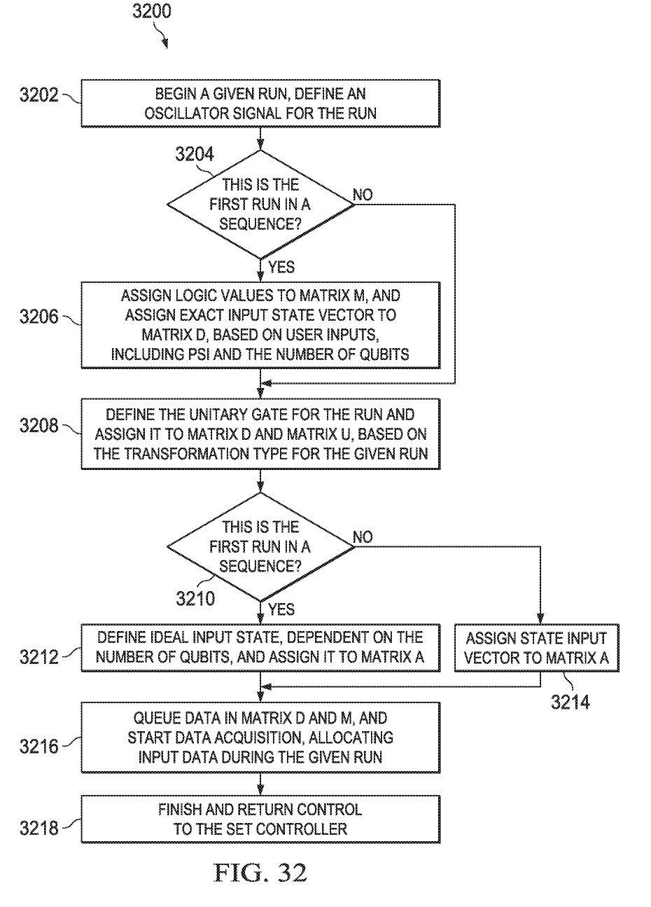

FIG. 32 depicts a flow diagram 3200 illustrating the operation of an example run controller of a quantum computing emulation platform, according to one embodiment. It is noted that some of the operations depicted in FIG. 32 may be optional. In various embodiments, the run controller may start or stop at any operation, and one or more of the depicted operations may be repeated and/or may be performed in a different order than the order depicted in FIG. 32. in this example embodiment (at 3202), the run controller begins a given run, and defines an oscillator signal for the run. If (at 3204) it is determined that the given run is the first run of a sequence of runs for which the outputs are fed back as inputs to the next run, the run controller may proceed to 3206. Otherwise, the run controller may proceed to 3208. In this example embodiment (at 3206), the run controller assigns logic values to matrix M, and assigns the exact input state vector to matrix D, based on user inputs, including psi and the number of qubits. At 3208, the run controller defines the unitary gate for the run and assigns it to matrix D and a matrix U, based on the transformation type for the given run.

In this example embodiment, if (at 3210) it is determined that the given run is the first run of a sequence of runs for which the outputs are fed back as inputs to the next run, the run controller may proceed to 3212. Otherwise, the run controller may proceed to 3214. In this example embodiment (at 3212), the run controller defines the ideal input state, dependent on the number of qubits, and assigns it to matrix A, after which it proceeds to 3216. At 3214, the run controller assigns the state input vector to matrix A, after which it proceeds to 3216. At 3216, the run controller queues data in matrix D and M, and starts the data acquisition, allocating input data during the given run. At 3218, the run controller finishes its work and returns control to the set controller (or to a calling method thereof).

The systems and methods described herein for controlling a quantum computing emulation device may be further illustrated by way of the following data acquisition examples. These examples describe how the controller components (which may be implemented as control scripts) can be used to implement different types of data sets. In these examples, the term “run” or “gate run” refers to a single application of a unitary gate, and the term “set” refers to a sequence of gates applied serially to an initial state.

In one example, to implement any sequence of unitary gates on a specific input state, psi, the following steps may be performed:
1. In the first section of the master control script, set the n qubits (number of qubits) and InitialInput variables to the appropriate values. For example, the values of these variables may be set through a script-based, command-line-based, or GUI-based user interface. Next, set the index variable to the desired value (if post-operation data selection is desired).
2. Next, set the Gate-type, U-type, runs, and/or sets variables in the optional part of the first section of the master control script. If the Gate-type and U-type are not supposed to change from set to set, they may be assigned here. Similarly, if the runs length and sets length are to remain constant for the entire session, those values may be set here.
3. In the data type configuration and execution section of the master control script, choose whether or not to loop through multiple values of the o variable in order to implement different sets of different gates and run lengths. To run only a single set, set the o variable to “loop” only once. Ensure that the sets, runs, Gate-type, and U-type variables are set correctly either here or in the previous section. Finally, set the psi variable to the desired input for each set.
4. Check the save command at the end of the master control script. Adjust the save command to save the data in the correct place with the correct name and variables.
5. Before running the master control script, make sure that the Op-type in the set control script is set to manual. Also, if the psi variable is set to manual, manually enter the desired state coefficients in the first section of the run control script.
6. Start the master control script and let it run to completion.

In a second example, in order to implement the Deutsch Algorithm, the following steps may be performed:
1. Set the sets variable to 1 in the master control script and set the Op-type to Deutsch in the set control script.
2. Set the InitialInput variable to Syn and n_qubits to 2, and ensure that the for loop on o in the master control script is adjusted appropriately.
3. In this example, a separate Deutsch test script will be called by the set control script, which will specify all of the other needed variables.
4. Once the values of these variables have been specified, run the master control script.

In some embodiments, the quantum computing emulation platforms described herein may support more than two types of quantum computing algorithms (e.g., more than just the Deutsch algorithm and manually defined sets of gate runs). In such embodiments, additional values of the Op-type variable may be used to specify that the control scripts of the quantum computing emulation platform and/or the components of the quantum computing emulation device are to be configured to implement one of these other types of quantum computing algorithms. For example, for each addition Op-type, respective values may be defined for any or all of the variables described herein to control the operation of the device. In some embodiments, a GUI-based user interface to the quantum computing emulation platform may allow a user to define a new standard or customer operation type and/or to compose different quantum computing algorithms by specifying the values of these variables for different runs and sets of runs in a quantum computing exercise.

As previously noted, in some embodiments, the quantum computing emulation platform may include a collection of low-level scripts, some of which may be used to interface the platform with the hardware of a particular quantum computing emulation device. In some embodiments, interface scripts and other low-level scripts may be modular in nature, and may be included in or excluded from different quantum computing exercises, as needed. In some embodiments, a quantum computing program, as controlled by components of the quantum computing emulation platform, may be executed first on a simulator before attempting to program the quantum computing emulation device to execute the program. In such embodiments, a modular simulator interface component may be replaced with a modular device interface component which switching from executing the program on the simulator to executing the program on the device. In addition, as hardware components on the quantum computing emulation device are replace and/or upgraded, modular interfaces for the upgraded components may be added to the collection of low-level scripts included in (and supported by) the quantum computing emulation platform. For example, if the A/D or D/A convertors on the device were replaced with a microcontroller that include A/D and/or D/A functionality, an interface for driving the microcontroller may be added to the quantum computing emulation platform.

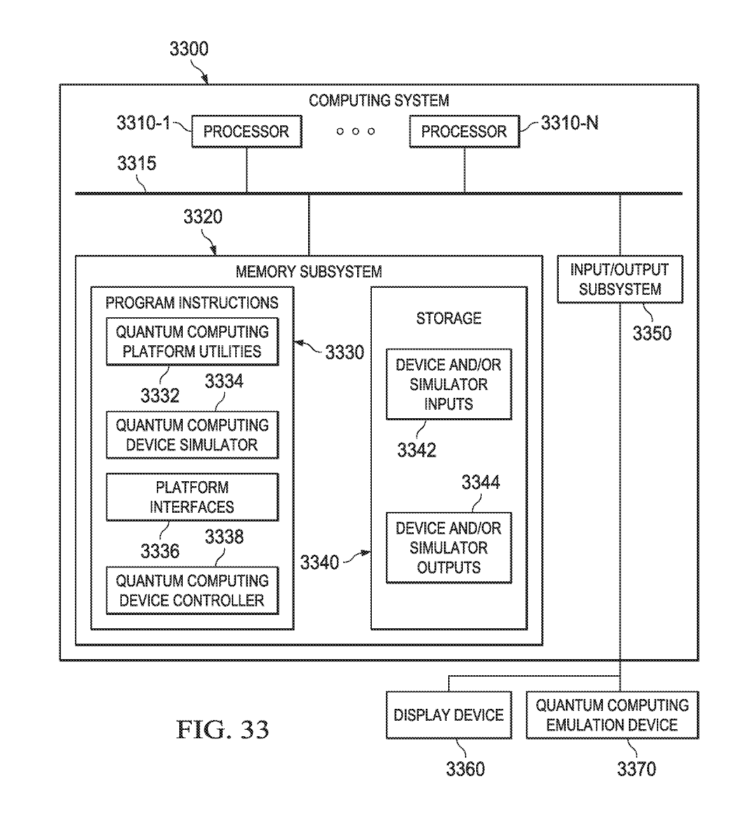

FIG. 33 illustrates an example computing system 3300 for controlling and simulating a quantum computing emulation device 3370, according to one embodiment. In this example embodiment, computing system 3300 includes one or more processors 3310. Each of processors 3310 may include circuitry or logic to interpret or execute program instructions and/or to process data. For example, each processor 3310 may include a microprocessor, microcontroller, digital signal processor (DSP), graphics processor, or application specific integrated circuit (ASIC). In some embodiments, processors 3310 may interpret and/or execute program instructions and/or process data stored locally in memory subsystem 3320 or remotely (not shown).

Processors 3310 may implement any instruction set architecture (ISA), in different embodiments. In some embodiments, all of the processors 3310 may implement the same ISA. In other embodiments, two or more of processors 3310 may implement different ISAs. Processors 3310 are coupled to a memory subsystem 3320 and an input/output subsystem 3350 via a system interface 3315. System interface 3315 may implement any of a variety of suitable bus architectures and protocols including, but not limited to, a Micro Channel Architecture (MCA) bus, Industry Standard Architecture (ISA) bus, Enhanced ISA (EISA) bus, Peripheral Component Interconnect (PCI) bus, PCI-Express bus, or a HyperTransport (HT) bus.

In some embodiments, memory subsystem 3320 may include random access memory (RAM), read-only memory (ROM), electrically erasable programmable read-only memory (EEPROM), flash memory, magnetic storage, opto-magnetic storage, and/or any other type of volatile or non-volatile memory. In some embodiments, memory subsystem 3320 may include computer-readable media, e.g., a hard disk drive, floppy disk drive, CD-ROM, and/or other type of rotating storage media, and/or another type of solid state storage media. In the example embodiment illustrated in FIG. 33, memory subsystem 3320 includes program instructions 3330, including program instructions that when executed by one or more of the processors 3310 implement some or all of the methods described herein for controlling and/or simulating a quantum computing emulation device, such as quantum computing emulation device 3370. For example, program instructions 3330 include quantum computing platform utilities 3332 (such as utilities within a commercially available data acquisition toolbox or signal processing toolbox), a quantum computing device simulator 3334, one or more platform interfaces 3336 (which may include a device interface and/or a simulator interface), and one or more quantum computing device controllers 3338 (such as a master controller, a set controller, and a run controller, as described herein). In some embodiments, these components may implement the functionality of a quantum computing emulation platform, such as those described herein. In the example embodiment illustrated in FIG. 33, storage 3340 may include storage for device and/or simulator inputs (shown as 3342) and storage for device and/or simulator outputs (shown as 3344).

In the example embodiment illustrated in FIG. 33, input/output subsystem 3350 may implement any of a variety of digital and/or analog communication interfaces, graphics interfaces, video interfaces, user input interfaces, and/or peripheral interfaces for communicatively coupling input/output devices or other remote devices to the components of computing system 3300. Input/output subsystem 3350 may generate signals to be provided (e.g., via one or more output pins of computing system 3300) to quantum computing emulation device 3370. For example, under the direction and control of the quantum computing device controllers 3338, a device interface may generate signals to program quantum computing emulation device 3370 to perform one or more quantum computing operations, may play out gate coefficients and control values stored within structures defined within memory subsystem 3320, to provide analog signals representing basis states (or from which basis states and initial quantum states may be generated), and to start and stop the operation of quantum computing emulation device 3370. The device interface may also be configured to receive results of the quantum computing operations, which may then be stored in structures defined within memory subsystem 3320. Input/output subsystem 3350 may also generate signals to be provided (e.g., via one or more output pins of computing system 3300) to a display device 3360. For example, display device 3360 may receive signals encoding data for display of a graphical user interface (GUI) or command line interface for interacting with various components of a quantum computing emulation platform to control quantum computing emulation device 3370 and/or quantum computing device simulator 3334.

In some embodiments, a quantum computing emulation device may be interfaced with a traditional digital computer in order to serve as an analog co-processor. In such embodiments, a digital computer, tasked with solving a particular problem, perhaps as a subroutine to a larger computation, may designate an initial quantum state and sequence of gate operations to be performed on this state through a digital-to-analog converter (DAC) interface. The co-processor (i.e., the quantum computing emulation device) may then produce a final state (i.e., a signal) which may be subject to a sequence of measurement gate operations. The result may be a particular binary outcome, which may then be reported back to the digital computer via an analog-to-digital (A/D) converter.

In many of the example embodiments described herein, the quantum state is represented in the frequency domain. In some embodiments, additional qubits may be represented in the time domain, such as by using several signal packets. For example, additional qubits may be represented as part of train of signal packets that are separated in time. In other embodiments, the capacity of the quantum computing emulation devices described herein may be increased in the spatial domain by using parallel signals. For example, additional qubits may be represented as multiple signals existing in separate wires. In this example, the processes described herein may be parallelized and all of the gate operations may be replicated so that, instead of having a single pair of signals, there may be four or eight or more parallel signals that are combined in such a way that they allow the device to implement a large number of qubits.

In some embodiments of the present disclosure, the quantum computing emulation device may employ pulse position modulation (PPM). Pulse position modulation is a type of time-division multiplexing sometimes used in line-of-sight radio-frequency and free-space optical transmissions in which the received position of a single pulse is used to encode information. In an M-PPM message, an m-bit string is transmitted by placing a pulse in a single frame of a symbol consisting of M=2^{m} frames. The reception time of the pulse, which is considered either present or not, indicates the value of the transmitted m-bit signal.

In some applications, M-PPM messages may be extended to support a multi-pulse technique, allowing for the transmission of exactly Kε{1, . . . , M/2} pulses per symbol. This may allow one to encode

$${log}_{2} ( \frac{M}{K} )$$

bits per symbol for a fixed number, K, of pulses. In some embodiments, an approach in which information is associated with the position of a received signal or pulse may be well-suited for use in a time-bin encoding framework of a quantum computing emulation device.

In some embodiments of the present disclosure M-PPM may be used to represent a quantum state. For example, in one embodiment, an M-PPM scheme with M=2^{m} frames and K pulses may be used to transmit

$${log}_{2} ( \frac{M}{K} )$$

bits. Each combination of received pulses may represent a unique bit state. In the context of a quantum computing device emulator, each of the M frames may represent a basis state. This approach differs from an approach that employs frequency-defined qubits in that the basis state is defined by its frame position rather than by a combination of complex exponentials. With this approach, in order to fully introduce qubit encoding, the complex amplitudes a may be encoded in each time frame. Therefore, a time-bin encoded quantum state may be considered a symbol of M frames with amplitude scaled pulses in which the number of pulses depends on the presence of each basis state in the quantum state. Using this approach, every symbol frame may carry a pulse, and for M-PPM, at most K basis states will have non-zero coefficients.

The power of quantum computing lies ultimately in the ability to operate coherently on arbitrary superpositions of qubits representing the quantum state. It has been shown that the fundamental mathematics of gate-based quantum computing can be represented classically and practically implemented electronically. Thus, the quantum computing emulation devices described herein may be capable of faithfully emulating a truly quantum system, albeit one of limited scale. The work described herein serves to illustrate that by leveraging the concepts of quantum computing and applying them to classical analog systems, one can construct a relatively small-scale device that may actually be competitive with current state-of-the-art digital technology. In addition, it has been shown that a quantum computing emulation platform, including a collection of control scripts and low-level scripts, may be used to program and control the operation of such a device in order to execute a variety of quantum computing operations in one or more sets of gate runs.

As described herein, a gate-based quantum computing emulation device is presented in which the physical resources needed to represent, prepare, manipulate, and measure the quantum state may scale sub-exponentially with respect to the number of qubits to be represented. The quantum computing emulation devices described herein may be robust to decoherence, may be easily manipulated, and may be scaled to a desired number of qubits. In at least some embodiments, the quantum computing emulation devices described herein may be constructed from standard analog electronic components. These devices may be faster than current digital processors with a similar form factor and yet cheaper to build than a true quantum computing device.

Although only exemplary embodiments of the present disclosure are specifically described above, it will be appreciated that modifications and variations of these examples are possible without departing from the spirit and intended scope of the disclosure.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by the law, the scope of the present disclosure is to be determined by the broadest permissible interpretation of the following claims and their equivalents, and shall not be restricted or limited by the foregoing detailed description.

What is claimed is:

1. A method for controlling a quantum computing emulation device, comprising:
receiving, via an input interface of a quantum computing emulation platform, input identifying a quantum computing exercise to be performed by analog electronic circuits within the quantum computing emulation device;
determining, by a master controller of the quantum computing emulation platform dependent on the received input, a plurality of control values for programming, on the quantum computing emulation device, an initial quantum state for the quantum computing exercise, a number of gate operations to be applied to the initial quantum state in one or more sets of execution runs during performance of the quantum computing exercise, a transformation type for each execution run, and a sequence of one or more gate operations to be applied in each set of execution runs;
defining, by the master controller of the quantum computing emulation platform, one or more data collection variables for the quantum computing exercise and allocating storage for the one or more data collection variables in a memory;
initiating performance of the quantum computing exercise by the analog electronic circuits within the quantum computing emulation device, wherein the initiating comprises providing the control values to the quantum computing emulation device; and
storing, by the master controller of the quantum computing emulation platform to the data collection variables, data collected from the quantum computing emulation device during performance of the quantum computing exercise.

2. The method of claim 1, wherein:
the plurality of control values comprises a respective control value for controlling each of a plurality of switch type circuits on the quantum computing emulation device;
the plurality of switch type circuits control selection of a number of qubits to be operated on, a particular one of the qubits to be operated on, or the initial quantum state for the quantum computing exercise.

3. The method of claim 2, wherein the plurality of control values further comprises a control value for controlling, for at least one of the qubits to be operated on, whether the quantum state of the qubit is represented in the frequency domain, in the time domain, or in both the frequency domain and the time domain.

4. The method of claim 1, wherein the plurality of control values comprises a plurality of gate coefficients for programming the analog electronic circuits to perform a particular one of a plurality of gate operations implemented on the quantum computing emulation device.

5. The method of claim 1, wherein:
initiating performance of the quantum computing exercise comprises initiating performance of one or more operations, by a set controller of the quantum computing emulation platform, to prepare control values for one or more gate operations to be performed by the quantum computing emulation device during each execution run in each set of execution runs and to prepare the quantum computing emulation platform to collect results of the quantum computing exercise.

6. The method of claim 5, further comprising:
initiating, by the set controller of the quantum computing emulation platform for each execution run, performance of one or more operations, by a run controller of the quantum computing emulation platform, to provide the control values for the one or more gate operations to be performed by the quantum computing emulation device during the execution run and to record results of the execution run in one or more of the data collection variables in the memory.

7. The method of claim 1, wherein:
initiating performance of the quantum computing exercise comprises:
defining one or more control variables for the quantum computing exercise and allocating storage for the one or more control variables in the memory; and
storing the plurality of control values to the one or more control variables; and
providing the control values to the quantum computing emulation device comprises playing out a portion of the control values stored in the one or more control variables to the quantum computing emulation device via a device interface of the quantum computing emulation platform.

8. A non-transitory, computer-readable medium storing instructions that when executed by a processor cause the processor to perform:
receiving, via an input interface of a quantum computing emulation platform, input identifying a quantum computing exercise to be performed by analog electronic circuits within a quantum computing emulation device;
determining, by a master controller of the quantum computing emulation platform dependent on the received input, a plurality of control values for programming, on the quantum computing emulation device, an initial quantum state for the quantum computing exercise, a number of gate operations to be applied to the initial quantum state in one or more sets of execution runs during performance of the quantum computing exercise, a transformation type for each execution run, and a sequence of one or more gate operations to be applied in each set of execution runs;
defining, by the master controller of the quantum computing emulation platform, one or more data collection variables for the quantum computing exercise and allocating storage for the one or more data collection variables in a memory;
initiating performance of the quantum computing exercise by the analog electronic circuits within the quantum computing emulation device, wherein the initiating comprises providing the control values to the quantum computing emulation device; and
storing, by the master controller of the quantum computing emulation platform to the data collection variables, data collected from the quantum computing emulation device during performance of the quantum computing exercise.

9. The non-transitory, computer-readable medium of claim 8, wherein:
the plurality of control values comprises a respective control value for controlling each of a plurality of switch type circuits on the quantum computing emulation device;
the plurality of switch type circuits control selection of a number of qubits to be operated on, a particular one of the qubits to be operated on, or the initial quantum state for the quantum computing exercise.

10. The non-transitory, computer-readable medium of claim 9, wherein the plurality of control values further comprises a control value for controlling, for at least one of the qubits to be operated on, whether the quantum state of the qubit is represented in the frequency domain, in the time domain, or in both the frequency domain and the time domain.

11. The non-transitory, computer-readable medium of claim 8, wherein the plurality of control values comprises a plurality of gate coefficients for programming the analog electronic circuits to perform a particular one of a plurality of gate operations implemented on the quantum computing emulation device.

12. The non-transitory, computer-readable medium of claim 8, wherein:
initiating performance of the quantum computing exercise comprises initiating performance of one or more operations, by a set controller of the quantum computing emulation platform, to prepare control values for one or more gate operations to be performed by the quantum computing emulation device during each execution run in each set of execution runs and to prepare the quantum computing emulation platform to collect results of the quantum computing exercise.

13. The non-transitory, computer-readable medium of claim 12,
wherein when executed by the processor, the program instructions further cause the processor to perform:
initiating, by the set controller of the quantum computing emulation platform for each execution run, performance of one or more operations, by a run controller of the quantum computing emulation platform, to provide the control values for the one or more gate operations to be performed by the quantum computing emulation device during the execution run and to record results of the execution run in one or more of the data collection variables in the memory.

14. The non-transitory, computer-readable medium of claim 8, wherein:
initiating performance of the quantum computing exercise comprises:
defining one or more control variables for the quantum computing exercise and allocating storage for the one or more control variables in the memory; and
storing the plurality of control values to the one or more control variables; and
providing the control values to the quantum computing emulation device comprises playing out a portion of the control values stored in the one or more control variables to the quantum computing emulation device via a device interface of the quantum computing emulation platform.

15. A system, comprising:
a device interface to couple the system to a quantum computing emulation device, the quantum computing emulation device to include analog electronic circuits operable to emulate a plurality of quantum computing operations;
an input interface to receive input identifying a quantum computing exercise to be performed by analog electronic circuits within the quantum computing emulation device;
at least one processor;
a memory storing program instructions that when executed by the processor implement a quantum computing emulation platform, wherein the quantum computing emulation platform comprises:
a master controller to:
determine, dependent on the received input, a plurality of control values operable to program, on the quantum computing emulation device, an initial quantum state for the quantum computing exercise, a number of gate operations to be applied to the initial quantum state in one or more sets of execution runs during performance of the quantum computing exercise, a transformation type for each execution run, and a sequence of one or more gate operations to be applied in each set of execution runs;
define one or more data collection variables for the quantum computing exercise and allocate storage for the one or more data collection variables in the memory;
initiate performance of the quantum computing exercise by the analog electronic circuits within the quantum computing emulation device, wherein to initiate performance of the quantum computing exercise, the master controller is to provide the control values to the quantum computing emulation device; and
store, to the data collection variables, data collected from the quantum computing emulation device during performance of the quantum computing exercise.

16. The system of claim 15, wherein the quantum computing emulation platform further comprises:
a set controller to:
prepare control values for one or more gate operations to be performed by the quantum computing emulation device during each execution run in each set of execution runs;
prepare the quantum computing emulation platform to collect results of the quantum computing exercise.

17. The system of claim 16, wherein the quantum computing emulation platform further comprises:
a run controller to:
provide the control values for the one or more gate operations to be performed by the quantum computing emulation device during the execution run;
record results of the execution run in one or more of the data collection variables in the memory.

18. The system of claim 15, wherein
the plurality of control values comprises:
a respective control value operable to control each of a plurality of switch type circuits on the quantum computing emulation device; and
a plurality of gate coefficients operable to program the analog electronic circuits to perform a particular one of a plurality of gate operations implemented on the quantum computing emulation device;
the plurality of switch type circuits control selection of a number of qubits to be operated on, a particular one of the qubits to be operated on, or the initial quantum state for the quantum computing exercise.

19. The system of claim 15, wherein the input interface comprises a command line interface, a script-based interface, or a graphical user interface (GUI).

20. The system of claim 15, wherein:
the quantum computing emulation platform further comprises:
a simulator to simulate operation of the quantum computing emulation device;
a simulator interface through which the master controller is to initiate performance of a quantum computing exercise by the simulator.
